(19) United States
(12) Patent Application Publication
(10) Pub. No.: US 2026/0361366 A1
(43) Pub. Date: Nov. 12, 2026

(54) Channel State Information Reference Resource

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US); Hyoungsuk Jeon, Centreville, VA (US); Gautham Prasad, Herndon, VA (US); Ryan Keating, Chicago, IL (US)

(73) Assignee: Ofinno, LLC, Reston, VA (US)

(21) Appl. No.: 19/742,665

(22) Filed: Jul. 15, 2026

Related U.S. Application Data
(63) Continuation of application No. PCT/US2025/011761, filed on Jan. 16, 2025.
(60) Provisional application No. 63/621,386, filed on Jan. 16, 2024.

(51) Int. Cl. H04B 7/06; H04L 5/00; H04L 27/26

(52) U.S. Cl. CPC H04B 7/0626; H04L 5/0044; H04L 27/26025

(57) ABSTRACT

A wireless device receives, in a first occasion, a first message indicating a first differential offset. The wireless device determines a channel state information (CSI) reference resource, corresponding to a CSI report, using a differential offset, among the first differential offset and a second differential offset, based on a relationship between the first occasion and an uplink slot of the CSI report. The wireless device transmits, in the uplink slot, the CSI report based on a CSI reference signal (CSI-RS) received no later than the CSI reference resource.

### CROSS-REFERENCE TO RELATED APPLICATIONS

This application is a continuation of International Application No. PCT/US2025/011761, filed Jan. 16, 2025, which claims the benefit of U.S. Provisional Application No. 63/621,386, filed Jan. 16, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows several DCI formats.

FIG. 18A shows an example of a non-terrestrial network (NTN).

FIG. 18B shows an example of an NTN with a transparent payload.

FIG. 18C shows an example of assistance information (e.g., NTN assistance information) for maintenance of UL synchronization at a wireless device in an NTN.

FIG. 19A shows an example of UL/DL frame structure and uplink transmission timing in a wireless communication system.

FIG. 19B shows an example of timing advance for adjusting/maintaining UL/DL frame structure and/or uplink transmission timing in a wireless communication system.

FIG. 19C shows an example of Koffset in an NTN per an aspect of the present disclosure.

FIG. 20 and FIG. 21 show examples of channel state information (CSI) report in wireless communication systems.

FIG. 22 shows an example of CSI configuration per an aspect of the present disclosure.

FIG. 23 and FIG. 24 show examples of CSI report in an NTN per an aspect of the present disclosure.

FIG. 25A, FIG. 25B, FIG. 26A, and FIG. 26B show examples of CSI reporting in an NTN scenario per an aspect of the present embodiment.

FIG. 27, FIG. 28, FIG. 29, and FIG. 30 show examples of CSI reporting in an NTN scenario per an aspect of the present embodiment.

FIG. 31 illustrates an example flowchart of a procedure for CSI report in an NTN as per an aspect of an embodiment of the present disclosure.

FIG. 32 illustrates an example flowchart of a procedure for CSI report in an NTN as per an aspect of an embodiment of the present disclosure.

FIG. 33 illustrates an example flowchart of a procedure for CSI report in an NTN as per an aspect of an embodiment of the present disclosure.

FIG. 34 illustrates an example flowchart of a procedure for CSI report in an NTN as per an aspect of an embodiment of the present disclosure.

FIG. 35 illustrates an example flowchart of a procedure for CSI report in an NTN as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

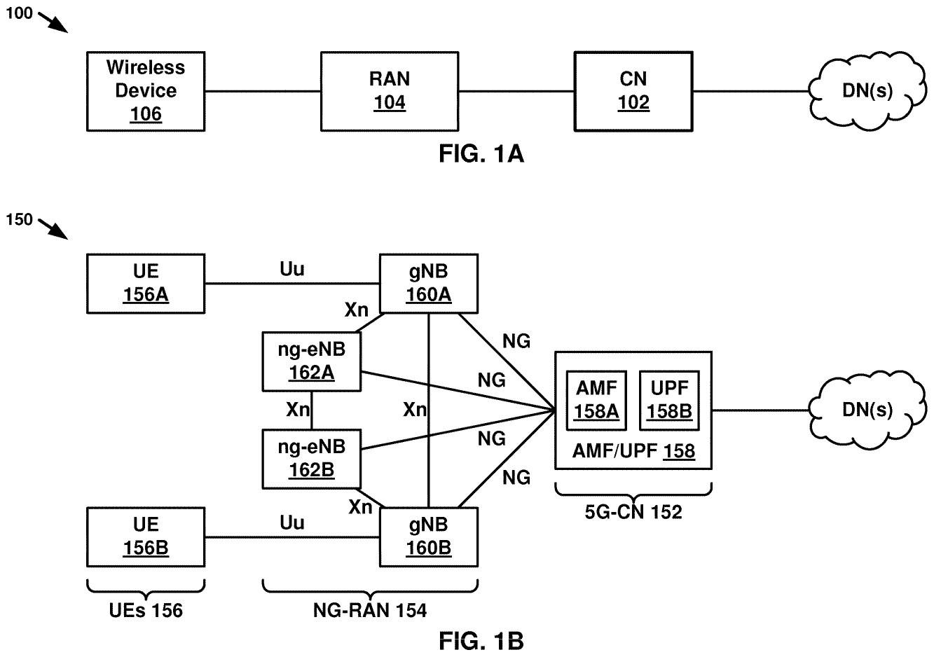

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNS), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

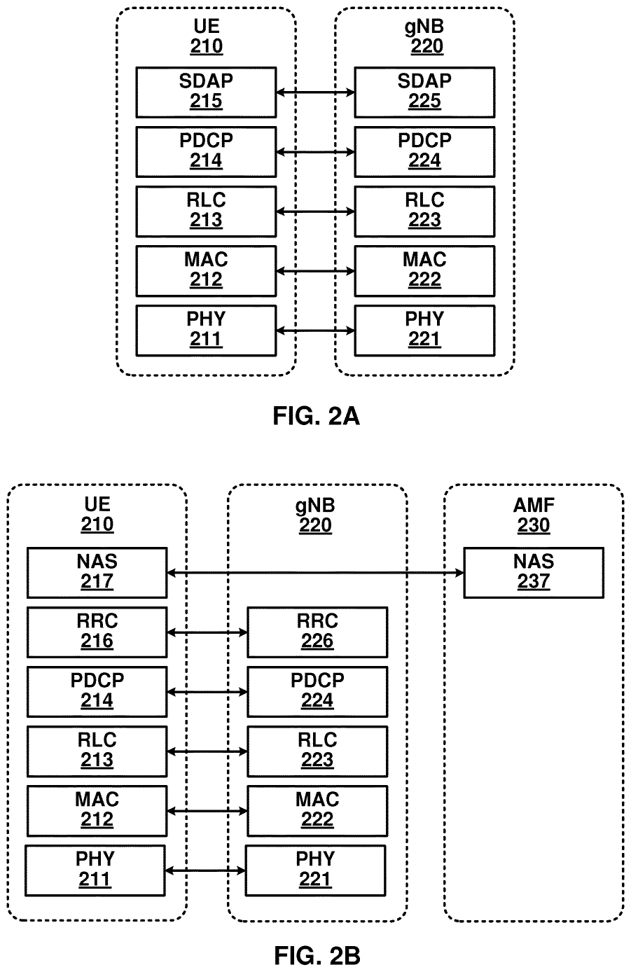

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

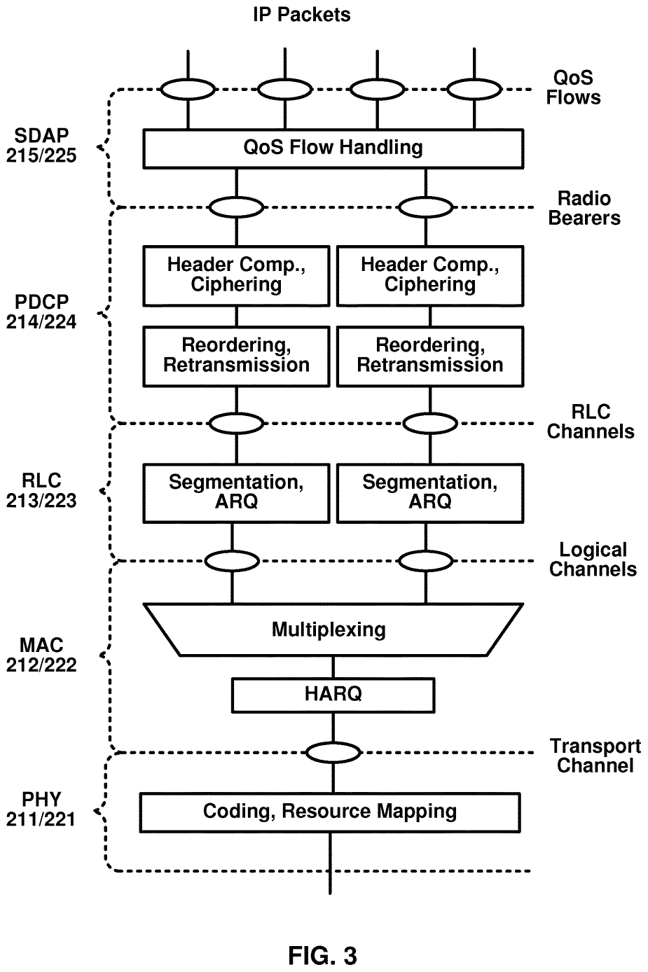

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

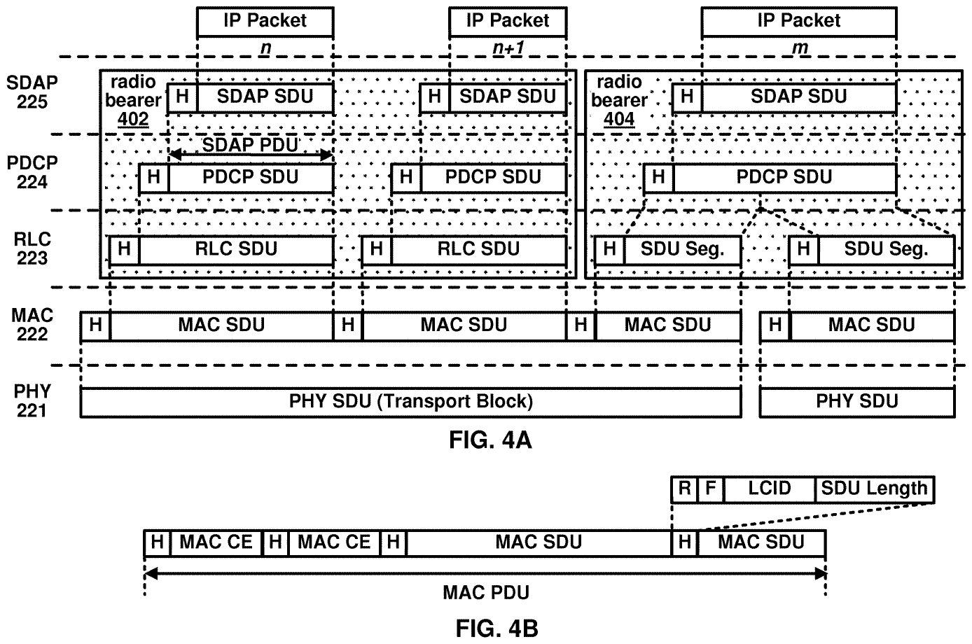

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

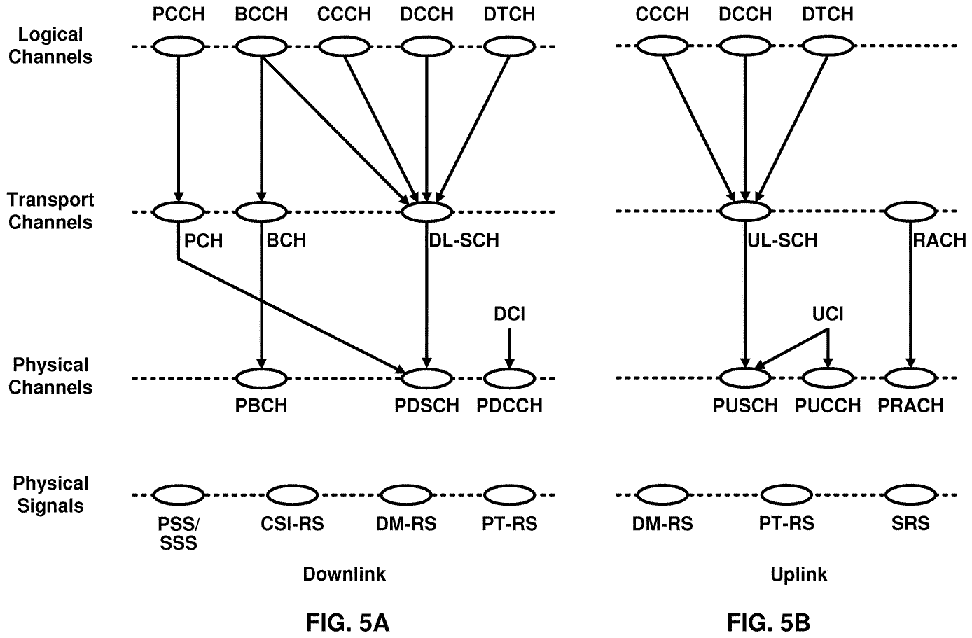

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

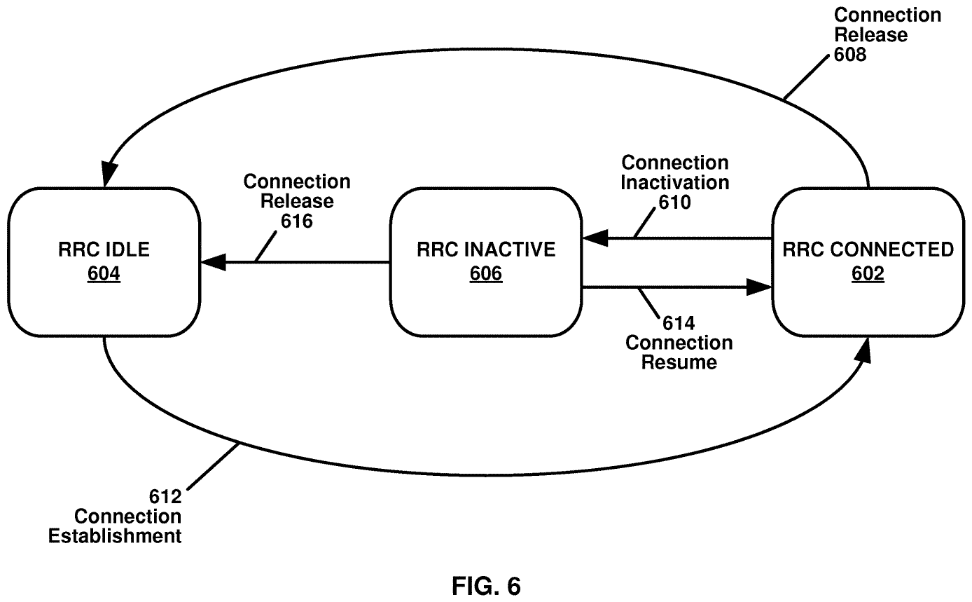

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAls. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

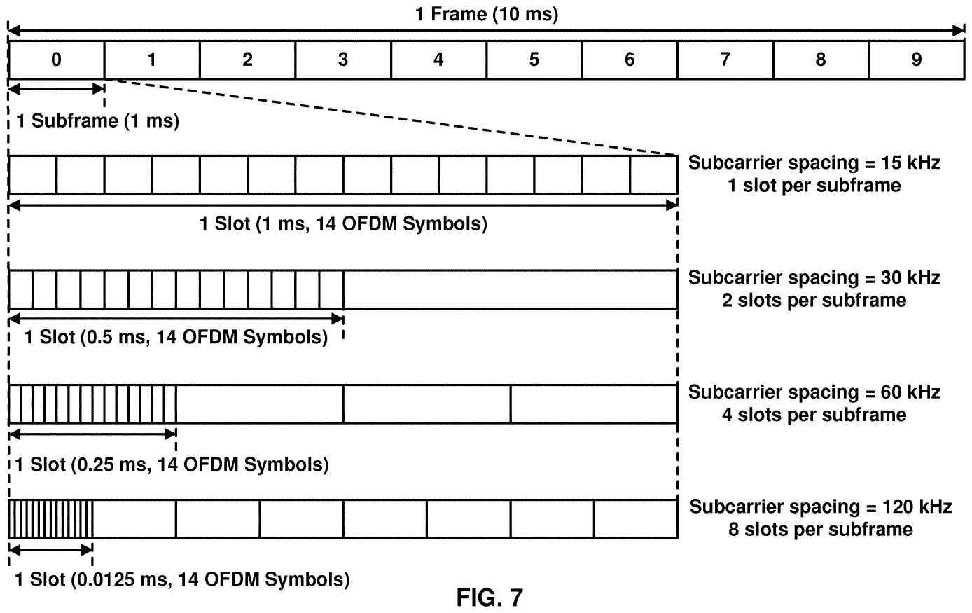

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 KHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

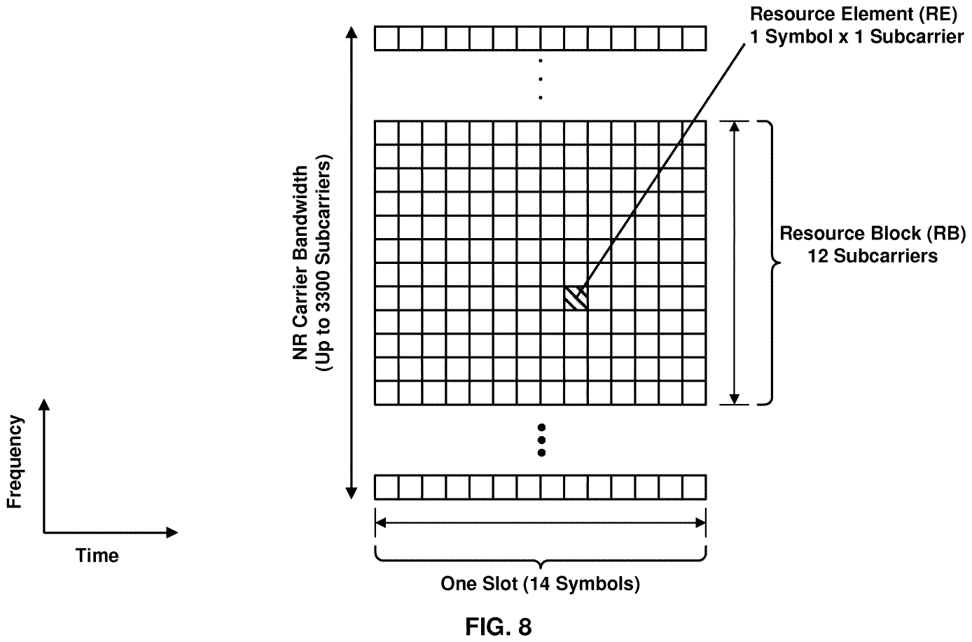

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

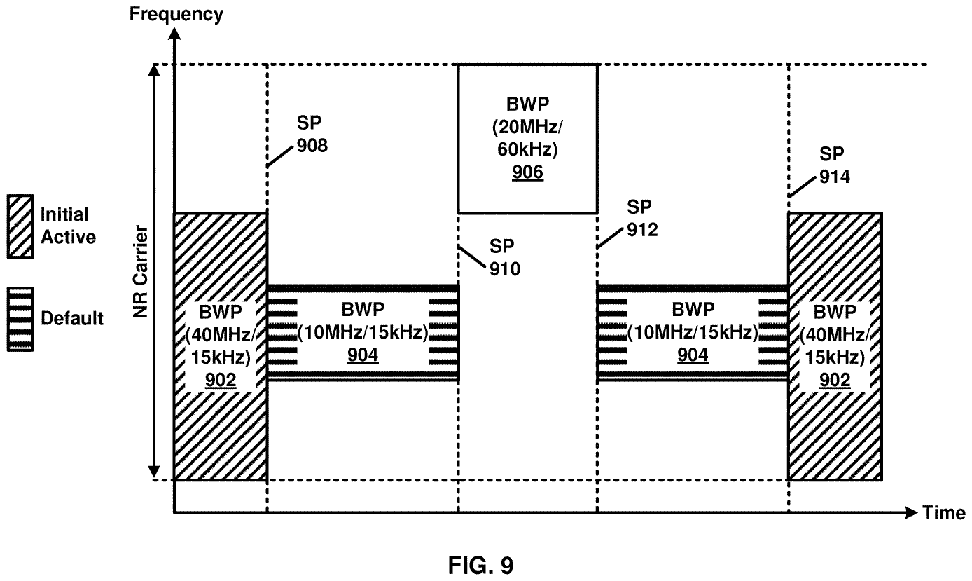

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

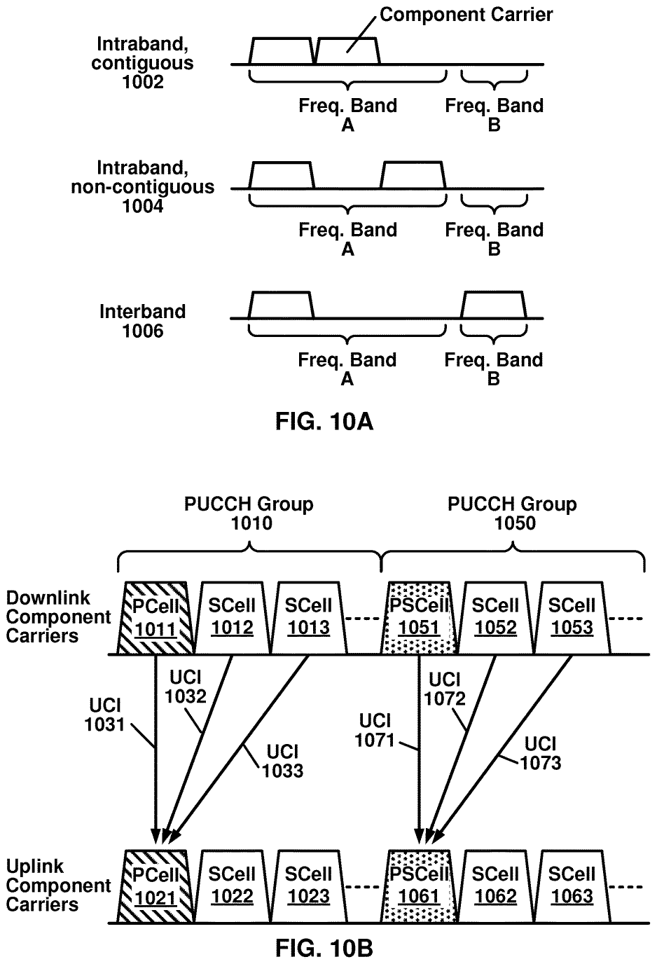

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

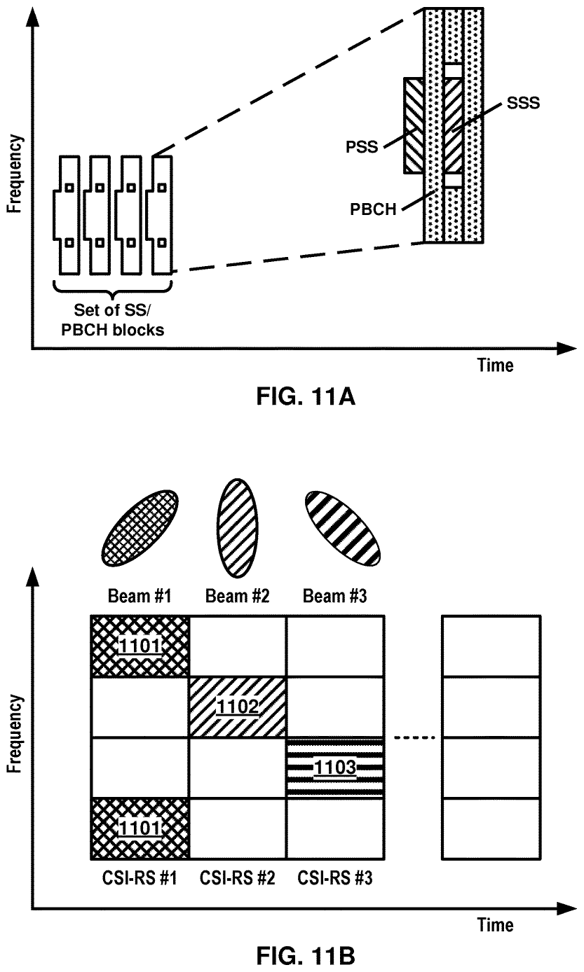

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

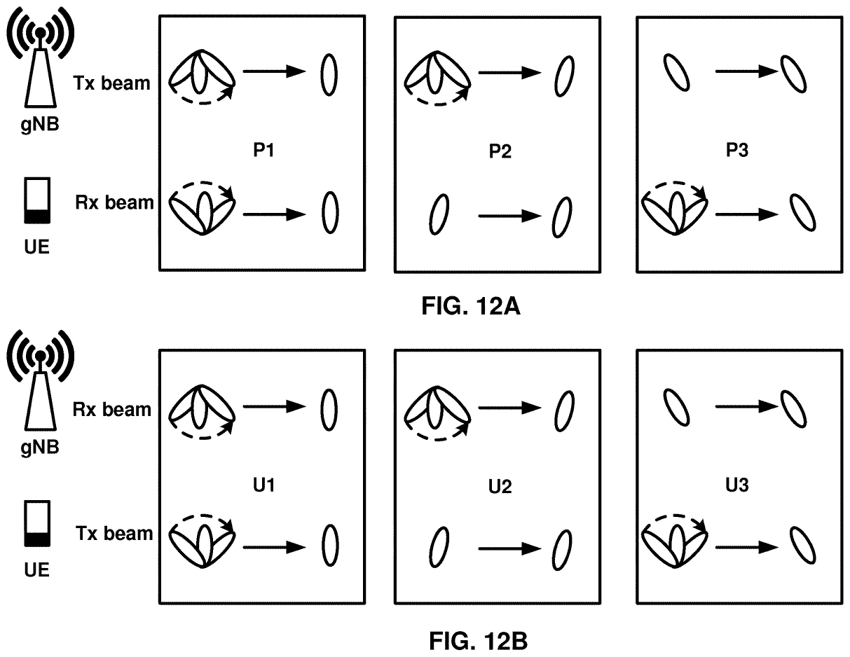

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

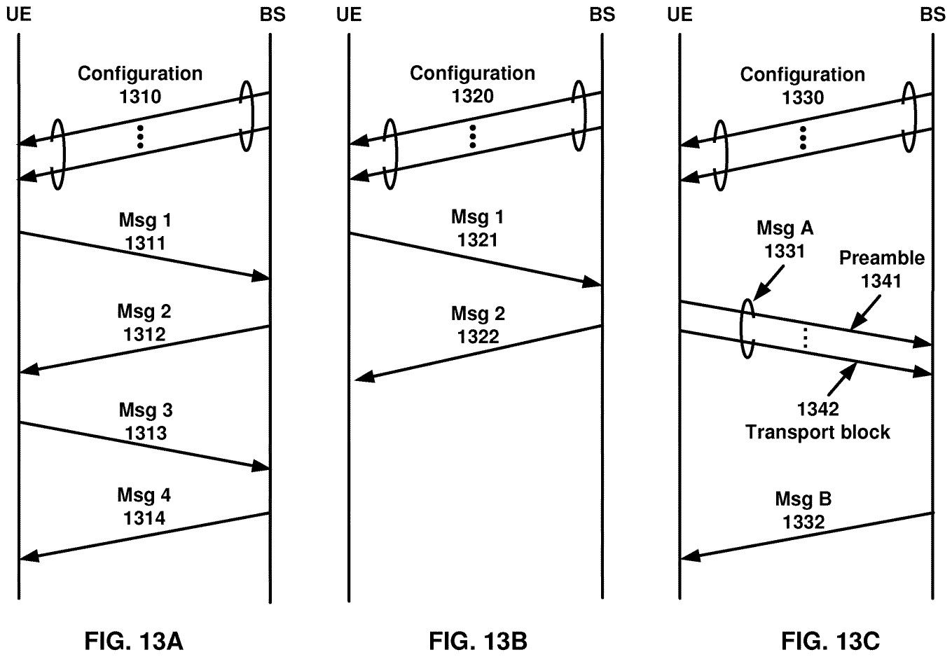

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceld). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

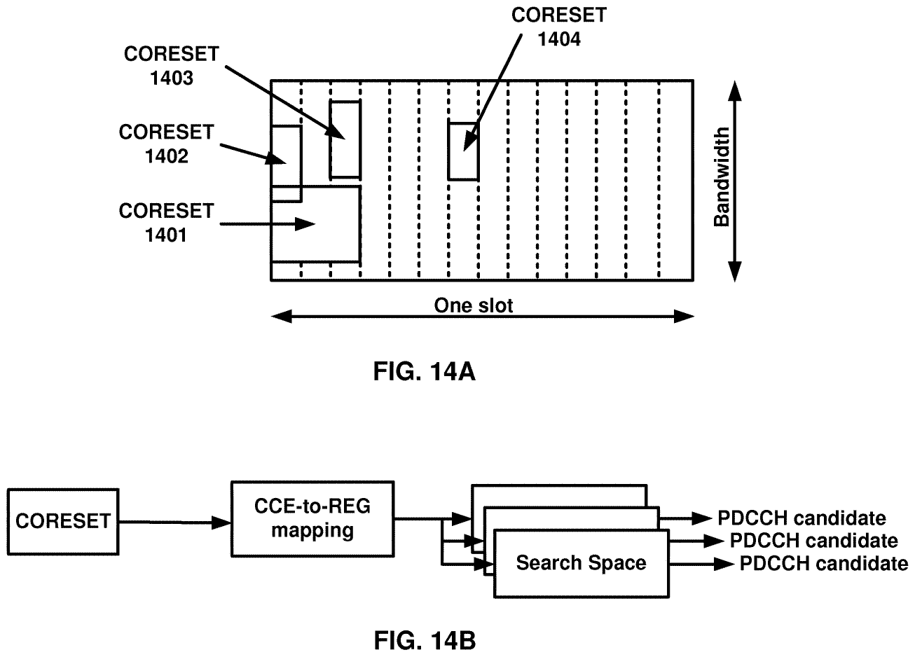

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

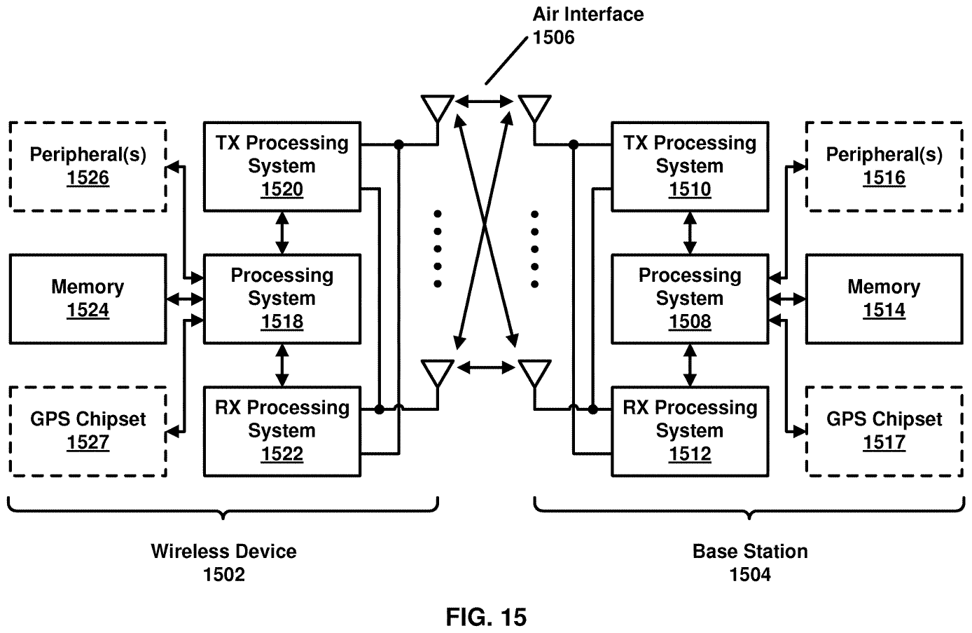

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

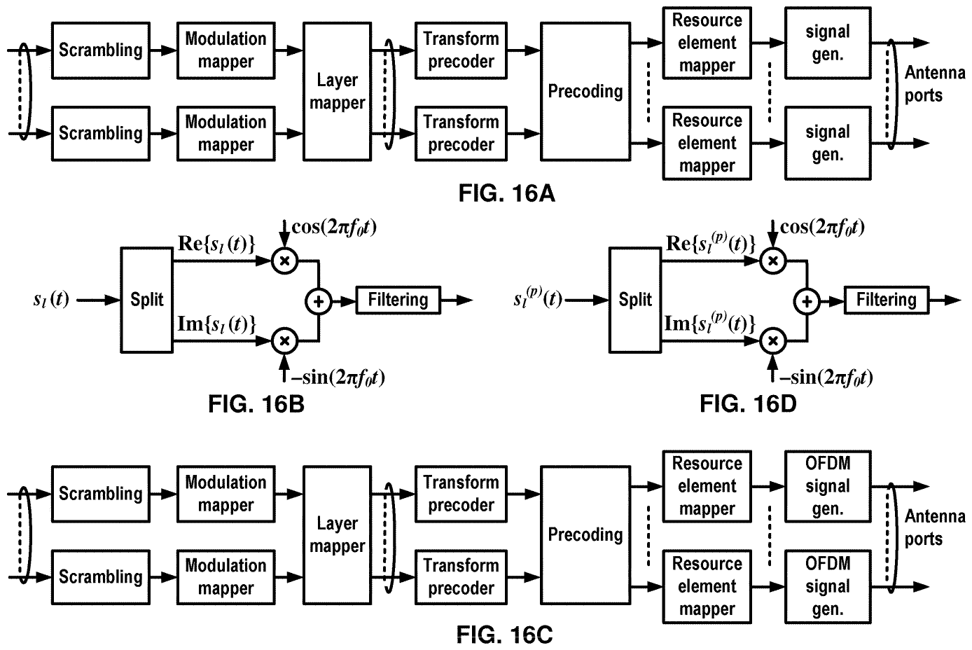

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format field (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In an example, the base station may transmit, to the wireless device, one or more messages (e.g., one or more downlink signals). The one or more messages may comprise one or more RRC messages, e.g., one or more RRC configuration/reconfiguration messages. For example, the one or more RRC messages may comprise one or more configuration parameters (e.g., one or more RRC configuration parameters). In some implementations, the one or more messages may comprise one or more MAC CEs and/or one or more DCIs. For example, the one or more RRC messages may correspond to broadcast or multicast or group cast downlink messages (e.g., SIBs). For example, the one or more RRC messages may correspond to unicast downlink messages and/or dedicated downlink messages.

A wireless device may perform a buffer status reporting (BSR) procedure, e.g., to provide a base station (e.g., a serving base station) and/or a network with information about UL data volume in an MAC entity of the wireless device. The one or more configuration parameters may comprise one or more BSR configuration parameters.

The one or more BSR configuration parameters may comprise information element(s) indicating values of following parameters: a periodic BSR timer, a retransmission BSR timer, a logical channel SR delay timer, a logical channel SR-delay timer applied, a logical channel SR mask, and/or a logical channel group.

A logical channel (LC) may be allocated to (e.g., associated with) a logical channel group (LCG) using the logicalChannelGroup.

A wireless device may trigger a BSR, e.g., if at least one of the one or more events occur. For example, the one or more events comprise a first event that UL data, for a logical channel which belongs to an LCG, becomes available to the MAC entity of the wireless device, and/or the UL data may belong to the logical channel with higher priority than the priority of any logical channel containing available UL data which belong to any LCG. For example, the one or more events comprise a second event that UL data, for a logical channel which belongs to an LCG, becomes available to the MAC entity of the wireless device, and/or none of logical channels which belong to an LCG may contain any available UL data, e.g., when the UL data becomes available. The BSR triggered, e.g., based on the first event and/or the second event may be referred below to as Regular BSR. For example, the one or more events comprise the one that UL resource(s) are allocated, and number of padding bits is equal to or larger than the size of the Buffer Status Report MAC CE plus its subheader, in which case the BSR is referred below to as Padding BSR. For example, the one or more events comprise the one that retxBSR-Timer expires, and/or at least one of logical channels which belong to an LCG contains UL data, in which case the BSR is referred below to as Regular BSR. For example, the one or more events comprise the one that periodicBSR-Timer expires, in which case the BSR is referred below to as Periodic BSR. For example, each logical channel may trigger one separate Regular BSR, e.g., when Regular BSR triggering events occur for multiple logical channels simultaneously.

A wireless device may determine, in response to at least one BSR being pending (e.g., having been triggered and/or not cancelled), if UL-SCH resources are available for a new transmission and/or if the UL-SCH resources may accommodate a BSR MAC CE plus its subheader as a result of logical channel prioritization. For example, the BSR MAC CE may comprise and/or indicate the at least one BSR.

A wireless device may perform instruct the multiplexing and assembly procedure to generate the BSR MAC CE(s), e.g., if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization.

A wireless device may trigger a scheduling request, e.g., if at least one BSR is pending (e.g., has been triggered and/or not cancelled). For example, the wireless device may trigger a scheduling request, e.g., if at least one BSR is pending (e.g., has been triggered and/or not cancelled), if a regular BSR has been triggered.

A wireless device may determine that UL-SCH resources are available, e.g., if a MAC entity of the wireless device has been configured with, receives, and/or determines an uplink grant. UL-SCH resources determined as available may be available for use, e.g., at a point in time that the UL-SCH resources are determined as available. UL-SCH resources determined as available may not be available for use, e.g., at a point in time that the UL-SCH resources are determined as available. UL-SCH resources determined as available may not be available for use at a point in time that the UL-SCH resources are determined as available, e.g., if the UL-SCH resources are overlapped with other resources (e.g., SSB transmission) and/or if the UL-SCH resources are invalid.

A MAC PDU may comprise at least one (e.g., at most one) BSR MAC CE. For example, a MAC PDU may comprise at least one (e.g., at most one) BSR MAC CE, e.g., when multiple events have triggered one or more BSRs. For example, a wireless device may select a BSR among the one or more BSRs and/or may multiplex the MAC PDU comprising the at least one (e.g., at most one) BSR MAC CE corresponding to the selecting BSR. For example, the wireless device may select the BSR among the one or more BSRs based on a priority among the one or more BSRs. For example, the Regular BSR may have precedence over the padding BSR. For example, the Periodic BSR may have precedence over the padding BSR.

The MAC entity of the wireless device may cancel one or more (e.g., all) triggered BSRs, e.g., when the UL grant(s) may accommodate pending data (e.g., all pending data) available for transmission and/or may be not sufficient to additionally accommodate the BSR MAC CE plus its subheader. All BSRs triggered prior to MAC PDU assembly shall be cancelled when a MAC PDU is transmitted and this PDU includes a Long or Short BSR MAC CE which contains buffer status up to (and including) the last event that triggered a BSR prior to the MAC PDU assembly.

A wireless device may perform a MAC PDU assembly, e.g., at any point, in time between uplink grant reception and actual transmission of the corresponding MAC PDU. For example, the wireless device may trigger BSR and SR, e.g., after or in response to the assembly of a MAC PDU which may comprise a BSR MAC CE, and/or before the transmission of this MAC PDU. For example, the wireless device may trigger BSR and SR during MAC PDU assembly.

A wireless device may trigger and/or transmit a scheduling request (SR), e.g., to request UL-SCH resources for a transmission (e.g., new transmission) and/or beam failure recovery and/or consistent LBT failure or the like. The one or more configuration parameters may configure a MAC entity of the wireless device with zero, one, or more SR configurations. For example, the one or more configuration parameters may comprise one or more SR configuration parameters configuring one or more SR configurations. An SR configuration of the one or more SR configurations may comprise a set of PUCCH resource(s) for SR across different BWP(s) and/or cell(s).

The SR configuration may correspond to one or more logical channels and/or to SCell beam failure recovery and/or to consistent LBT failure recovery. Each logical channel, SCell beam failure recovery, and/or consistent LBT failure recovery, may be mapped to zero or one SR configuration of the one or more SR configurations. The wireless device may determine the SR configuration of the logical channel that triggered a BSR or the SCell beam failure recovery or the consistent LBT failure recovery (if such a configuration exists) as corresponding SR configuration for the triggered SR. The wireless device may use any SR configuration of the one or more SR configurations for an SR triggered by Pre-emptive BSR.

For example, the SR configuration may comprise/indicate sr-ProhibitTimer and/or sr-TransMax.

The wireless device may maintain one or more variables used for the scheduling request procedure. For example, the one or more variables comprise a counter, e.g., SR_COUNTER, counting a number of SR triggered and/or a number of transmissions of SR triggered and/or pending. The wireless device may maintain the SR_COUNTER per SR configuration. The wireless device may set the SR_COUNTER of the corresponding SR configuration to 0 (e.g., or any initial value), e.g., if an SR is triggered and there are no other SRs pending corresponding to the same SR configuration. The wireless device may determine an SR as pending until it is cancelled, e.g., when the SR is triggered.

The wireless device may cancel pending SR(s) (e.g., all pending SR(s) for BSR triggered according to the BSR procedure, e.g., prior to the MAC PDU assembly and/or may stop each respective sr-ProhibitTimer, e.g., when the wireless device transmit the MAC PDU and this PDU comprises a Long and/or Short BSR MAC CE which contains buffer status up to (and comprising) the last event that triggered a BSR prior to the MAC PDU assembly. The wireless device may cancel pending SR(s) (e.g., all pending SR(s)) for BSR triggered according to the BSR procedure and may stop each respective sr-ProhibitTimer, e.g., when the UL grant(s) accommodate pending data (e.g., all pending data) available for transmission.

An MAC entity of the wireless device may, for each pending SR not triggered according to the BSR procedure for a Serving Cell, cancel the pending SR and stop the corresponding sr-ProhibitTimer (e.g., if running), e.g., if this SR was triggered by Pre-emptive BSR procedure prior to the MAC PDU assembly and/or a MAC PDU comprising the relevant Pre-emptive BSR MAC CE is transmitted. The MAC entity may, for each pending SR not triggered according to the BSR procedure for a Serving Cell, cancel the pending SR and stop the corresponding sr-ProhibitTimer (e.g., if running), e.g., if this SR was triggered by beam failure recovery of an SCell and/or a MAC PDU is transmitted and this PDU comprises a BFR MAC CE or a Truncated BFR MAC CE which contains beam failure recovery information for this SCell. The MAC entity may, for each pending SR not triggered according to the BSR procedure for a Serving Cell, cancel the pending SR and stop the corresponding sr-ProhibitTimer (e.g., if running), e.g., if this SR was triggered by beam failure recovery of an SCell and this SCell is deactivated. The MAC entity may, for each pending SR not triggered according to the BSR procedure for a Serving Cell, cancel the pending SR and stop the corresponding sr-ProhibitTimer (e.g., if running), e.g., if this SR was triggered by consistent LBT failure recovery of a cell (e.g., an SCell) and a MAC PDU is transmitted and the MAC PDU comprises an LBT failure MAC CE that indicates consistent LBT failure for this cell (e.g., SCell). The MAC entity may, for each pending SR not triggered according to the BSR procedure for a Serving Cell, cancel the pending SR and stop the corresponding sr-ProhibitTimer (e.g., if running), e.g., if this SR was triggered by consistent LBT failure recovery of a cell (e.g., SCell) and the triggered consistent LBT failure(s) (e.g., all the triggered consistent LBT failure(s) for this cell (e.g., SCell) are cancelled.

The wireless device may determine that one or more PUCCH resources are valid, e.g., if the one or more PUCCH resources are scheduled on a BWP which is active at the time of SR transmission occasion. The MAC entity may, for each pending SR, initiate a random access procedure on a cell (e.g., SpCell) and cancel the pending SR, e.g., if at least one SR is pending and/or if the MAC entity has no valid PUCCH resource configured for the pending SR.

The MAC entity may, for each pending SR and/or for the SR configuration corresponding to the pending SR, determine whether one or more first conditions, e.g., to signal an SR on one valid PUCCH resource for SR, satisfy, e.g., when (or if) at least one SR is pending, and/or when (or if) the MAC entity has valid PUCCH resource(s) configured for the pending SR, and/or when (or if) the MAC entity has an SR transmission occasion on the valid PUCCH resource for SR configured. For example, the one or more first conditions may comprise sr-ProhibitTimer being not running at the time of the SR transmission occasion and/or the PUCCH resource for the SR transmission occasion being not overlapped with a measurement gap.

The wireless device may stop (e.g., if any) ongoing Random Access procedure due to a pending SR for BSR, which was initiated by the MAC entity prior to the MAC PDU assembly and which has no valid PUCCH resources configured, e.g., if a MAC PDU is transmitted using a UL grant other than a UL grant provided by Random Access Response or a UL grant determined for the transmission of the MSGA payload, and this PDU comprises a BSR MAC CE which contains buffer status up to (and comprising) the last event that triggered a BSR prior to the MAC PDU assembly.

The wireless device may stop (e.g., if any) ongoing Random Access procedure due to a pending SR for BSR, which was initiated by the MAC entity prior to the MAC PDU assembly and which has no valid PUCCH resources configured, e.g., if the UL grant(s) can accommodate pending data (e.g., all pending data) available for transmission.

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells).

When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. In an example, the serving cell may be a PCell.

In an example, the one or mor configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate the SCell in response to receiving an SCell Activation/Deactivation MAC CE.

For example, the base station may configure (e.g., via the one or more RRC messages/parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (e.g., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

A serving cell may be a cell (e.g., PCell, SCell, PSCell, etc.) on which the wireless device may receive SSB/CSI-RS/PDCCH/PDSCH and/or may transmit PUCCH/PUSCH/SRS etc. The serving cell is identified by a serving cell index (e.g., ServCellIndex or SCellIndex configured/indicated by the one or more configuration parameters). For a wireless device in RRC_CONNECTED not configured with CA/DC, there may only be one serving cell comprising of a primary cell. For a wireless device in RRC_CONNECTED configured with CA/DC the term ‘serving cells’ may be used to denote a set of cells comprising of the Special Cell(s) and one or more (e.g., all) secondary cells. For a wireless device configured with CA, a cell providing additional radio resources on top of Special Cell is referred to as a secondary cell.

A non-serving (or neighbor) cell may be a cell on which the wireless device may not receive MIBs/SIBs/PDCCH/PDSCH and/or may not transmit PUCCH/PUSCH/SRS etc. The non-serving cell has a physical cell identifier (PCI) different from a PCI of a serving cell. The non-serving cell may not be identified by (or associated with) a serving cell index (e.g., ServCellIndex or SCellIndex). The wireless device may rely on an SSB of a non-serving cell for Tx/Rx beam (or spatial domain filter) determination (for PDCCH/PDSCH/PUCCH/PUSCH/CSI-RS/SRS for a serving cell, etc.), e.g., when a TCI state of the serving cell is associated with (e.g., in TCI-state IE of TS 38.331) a SSB of the non-serving cell. The base station may not transmit configuring resources/parameters of PDCCH/PDSCH/PUCCH/PUSCH/SRS of a non-serving cell to the wireless device.

In an example, the base station and/or the wireless device may switch a BWP between configured BWPs by means of a DCI or a BWP invalidity timer. When the BWP invalidity timer is configured for the serving cell, the base station and/or the wireless device may switch the active BWP to a default BWP in response to the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: transmitting on UL-SCH; transmitting on RACH; monitoring a PDCCH; transmitting PUCCH; receiving DL-SCH; and/or (re-) initializing any suspended configured uplink grants of configured grant Type 1 according to a stored configuration, if any. In an example, on the inactive/idle BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, a DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

In an example, a set of PDCCH candidates for the wireless device to monitor is defined in terms of one or more search space sets. A search space set may comprise a common search space (CSS) set or a UE-specific search space (USS) set. The wireless device may monitor one or more PDCCH candidates in one or more of the following search space sets (e.g., one or more search space sets): a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by the SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by a INT-RNTI, a SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, a MCS-C-RNTI, or a CS-RNTI(s), and the USS set configured by SearchSpace in PDCCH-Config with searchSpaceType=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

In an example, the wireless device may monitor the one or more PDCCH candidates according to one or more configuration parameters of the search space set. For example, the search space set may comprise a plurality of search spaces (SSs). The wireless device may monitor the one or more PDCCH candidates in one or more CORESETs for detecting one or more DCIs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s), e.g., number of CCEs, number of PDCCH candidates in CSS set(s), and/or number of PDCCH candidates in the USS(s), and/or possible (or configured) DCI format(s).

In an example, the wireless device may receive the C-RNTI (e.g., via one or mor previous transmissions) from the base station. For example, the one or more previous transmissions may comprise a Msg2 1312, Msg4 1314, or a Msg B 1332. If the wireless device is not provided the Type3-PDCCH CSS set or the USS set and if provided the Type1-PDCCH CSS set, the wireless device may monitor the one or more PDCCH candidates for DCI format 0_0 and DCI format 1_0 with CRC scrambled by the C-RNTI in the Type1-PDCCH CSS set.

For example, the one or more search space sets may correspond to one or more of searchSpaceZero, searchSpaceSIB1, searchSpaceOtherSystemInformation, pagingSearchSpace, ra-SearchSpace, and the C-RNTI, the MCS-C-RNTI, or the CS-RNTI. The wireless device may monitor the one or more PDCCH candidates for the DCI format 0_0 and the DCI format 1_0 with CRC scrambled by the C-RNTI, the MCS-C-RNTI, or the CS-RNTI in the one or more search space sets in a slot where the wireless device monitors the one or more PDCCH candidates for at least the DCI format 0_0 or the DCI format 1_0 with CRC scrambled by the SI-RNTI, the RA-RNTI, the MSGB-RNTI, or the P-RNTI.

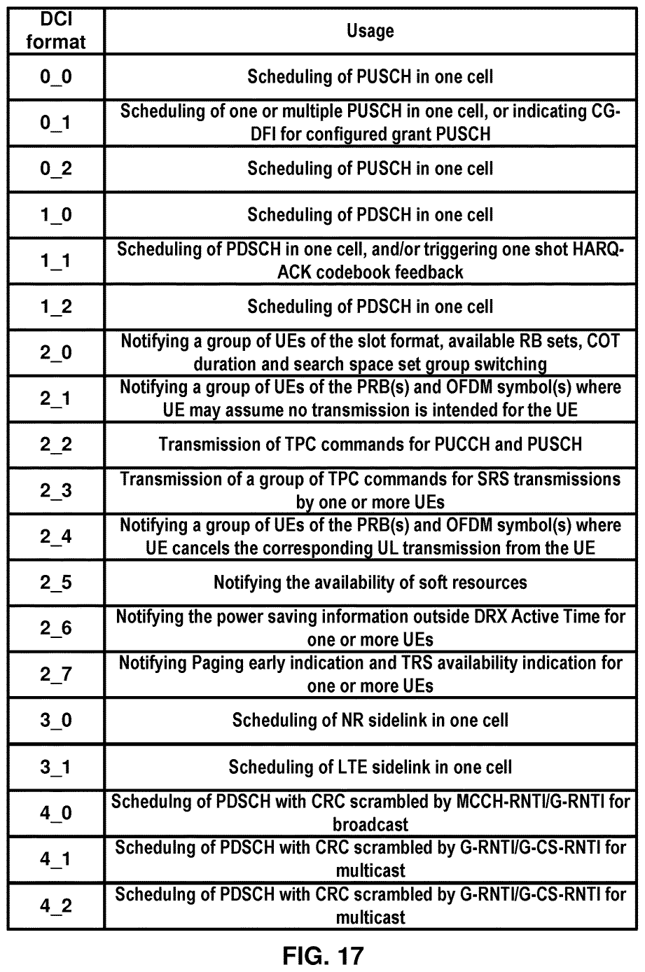

FIG. 17 shows several DCI formats. For example, the base station may use the DCI formats to transmit downlink control information to the wireless device. In an example, the wireless device may use the DCI formats for PDCCH monitoring. Different DCI formats may comprise different DCI fields and/or have different DCI payload sizes. Different DCI formats may have different signaling purposes. As shown in FIG. 17, DCI format 0_0 may be used to schedule PUSCH in one cell. DCI format 0_1 may be used to schedule one or multiple PUSCH in one cell or indicate CG-DFI (configured grant-Downlink Feedback Information) for configured grant PUSCH, etc.

In an example, the wireless device may support a baseline processing time/capability. For example, the wireless device may support additional aggressive/faster processing time/capability. In an example, the wireless device may report to the base station a processing capability, e.g., per sub-carrier spacing. In an example, a PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. In an example, the first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

In an example, a PUSCH preparation/processing time may be considered for determining the transmission time of an UL data. For example, if the first uplink symbol in the PUSCH allocation for a transport block (including DM-RS) is no earlier than at symbol L2, the wireless device may perform transmitting the PUSCH. In an example, the symbol L2 may be determined, by a wireless device, at least based on a slot offset (e.g., K2), SLIV of the PUSCH allocation indicated by time domain resource assignment of a scheduling DCI. In an example, the symbol L2 may be specified as the next uplink symbol with its CP starting after a time gap with length T_{proc,2} after the end of the reception of the last symbol of the PDCCH carrying the DCI scheduling the PUSCH.

A wireless device may monitor a set of PDCCH candidates according to configuration parameters of a search space set comprising a plurality of search spaces (SSs). The wireless device may monitor a set of PDCCH candidates in one or more CORESETs for detecting one or more DCIs. The one or more configuration parameters may configure the one or more CORESETs. Monitoring (e.g., of the PDCCH) may comprise decoding one or more PDCCH candidates of the set of the PDCCH candidates according to monitored DCI formats. Monitoring (e.g., of the PDCCH) may comprise decoding a DCI content of one or more PDCCH candidates with possible (or configured) PDCCH locations, possible (or configured) PDCCH formats (e.g., number of CCEs, number of PDCCH candidates in common SSs, and/or number of PDCCH candidates in the UE-specific SSs) and/or possible (or configured) DCI formats (e.g., FIG. 17). The decoding (e.g., of the PDCCH) may be a blind decoding. The one or more configuration parameters may configure the wireless device with DCI format(s) by which the wireless device may monitor the PDCCH in an SS of the plurality of SSs.

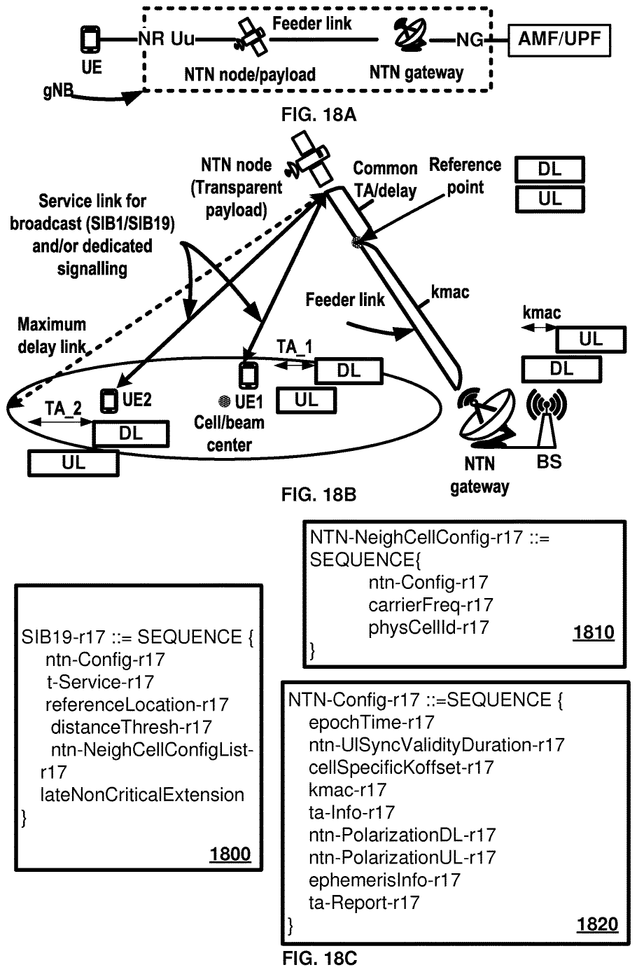

FIG. 18A shows an example of a non-terrestrial network (NTN). FIG. 18B shows an example of an NTN with a transparent payload. FIG. 18C shows an example of assistance information (e.g., NTN assistance information) for maintenance of UL synchronization at a wireless device in an NTN. A non-terrestrial network (NTN) network (e.g., a satellite network) may be a network or a network segment (e.g., an NG-RAN consisting of gNBs) for providing non-terrestrial NR access to wireless devices. The NTN may use a space-borne vehicle to embark a transmission equipment relay node (e.g., radio remote unit or a transparent payload) or a base station (or a regenerative payload). While a terrestrial network is a network located on the surface of the earth, an NTN may be a network which uses an NTN node (e.g., a satellite) as an access network, a backhaul interface network, or both. In an example, an NTN may comprise one or more NTN nodes (or payloads and/or space-borne vehicles), each of which may provide connectivity functions, between the service link and the feeder link. As shown in FIG. 18B, a base station may, via the service link, transmit broadcast channels/signals (e.g., system information blocks, e.g., SIBx, x=1, 2, . . . , 19, . . . ), multicast channels/signals, and/or dedicated channels/signals to wireless devices, e.g., via one or more cells/beams.

An NTN node may embark a bent pipe payload (e.g., a transparent payload) or a regenerative payload. The NTN node may have capability to store information/data received from the wireless devices and/or the base stations and forward the stored information/data to receivers (and/or other NTN platforms), e.g., a store and forward (S&F) NTN scenario. The NTN node with the transparent payload may comprise transmitter/receiver circuitries without the capability of on-board digital signal processing (e.g., modulation and/or coding) and connect to a base station (e.g., a base station of an NTN or the NTN base station or a non-terrestrial access point) via a feeder link. In some respects, as shown in FIG. 18A, the base station (e.g., a gNB/eNB) may further comprise the transparent NTN node, the feeder link, and/or a gateway (e.g., an NTN gateway). The gateway may be an earth station that is located at the surface of the earth, providing connectivity to the NTN payload using a feeder link. In some examples, the NTN node with the regenerative payload (e.g., the base station of the NTN or the NTN base station) may comprise functionalities of a base station, e.g., the on-board processing used to demodulate and decode the received signal and/or regenerate the signal before sending/transmitting it back to the earth. In some respects, the base station (e.g., the gNB) may further comprise the regenerative NTN node, the feeder link, and/or the gateway (e.g., the NTN gateway).

In some examples, the NTN node may be a satellite, a balloon, an air ship, an airplane, an unmanned aircraft system (UAS), an unmanned aerial vehicle (UAV), a drone, or the like. For example, the UAS may be a blimp, a high-altitude platform station (HAPS), e.g., an airborne vehicle embarking the NTN payload placed at an altitude between 8 and 50 km, or a pseudo satellite station. In an example, a satellite may be placed into a low-earth orbit (LEO) at an altitude between 250 km to 1500 km, with orbital periods ranging from 90-130 minutes. From the perspective of a given point on the surface of the earth, the position of the LEO satellite may change. In an example, a satellite may be placed into a medium-earth orbit (MEO) at an altitude between 5000 to 20000 km, with orbital periods ranging from 2 hours to 14 hours. In an example, a satellite may be placed into a geostationary satellite earth orbit (GEO) at 35,786 km altitude, and directly above the equator. From the perspective of a given point on the surface of the earth, the position of the GEO satellite may not change.

FIG. 18B shows an example of an NTN with a transparent NTN platform. Although FIG. 18B only shows an example of the NTN with the transparent NTN platform/payload/node, embodiments of FIG. 18B may be applicable for an NTN with a regenerative NTN platform or a store and forward (S&F) NTN scenario. As shown in FIG. 18B, the NTN node (e.g., the satellite) may forward a received signal (or stored data/information) from the NTN gateway on the ground back to the earth over the feeder link. In an example, the gateway and the base station may not be collocated or may be collocated. The NTN node may forward a received signal (or data) to the wireless device or the base station from another NTN node, e.g., over inter-link satellite communication links.

The NTN node may generate one or more beams over a given area (e.g., a coverage area or a cell). The footprint of a beam (or the cell) may be referred to as a spotbeam. For example, the footprint of a cell/beam may move over the Earth's surface with the satellite movement (e.g., a LEO with moving cells or a HAPS with moving cells). The footprint of a cell/beam may be Earth fixed (e.g., quasi-earth-fixed) with some beam pointing mechanism used by the satellite to compensate for its motion (e.g., a LEO with earth fixed cells). The size of a spotbeam (e.g., diameter of the spotbeam and/or cell and/or coverage area) may range from tens of kilometers (e.g., 50 km-200 km) to a few thousand kilometers (e.g., 3500 km). For example, the size of the spotbeam may depend on the system design.

A propagation delay (e.g., a round-trip propagation delay or a round-trip transmission delay) may be an amount of time it takes for the head of the signal to travel from a sender (e.g., the base station or the NTN node) to a receiver (e.g., the wireless device) and/or vice versa. The propagation delay may vary depending on a change in distance between the sender and the receiver, e.g., due to movement of the NTN node, movement of the wireless device, a change of an inter-satellite link, and/or feeder link switching. One-way latency/delay may be an amount of time required to propagate through a telecommunication system from the sender (e.g., the base station) to the receiver (e.g., the wireless device). For the transparent NTN, the round-trip propagation delay (RTD or RTT or UE-gNB RTT) may comprise service link delay (e.g., between the NTN node and the wireless device), feeder link delay (e.g., between the NTN gateway and the NTN node), and/or between the gateway and the base station (e.g., in the case the gateway and the NTN base station are not collocated). For example, the UE-gNB RTT (or the RTD) may be twice of the one-way delay between the wireless device and the base station. In case of a GEO satellite with the transparent payload, the RTD may be approximately 556 milliseconds. A (maximum) RTD of a LEO satellite with the transparent payload and altitude of 600 km is approximately 25.77 milliseconds and with altitude of 1200 km is approximately 41.77 milliseconds. In an example, the RTD of a terrestrial network (e.g., NR, E-UTRA, LTE) may be negligible compared to the RTD of an NTN scenario (e.g., the RTD of a terrestrial network may be less than 1 millisecond).

A differential delay within a beam/cell of a NTN node may depend on, for example, the maximum diameter of the beam/cell footprint at nadir. For example, the differential delay withing the beam/cell may correspond to a maximum delay link in FIG. 18B. In an example, the differential delay may imply the maximum difference between communication latency that two wireless devices, e.g., a first wireless device (UE1) that is located close to the center of the cell/beam and a second wireless device (UE2) that is located close to the edge of the cell/beam in FIG. 18B, may experience while communicating with the base station via the NTN node. The first wireless device may experience a smaller RTD compared to the second wireless device. The link with a maximum propagation delay (e.g., the maximum delay link) may experience the highest propagation delay (or the maximum RTD) in the cell/beam. In an example, the differential delay may imply a difference between the maximum delay of the cell/beam and a minimum delay of the cell/beam. In an example, the service link to a cell/beam center may experience the minimum propagation delay in the cell/beam. Depending on implementation, for a LEO satellite, the differential delay may be at least 3.12 milliseconds and may increase up to 8 milliseconds. In an example of a GEO satellite, depending on implementation, the differential delay may be as large as 32 milliseconds.

FIG. 18C shows as example of the NTN assistance information (e.g., for maintaining the UL synchronization). A base station may transmit to a wireless device the NTN assistance information via an NTN-specific SIB (e.g., SIB19 or SIB31) 1800. In another example, common configuration parameters of a serving cell may comprise the NTN assistance information, e.g., an NTN-config (e.g., ntn-Config-r17, e.g., corresponding to the serving cell with a first PCI). The one or more configuration parameters may comprise the common configuration parameters of the serving cell (e.g., IE ServingCellConfigCommon). The serving cell may belong to the NTN. The wireless device may communicate with the base station via the serving cell (of the NTN). The Serving cell may be a first/source cell (with/identified by, a first PCI) and/or a second/target cell (with/identified by a second PCI). In one example, the base station may transmit to the wireless device the common configuration parameters of the serving cell via a system broadcast information (e.g., SIB1) or an RRC reconfiguration message (e.g., a handover message). For example, the base station may transmit the common configuration parameters of the serving cell via one or more RRC messages (e.g., RRC setup message, RRC establishment message, RRC re-establishment message, and/or RRC reconfiguration message). The base station may transmit the common configuration parameters of the serving cell during the initial access procedure and/or the handover procedure.

The NTN assistance information may comprise a first set of NTN configuration parameters. For example, the first set of NTN configuration parameters may comprise at least one NTN-config (e.g., ntn-config-r17 1820). The at least one NTN-config may correspond to a cell (e.g., the serving cell) of the NTN and/or a non-serving cell of the NTN (e.g., a target cell or a neighbor cell of the NTN). The at least one NTN-config may correspond to a serving NTN node (satellite) or a target NTN node (satellite). Each NTN-config (e.g., ntn-Config 1820) of the at least one NTN-config may correspond to a cell (e.g., the serving cell or a neighbor cell of the NTN) with a corresponding physical cell ID (PCI). The wireless device may be in an RRC_CONNECTED state/mode or in an RRC inactive state/mode or in an RRC idle state (or mode).

As shown in FIG. 18C, the first set of NTN configuration parameters may comprise NTN-configs of one or more NTN neighbor cells (e.g., via ntn-NeighCellConfigList IE or ntn-NeighCellConfigListExt IE or the like) 1810. Each NTN neighbor cell of the one or more NTN neighbor cells may have its unique PCI. For example, the at least one NTN-config may comprise the one or more NTN neighbor cells. For example, the ntn-NeighCellConfigList (and/or ntn-NeighCellConfigListExt) may indicate/provide/configure a list of NTN neighbour cells (e.g., the one or more NTN neighbor cells) including their corresponding ntn-Config(s), carrier frequency and PhysCellld (PCI).

The NTN assistance information (e.g., the first set of NTN configuration parameters) may comprise the NTN-config of the common configuration parameters of the serving cell (e.g., a first NTN configuration parameters). The first NTN configuration parameters (e.g., a first NTN-config of the at least one NTN-config) may correspond to the first PCI or the first cell (e.g., the source cell). When the common configuration parameters of the serving cell correspond to the RRC setup message (and/or the RRC establishment message and/or RRC re-establishment message), the NTN-config of the common configuration parameters of the serving cell may correspond to the source cell. When the common configuration parameters of the serving cell correspond to the RRC reconfiguration message, the NTN-config of the common configuration parameters of the serving cell may correspond to the target cell (e.g., a second NTN configuration parameters e.g., a second NTN-config of the at least one NTN-config). The second NTN configuration parameters (e.g., the second NTN-config of the at least one NTN-config) may correspond to the second PCI or the second cell (e.g., the target cell).

An NTN-config (ntn-Config) of the at least one NTN-config may indicate/configure/provide parameters needed for the wireless device to access NR/LTE (or a 6G system) via NTN access. Each/an NTN-config of the at least one NTN-config (e.g., NTN-config-r17 1820) may comprise at least one of the following (or a combination of thereof): corresponding ephemeris parameters (or data/information) of an NTN node (e.g., the satellite ephemeris data, e.g., ephemerisInfo); and/or one or more common delay/TA parameters (e.g., ta-Info), e.g., comprising at least one of TACommon, TACommonDrift, TACommonDriftVariation; and/or a cell-specific scheduling offset (e.g., cellSpecifickoffset or Koffset, e.g., Kcell,offset) in number of slots for a given subcarrier spacing (e.g., ulKoffset), e.g., 15 KHz; and/or MAC-layer scheduling offset (e.g., kmac or K-Mac) in number of slots for a given subcarrier spacing (e.g., UKmac), e.g., 15 KHz, indicating a portion of a feeder link delay that the base station may pre-compensate, e.g., when UL/DL configurations are not aligned at the base station; and/or epoch time for applying the NTN-config (e.g., epochTime); and/or a validity duration of the NTN-config (e.g., ntn-UISyncValidityDuration) indicating a maximum duration (e.g., in seconds) that the NTN-config stays valid (e.g., a maximum duration that the wireless device stays UL synchronized with the serving cell without (re-) acquiring/reading the SIB19 of the serving cell); and/or one or more antenna polarization mode(s) (e.g., vertical horizontal, right-hand circular, or left-hand circular) for UL/DL communications (e.g., ntn-PolarizationUL/ntn-PolarizationDL); and/or a first indication/parameter (e.g., ta-Report-r17). For example, the MAC-layer scheduling offset may be 0, e.g., when the K-Mac is absent from (is not indicated/configured by) the NTN config of the serving cell. For example, in an NTN scenario with the transparent NTN node, when the UL frame and the DL frame are aligned at the base station, the K-Mac may be absent from the NTN-config of the serving cell. The validity duration may indicate (a maximum/longest) validity period of the (satellite) ephemeris data/information and/or the TA parameters of an NTN-config (e.g., the NTN-config of the serving cell).

As shown in FIG. 18C, the NTN-specific SIB (e.g., the SIB19) may further comprise t-Service indicating a time information on when a cell (e.g., the serving cell) provided via the NTN system (e.g., an NTN node/payload/platform) is going to stop serving the area it is currently covering. t-Service field of the SIB19 may apply for both service link switches in NTN quasi-Earth fixed system and feeder link switches for both NTN quasi-Earth fixed and Earth moving system. An exact stop time that the serving NTN node terminates/stops/finishes serving the cell of the NTN may be between the time indicated by the value of t-Service minus 1 and the time indicated by the value of t-Service.

In some examples, the NTN-specific SIB (e.g., the SIB19) may further comprise t-ServiceStart indicating a time information on when a target satellite (of the serving cell) is going to start serving the area currently covered by a serving/source satellite (of the serving cell). Switching from the source satellite to the target satellite (e.g., the feeder link/service link switch or a satellite switch) may not comprise performing/triggering/starting a handover/reconfiguration procedure, e.g., a hard/soft satellite switch with resynchronization (e.g., a PCI unchanged service/feeder link switch or a service/feeder link switch without changing PCI of the serving cell or satellite/service link/feeder link switch without performing handover or satellite/service link/feeder link switch without reconfiguration) or a hard/soft satellite switch without reconfiguration. For example, when the SIB19 indicates/comprises a satSwitchWithReSync, the wireless device may determine the switching from the source satellite (with a first NTN-config of the at least one NTN config) to the target satellite (with a second NTN-config of the at least one NTN config) does not comprise (or is not based on) performing/triggering/starting the handover/reconfiguration procedure. When the SIB19 does not indicate/comprise/configure the satSwitchWithReSync (e.g., the satSwitchWithReSync is absent from the SIB19), the wireless device may determine the switching from the source satellite to the target satellite comprises (or is based on) performing/triggering/starting the handover/reconfiguration procedure. The satSwitchWithReSync may indicate/configure/provide parameters for/corresponding to the target satellite that the wireless device may use/require to perform the satellite switch with re-synchronization. This satSwitchWithReSync may only be present in an NTN cell and its presence indicates that satellite switch without PCI change is supported in the cell.

Upon/in response to/after/based on receiving the NTN-specific SIB (SIB19) in/via an NTN cell, a wireless device may start or restart an NTN validity/validation timer/window/period (e.g., a validity timer or timer T430) for the serving cell with a timer value set to ntn-UISyncValidityDuration (of an NTN-config, e.g., of the at least one NTN-config) for the serving cell from the subframe indicated by epochTime (of the NTN-config) for the serving cell. If the SIB19 comprises either SatSwitchWithReSync and/or t-Service, the wireless device supports a hard satellite switch with resynchronization (e.g., the PCI unchanged service/feeder link switch), and if t-ServiceStart is included in/indicated by the SatSwitchWithReSync of the SIB19 and the wireless device supports the soft satellite switch with resynchronization, the wireless device may perform/initiate/execute/start the satellite switch with resynchronization between a time indicated by the t-ServiceStart and a time indicated by the t-Service for the serving cell. If the SIB19 comprises either SatSwitchWithReSync and/or t-Service, the wireless device supports a hard satellite switch with resynchronization (e.g., the PCI unchanged service/feeder link switch), and if t-ServiceStart is not included in/indicated by the SatSwitchWithReSync of the SIB19 or the wireless device does not support the soft satellite switch with resynchronization, the wireless device may perform/initiate/execute/start the satellite switch with resynchronization at a time indicated by the t-Service for the serving cell.

For performing/initiating/executing/starting the satellite switch with re-synchronization (e.g., in the RRC_CONNECTED state/mode), the wireless device may perform at least one of the following: stop/expiring the validity timer (e.g., timer T430) if running; and/or inform/notifying (or sending an indication to) lower layers of the wireless device (e.g., the MAC layer) that UL synchronisation is lost due to satellite switch with re-synchronization; and/or starting/initiating/performing re-synchronising to a downlink (DL) of the serving cell of (e.g., an SpCell served by) the target satellite (e.g., the target satellite corresponding to the second NTN config, e.g., an ntn-Config in SatSwitchWithReSync of the SIB19); and/or starting the validity timer (e.g., the timer T430) with the timer value set to ntn-UISyncValidityDuration from the subframe indicated by epochTime in the second NTN-config; and/or informing the lower layers when/that the UL synchronisation is obtained.

For performing/initiating/executing/starting the satellite switch with reconfiguration (e.g., the handover procedure) and when the target cell is part of the NTN, the wireless device may start timer T430 with the timer value set to ntn-UISyncValidityDuration from the subframe indicated by epochTime, according to a third NTN-Config of the at least one NTN config (e.g., corresponding to/of the target cell).

Upon or in response to acquiring/receiving an NTN-config (e.g., the first/second or third NTN-config) of the serving cell (e.g., upon reception of the SIB19 and/or upon reception of RRCReconfiguration message for the target cell including reconfigurationWithSync and/or upon conditional reconfiguration execution, e.g., when applying a stored RRCReconfiguration message for a target cell including reconfigurationWithSync), the wireless device may start/restart the validity (or validation) duration/timer/window/period (e.g., T430 timer) of the serving cell. For example, the wireless device may start the validity timer based the epoch time indicated by the NTN-config of the serving cell, e.g., the wireless device may start the validity timer from a subframe indicated by the epoch time. The wireless device may set an initial value of the T430 timer by ntn-UISyncValidityDuration of the NTN-config of the serving cell. The wireless device may stop the validity timer of the serving cell (e.g., a source cell or first cell) upon reception of the RRCReconfiguration message for the target cell (e.g., a second cell and/or a target serving cell) including reconfigurationWithSync and/or upon conditional reconfiguration execution, e.g., when applying a stored RRCReconfiguration message for the target cell including reconfigurationWithSync.

In an example, in response to determining that the validity duration being expired, the wireless device may stop UL transmissions (e.g., of PUSCH/PUCCH/SRS/PRACH signals/channels) via the serving cell and/or flush HARQ buffers of one or more HARQ processes. The wireless device may, in response to the expiry of the validity timer/duration, suspend/halt (any/all) UL transmissions until acquiring the SIB19 (of the serving cell or a target cell or a target satellite). For example, the wireless device may acquire the SIB19 of the serving cell to receive an update NTN assistance information 1800. The wireless device may receive an update (satellite) ephemeris data/information and/or update common TA parameters. The wireless device may, prior to expiry of the validity duration of the serving cell and to reduce interruption in UL transmissions, (re-) acquire the SIB19 in order to have valid (estimate of) the open-loop TA value of the serving cell (valid TA value).

In an example, upon the expiry of the validity duration of the serving cell and when the wireless device is not able to (re-) acquire the SIB19 (of the serving cell), the wireless device may become UL unsynchronized with the base station of the serving cell, e.g., for UL communication with the base station via the serving cell.

For example, a satellite ephemeris data/information (e.g., ephemerisInfo-r17) of an NTN-config (e.g., corresponding to an NTN node of the serving cell) may comprise position velocity parameters (of the NTN node) and/or orbital parameters (of the NTN node). For example, the position velocity parameters (of the NTN node) may comprise r_PV bits. The orbital parameters (of the NTN node) may comprise r_O bits. r_PV and/or r_O may indicate precision/accuracy in quantizing the satellite ephemeris data/information (e.g., ephemerisInfo-r17) of an NTN-config. For example, by increasing r_O and/or r_PV, a more accurate (quantization) of the location of the NTN node (e.g., a more accurate estimation of the service link delay of the serving cell) may be measured/determined by the wireless device. A base station (or an NTN control function) may determine the position velocity parameters (of the NTN node) e.g., comprising r_PV bits, and/or the orbital parameters (of the NTN node), e.g., comprising r_O bits, based on required accuracy/precision for determining/calculating (or maintaining or driving or measuring), e.g., by a wireless device and/or a core network entity, a position/location information of the NTN node within the validity duration of the NTN-config (e.g., ntn-UISyncValidityDuration).

Similarly, the one or more common delay/TA parameters (e.g., ta-Info), e.g., comprising the at least one of TACommon (e.g., comprising comprise r_commTA bits), TACommonDrift (e.g., comprising r_commTA_drift bits), TACommonDriftVariation (e.g., comprising r_commTA_var bits), of the NTN-config may comprise r_TA bits (r_TA=r_commTA+r_commTA_drift+r_commTA_var). r_TA may indicate precision/accuracy in quantizing the common delay of the serving cell. For example, by increasing r_TA, a more accurate (quantization) of the common delay of the serving cell (and/or feeder link delay) may be obtained/determined by the wireless device. A base station (or an NTN control function) may determine the one or more common delay/TA parameters based on required accuracy/precision for determining/calculating (or maintaining or driving or measuring), e.g., by a wireless device and/or a core network entity, a position/location information of the NTN node within the validity duration of the NTN-config (e.g., ntn-UISyncValidityDuration).

For example, a base station (or the NTN control function) may determine the satellite ephemeris data/information and/or the one or more common delay/TA parameters of the NTN-config such that an error/inaccuracy in determining/measuring/calculating a (current) TA value of the wireless device (and/or UE-gNB RTT of the serving cell) during the validity duration of the NTN-config (e.g., ntn-UISyncValidityDuration) stay below an error threshold (e.g., within Cyclic prefix duration of the UL/DL BWP, e.g., 10 μSeconds or the like). The value of the validity duration may be 5 seconds or 25 seconds or 30 seconds or the like. The value of the validity duration may be determined based on a number of bits (e.g., r_total) that are allocated to (or precision/accuracy of) the satellite ephemeris data/information (e.g., r_O and/or r_PV) and/or the one or more common delay/TA parameters (e.g., r_TA) of the NTN-config. For example, when by increasing r_total, the base station may increase the value of the validity duration (e.g., the wireless device may less frequently need to acquire/read the NTN-specific SIB) without reducing accuracy of the estimated/determined TA value of the wireless device. As a disadvantage payload of the NTN-specific SIB may increase accordingly (by increasing r_total). As the NTN assistance information may comprise at least one NTN-config (e.g., N1>1 NTN-configs), a total payload of the NTN-specific SIB may be at least r_total*N1 bits.

In an example embodiment, a base station may transmit (broadcast), e.g., via an NTN node of the serving cell, different versions of the NTN-specific SIB of the serving cell. For example, each version of the NTN-specific SIB (comprising r_i bits) may correspond to a (particular) accuracy of the TA value of the wireless device. A default (or initial, e.g., i=0) version of the NTN-specific SIB may comprise a maximum number of payload (e.g., highest/greatest r_0=r_total*N1 bits) allowing a maximum value of the validity duration at a first wireless device. The base station after transmitting the default version of the NTN-specific SIB may, during a transmission window (or a transmission periodicity of the NTN-specific SIB), transmit (in an incremental approach) a less accurate versions of NTN-specific SIB (each with much shorter validity duration than the validity duration of the default version of the NTN-specific SIB). For example, after transmitting a first version of the NTN-specific SIB (comprising r_1 bits where r_1<r_0), the base station may, during the transmission window (or duration or period or burst), transmit a second version of the NTN-specific SIB (comprising r_2<r_1 bits).

A first wireless device, based on receiving a first version of the NTN-assistance information, may start a first validity duration. The first wireless device may not need to read/acquire the second version of the NTN-assistance SIB based on the first validity duration being running. A value of the first validity duration may be determined (by the base station) such that an expiry of the first validity duration corresponds to an expiry of the transmission window.

A second wireless device, based on receiving a second version of the NTN-assistance information, may start a second validity duration. The second wireless device may not need to read/acquire a third version of the NTN-assistance SIB (that is transmitted by the base station after transmitting the second version of the NTN-assistance SIB during the transmission window). A value of the second validity duration may be determined (by the base station) such that an expiry of the second validity duration corresponds to the expiry of the transmission window.

By transmitting different versions (e.g., the default version and the first/second/third versions) of the NTN-specific SIB (each with different payload size, e.g., r_0>r_1> r_2 bits) the base station may improve efficiency of broadcasting NTN assistance information, e.g., to reduce required power for transmission of the NTN assistance information during the transmission window. For example, in legacy systems, the base station may, during the transmission window, transmit (periodically) the NTN-specific SIB L1 times, each time comprising r_0 bits (e.g., the base station may transmit the default version of the NTN-specific SIB L1 times during the transmission window). By transmitting different versions of the NTN-specific SIB (each with different payload size) the base station may, during the transmission window, transmit L1 versions of the NTN-specific SIB such that i-th (i>=1) version of the NTN-specific SIB comprises r_i<r_0 bits, which improves efficiency of broadcasting NTN assistance information without reducing accuracy of the TA value at the wireless devices.

To maintain uplink orthogonality in a serving cell, transmissions from different wireless devices in a cell/beam (e.g., the first wireless device and the second wireless device in FIG. 18B) may need to be time-aligned at the base station and/or the NTN node (e.g., satellite). The cell may be the serving cell. In an example, time alignment/synchronization may be achieved by using different timing advance (TA) values at different wireless devices to compensate for their different propagation delays (or RTDs). As shown in FIG. 18B, for UL transmissions, the first wireless device may use the first TA value (e.g., TA_1) and the second wireless device may use the second TA value (TA_2).

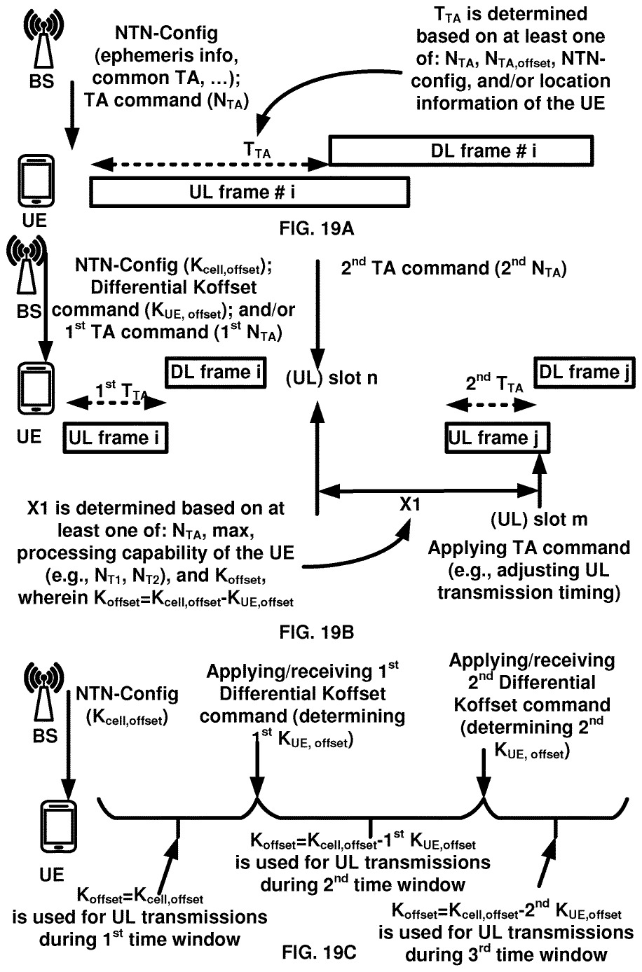

FIG. 19A shows an example of UL/DL frame structure and uplink transmission timing in a wireless communication system. The example of FIG. 19A may show UL/DL frames/configuration misalignment due to a timing advance (TA) procedure. The wireless device may manage/maintain the uplink (or UL) transmission timing (or UL timing or UL/DL timing) for uplink transmissions. For example, uplink transmission timing, as also shown in FIG. 19A, may imply/comprise an UL frame #i (UL frame i or UL frame number i) may start a (current or latest) TA value (T_{TA}) before/prior to a (beginning/starting of) DL frame #i (DL frame i or DL frame number i), e.g., the UL frame #i is advanced by the TA value with respect to its corresponding DL frame #i. The uplink transmission timing (for UL transmissions) may imply/comprise that uplink frame number i (UL frame #i or UL frame i) for UL transmissions (via the serving cell), from the wireless device to the base station, may start

$${T}_{TA} = ( {N}_{TA} + {N}_{TA , offset} + {N}_{TA , adj}^{common} + {N}_{TA , adj}^{UE} ) {T}_{c}$$

before the start of the corresponding downlink frame (e.g., the DL frame i) at the wireless device.

As shown in FIG. 19A, a wireless device (e.g., the first wireless device or the second wireless device) may estimate (or determine or measure or calculate or derive or maintain) the (current or a latest) TA value (T_{TA}) based on at least one of the following: the at least one NTN-config (e.g., the first/second/third NTN config or an NTN-config of the serving cell), e.g., for calculating/determining

$${N}_{TA , adj}^{common}$$

$$and / or$$

$${N}_{TA , adj}^{UE} ;$$

and/or a location information (e.g., GNSS information) of the wireless device, e.g., for determining/calculating/deriving

$${N}_{TA , adj}^{UE} ;$$

and/or one or more configuration parameters (e.g., T_{TA,offset}); and/or at least one (absolute) TA command (TAC) MAC CE (e.g., N_{TA}). During communication via a cell (e.g., prior to an expiry of the validity timer of the serving cell/NTN-config), the wireless device may (regularly) estimate/determine/measure a (current or a latest) TA value based on the indicated/configured NTN assistance information (e.g., the NTN-config of the serving cell/satellite). For example, when the validity timer is running (or is not stopped or expired), the wireless device may transmit UL signals/channels based on the TA value.

For example, the wireless device may calculate/measure/maintain the current (or latest available) TA (value) of the wireless device T_{TA} (e.g., corresponding to a TAG ID or a primary TAG or a secondary TAG) based on at least a combination of a closed-loop TA value (or a closed-loop TA procedure/control, e.g., N_{TA}) and/or an open-loop TA value (or an open-loop TA procedure/control,

$$e . g . , {N}_{TA , adj}^{common}$$

$$and / or$$

$${N}_{TA , adj}^{UE} ) .$$

In an example above, a combination of the closed-loop TA control and the open-loop TA control may be based on adding/summing the open-loop TA value (e.g., derived/calculated based on the open-loop TA procedure/control) and the closed-loop TA value (or a portion of the closed-loop TA procedure/control),

$$e . g . , {T}_{TA} = ( {N}_{TA} + {N}_{TA , offset} + {N}_{TA , adj}^{common} + {N}_{TA , adj}^{UE} ) {T}_{c} .$$

The current TA value of the first wireless device may be TA_1. The closed-loop TA procedure/control may be based on receiving at least one (absolute) TA command (TAC) MAC CE indicating a TA value (e.g., T_{A} corresponding to the TAG ID, e.g., the primary TAG or the secondary TAG) from the base station (e.g., via Msg2 1312 and/or MsgB 1332 and/or a PDSCH). The base station may transmit a MAC PDU (e.g., the PDSCH comprising the MAC PDU) comprising the TAC MAC CE. The MAC PDU may comprise a cell switch command indicating a target TA value. The MAC PDU may comprise a handover command indicating the target TA value. The TA value (or the target TA value) may indicate an adjustment of the closed-loop TA value (e.g., N_{TA}). The wireless device may receive a PDSCH comprising/carrying/with the MAC PDU.

For example, a timing advance command (e.g., the TAC MAC CE) of the at least one TA command may be a TA command of a random access response. The TA command may be an absolute timing advance command MAC CE. The TA command may indicate a value TA for a TAG T_{A}=0, 1, 2, . . . , 3846. The wireless device may determine an amount of the time alignment for the TAG with SCS of 2^{μ}·15 kHz based on N_{TA}=T_{A}·16·64/2^{μ}. N_{TA} may be relative to the SCS of the first uplink transmission from the wireless device after the reception of the random access response or the absolute timing advance command MAC CE. In another example, a timing advance command (e.g., the TAC MAC CE), T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 KHZ, N_{TA_new}=N_{TA_old}+ (T_{A}−31)·16·64/2^{μ}.

The open-loop TA procedure/control may require a GNSS-acquired position (or location information) of the wireless device and/or the NTN-config of the serving cell. The wireless device may, based on an implemented orbital predictor/propagator model (e.g., the GNSS-acquired position comprising GNSS measurements) and/or the NTN-config of the serving cell, may use the ephemeris data (and/or the GNSS-acquired position) to measure/calculate/maintain movement pattern of the satellite (corresponding to the NTN-config of the serving cell), measure/determine/estimate a service link delay (e.g., RTT of the service link), and/or measure/determine/estimate a feeder link delay (e.g., RTT of the feeder link) and/or measure/determine/estimate propagation delay between the wireless device and the base station (e.g., UE-gNB RTT of the serving cell). For example, the wireless device may, based on the GNSS-acquired position and/or the NTN-config of the serving cell, adjust the current TA value (e.g., the TA of the wireless device) via the open-loop TA procedure/control. The open-loop TA procedure/control may comprise determination/estimation calculation of one or more values, e.g.,

$${N}_{TA , adj}^{UE}$$

$$and / or$$

$${N}_{TA , adj}^{common} .$$

In some implementations, the wireless device may determine the open-loop TA value (corresponding to the serving cell) by summing up/adding the

$${N}_{TA , adj}^{common}$$

$$and$$

$${N}_{TA , adj}^{UE} .$$

The wireless device may (to determine the TA value of the wireless device) determine/estimate

$${N}_{TA , adj}^{UE}$$

based on the propagation delay of the service link (e.g., between the wireless device and the NTN node). The wireless device may determine/measure/estimate

$${N}_{TA , adj}^{UE}$$

based on the location information of the wireless device (e.g., position and/or GNSS of the wireless device) and the satellite ephemeris data (e.g., the NTN-config) of the serving cell.

The wireless device may (to determine the TA value of the wireless device) determine/estimate

$${N}_{TA , adj}^{common}$$

a common delay of the cell (e.g., a portion of the feeder link delay that is not pre-compensated by the base station). The wireless device may determine the

$${N}_{TA , adj}^{common}$$

based on the one or more common TA parameters (e.g., the NTN-config) of the serving cell.

The wireless device may use the NTN-config of a cell (e.g., the serving cell) the calculate/determinate/measurement/maintain an estimate of the UE-gNB RTT between the UE and a base station of the cell. In an example, the wireless device may calculate/measure/estimate the UE-gNB RTT (in ms or number of slots) of the serving cell based on the current TA value and the K-Mac (if indicated by the NTN-config of the serving cell). For example, the UE-gNB RTT may be the summation of the current TA value and K-Mac (based on subcarrier spacing of the 15 KHz). When the K-Mac is 0, the wireless device may determine/measure the UE-gNB RTT based on the current TA value (of the wireless device), e.g., the UE-gNB RTT is equal to the current TA value. The wireless device may maintain/calculate/update the open-loop TA value (or the UE-gNB RTT) over a validity duration of the NTN-config (e.g., T430 timer).

In response to a PRACH transmission (e.g., for performing a 2-step/4-step CFRA/CBRA procedure, e.g., for initial access and/or for beam failure recovery) by a wireless device to the base station (e.g., via the serving cell of the NTN), the wireless device may attempt to detect a DCI format 1_0 with CRC scrambled by a corresponding RA-RNTI during a RAR window (e.g., ra-ResponseWindow). The PRACH transmission may be indicated by a PDCCH order and/or higher layers (e.g., MAC/RRC layer) of the wireless device. The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PRACH occasion corresponding to the PRACH transmission. The symbol duration may correspond to an SCS for Type1-PDCCH CSS set.

When communicating with the NTN (e.g., when

$${N}_{TA , adj}^{UE}$$

$$or$$

$${N}_{TA , adj}^{common}$$

is not zero, e.g., when the open-loop TA value of the wireless device is not zero), the RAR window (e.g., ra-ResponseWindow or msgB-ResponseWindow) may start after an additional UE-gNB RTT of the serving cell. The wireless device may determine the UE-gNB RTT (e.g., in ms or in number of slots) of the serving cell based on the current TA value (e.g., T_{TA}) (of the serving cell) and/or the K-mac indicated by the NTN-config of the serving cell. The length of the RAR window in number of slots may be based on the SCS for Type1-PDCCH CSS set and is provided/indicated by the one or more configuration parameters (e.g., ra-ResponseWindow).

In response to a transmission of a PRACH and a PUSCH (e.g., for performing a 2-step CFRA/CBRA procedure, e.g., for initial access and/or for beam failure recovery) by the wireless device to the base station (e.g., via the serving cell of the NTN), or to a transmission of only a PRACH if the PRACH preamble is mapped to a valid PUSCH occasion, the wireless device may attempt to detect a DCI format 1_0 with CRC scrambled by a corresponding MsgB-RNTI during a RAR window (e.g., msgB-ResponseWindow). The PRACH transmission may be indicated by a PDCCH order and/or higher layers (e.g., MAC/RRC layer) of the wireless device. The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PUSCH occasion corresponding to the PRACH transmission. The symbol duration may correspond to an SCS for Type1-PDCCH CSS set. When communicating with the NTN (e.g., when

$${N}_{TA , adj}^{UE}$$

$$or$$

$${N}_{TA , adj}^{common}$$

is not zero, e.g., when the open-loop TA value of the wireless device is not zero), the RAR window may start after an additional UE-gNB RTT of the serving cell. The wireless device may determine the UE-gNB RTT (e.g., in ms or in number of slots) of the serving cell based on the current TA value (e.g., T_{TA}) of the serving cell and/or the K-mac indicated by the NTN-config of the serving cell. The length of the RAR window in number of slots may be based on the SCS for Type1-PDCCH CSS set and is provided/indicated by the one or more configuration parameters (e.g., msgB-ResponseWindow).

FIG. 19B shows an example of timing advance for adjusting/maintaining UL/DL frame structure and/or uplink transmission timing in a wireless communication system. The example of FIG. 19B may show an example of updating/adjusting UL/DL frames/configuration misalignment due to timing advance. As shown in FIG. 19B and as discussed above in connection with embodiment of FIG. 19A, an initial misalignment between UL/DL frames (e.g., between UL frame #i and DL frame #i) of the wireless device (prior to receiving a second TAC MAC CE) may be based on a first TA value (a first T_{TA}). Similar to embodiment of FIG. 18A, the wireless device may determine the first TA value based on the NTN-config and/or a first TAC MAC CE (e.g., a first TA command) indicating a first N_{TA}, e.g., the first

$${T}_{TA} = ( the first {N}_{TA} + {N}_{TA , offset} + {N}_{TA , adj}^{common} + {N}_{TA , adj}^{UE} ) {T}_{c} .$$

As shown in FIG. 19B, the wireless device may receive the second TA value from the base station based on receiving a second TA command (e.g., a second TAC MAC CE). For the second TAC MAC CE received on an uplink (UL) slot n, the wireless device may apply/adjust/implement/update the uplink transmission timing (e.g., for transmission of UL signals/channels) from a beginning/start of a slot m=n+k+1+2^{μ}·K_{offset} where

$$k = ⌈ {N}_{slot}^{subframe , μ} \cdot ( {N}_{T , 1} + {N}_{T , 2} + {N}_{TA , max} + 0.5 ) / {T}_{sf} ⌉ .$$

The slot m may be an uplink slot or a downlink slot. N_{T,1} is a time duration in msec of N₁ symbols corresponding to a PDSCH processing time for UE processing capability 1 when additional PDSCH DM-RS is configured. N_{T,2} is a time duration in msec of N₂ symbols corresponding to a PUSCH preparation time for UE processing capability 1. N_{TA,max} is a maximum timing advance value in msec that can be provided by a TA command field of 12 bits.

$${N}_{slot}^{subframe , μ}$$

is the number of slots per subframe (of an NR or an LTE) and T_{sf} is the subframe duration of 1 msec. N₁ and N₂ are determined with respect to the minimum SCS among the SCSs of all configured UL BWPs (e.g., by the one or more configuration parameters) for all uplink carriers in the TAG and/or of all configured DL BWPs (e.g., by the one or more configuration parameters) for the corresponding downlink carriers. For μ=0, the wireless device may assume N_{1,0}=14. The wireless device may determine the UL slot n and

$${N}_{slot}^{subframe , μ}$$

with respect to/considering/based on the minimum SCS among the SCSs of all configured UL BWPs for all uplink carriers in the TAG. The wireless device may determine N_{TA, max} with respect to/considering/based on the minimum SCS among the SCSs of all configured UL BWPs for all uplink carriers in the TAG and for all configured initial UL BWPs provided by initialUplinkBWP.

In an example, the uplink slot n may be a last/final/ending/latest slot among uplink slot(s) overlapping with the slot(s) of PDSCH reception (assuming the current TA is equal to zero, e.g., the first T_{TA}=0) where the PDSCH provides/comprises the second timing advance command (e.g., the second TAC MAC CE), e.g., at/during the uplink slot n the wireless device receives a MAC PDU/PDSCH comprising/indicating the second TAC MAC CE.

As shown in FIG. 19B, for applying the second TAC MAC CE (or for adjusting/updating/maintaining the uplink transmission timing in response to the second TAC MAC CE), the wireless device may update/adjust the UL timing with respect to DL timing after (an expiry of) a time duration with a length X1 (ms/slots/subframes or symbols), e.g., the wireless device may advance an UL frame #j by a second TA value (a second T_{TA}) with respect to a corresponding DL frame #j or determine the UL frame #j starts/is the second TA value before the DL frame #j. In an example, adjusting/updating/maintaining the uplink transmission timing may comprise that prior to the expiry of the time duration (e.g., before the slot m, e.g., within X1 slots/subframes/symbols after the receiving the second TA command at/during/in the UL slot n), the wireless device may transmit UL signals based on the first TA value. In an example, adjusting/updating/maintaining the uplink transmission timing may comprise that after the expiry of the time duration (e.g., after the slot m, e.g., after X1 slots/subframes/symbols after/from the receiving the second TA command at/during/in the UL slot n), the wireless device may transmit UL signals based on the second TA value. The wireless device may determine the second TA value based on the NTN-config of the serving cell and the second TAC MAC CE, e.g., the second

$${T}_{TA} = ( the second {N}_{TA} + {N}_{TA , offset} + {N}_{TA , adj}^{common} + {N}_{TA , adj}^{UE} ) {T}_{c} .$$

As shown in FIG. 19B, the wireless device may determine the time duration (e.g., the parameter X1) based on the parameter k (e.g., processing capability of the wireless device (e.g., N_{T,1} and/or N_{T,2})), and a scheduling offset (or Koffset), e.g., X1=k+1+2^{μ}·K_{offset} (ms/slots) or X1 is equal to difference (in number of slots/symbols/ms) between the slot m and the UL slot n). The Koffset may be based on a cell-specific Koffset (K_{cell,offset}), e.g., before receiving a differential Koffset from the base station. The Koffset may be based on the cell-specific scheduling offset and/or the differential Koffset, e.g., after receiving the differential Koffset from the base station. For example, when the differential Koffset is indicated/provided/configured, the Koffset may be a subtraction of the differential Koffset from the cell-specific Koffset. When the differential Koffset is not indicated/provided/configured (or is cleared) or before receiving the differential Koffset, the Koffset may be the cell-specific Koffset.

By adjusting the uplink timing (e.g., applying the second TA command) after the time duration from/after the receiving the second TA command, a collision between UL signals/channels, e.g., during the time duration with length X1 from the receiving the second TA command, may reduce. For example, the wireless device may transmit until the time duration from/after the receiving the second TA command (all) UL signals/channels based on the first TA value. As a result, when the second TA value is smaller than the first TA value, a possibility of collision of UL signals, e.g., due to applying the second TA command, may reduce.

FIG. 19C shows an example of Koffset in an NTN per an aspect of the present disclosure. A base station may transmit the NTN assistance information to the wireless device. The NTN assistance information (e.g., an NTN-config) may comprise the cell-specific Koffset (of the serving cell or the serving satellite). The wireless device may, in response to/based on/using the NTN-config, use the cell-specific Koffset for determining transmission timing of UL signals/channels (PUSCH/PUCCH/SRS/PRACH) scheduled by a downlink channel (e.g., DCI and/or fallbackRAR/RAR). For example, based on the determined transmission timing (or occasion or slot or symbol, e.g., in an UL frame or a DL frame of the wireless device) of an UL signal/channel (PUSCH/PUCCH/SRS/PRACH), the wireless device may transmit the UL signal/channel during/in/within the transmission timing. For example, with reference to slot(s) for a PUSCH transmission (e.g., via the serving cell of the NTN) scheduled by a RAR UL grant (indicated by fallbackRAR/RAR message), e.g., when the wireless device receives from the base station a PDSCH with the RAR/fallback message ending in a slot w for a corresponding PRACH transmission to the base station, the wireless device may transmit the PUSCH in a slot/transmission timing w₁=w+k₂+Δ+2^{μ}. K_{cell,offset}. The k₂ and Δ are provided by NR specification (e.g., TS 38.214) and K_{cell,offset} is the cell-specific Koffset. If the cell-specific Koffset is not provided by the one or more configuration parameters, e.g., the NTN-config, (or if the cell-specific Koffset is absent in the one or more configuration parameters), the wireless device sets K_{cell,offset}=0.

In another example, the control channel (e.g., a DCI) may trigger/indicate/order a transmission of the PRACH (e.g., the UL signal may be the ordered PRACH) corresponding to a preamble index. For example, the control channel (e.g., a PDCCH order) may comprise a random access preamble index field indicating a value (e.g., that is not zero) of the preamble index. For the PRACH transmission (e.g., during/via the transmission occasion) to the base station by the wireless device, triggered by the PDCCH order, a PRACH mask index field of the DCI may indicate the PRACH occasion for the PRACH transmission. In an example, the PRACH occasions may be associated with an SS/PBCH block (e.g., SSB) index indicated by the SS/PBCH block index field of the DCI (e.g., the PDCCH order). The wireless device may use the cell-specific scheduling offset (e.g., K_{cell,offset} by cellSpecifickoffset) corresponding to the serving cell to determine the PRACH occasion. For example, the wireless device may determine the PRACH occasion being after a slot/transmission timing v₁=v+2^{μ}·K_{cell,offset}. The slot v may be an UL slot of an UL BWP for the PRACH transmission that overlaps with an end of the PDCCH order reception (e.g., assuming the current TA value being 0, e.g., T_{TA}=0). μ may be the SCS configuration for the PRACH transmission. The PDCCH order reception may be received during the reception occasion.

As shown in FIG. 19C, a base station may transmit at least one differential Koffset MAC CE (a first differential Koffset MAC CE and/or a second differential Koffset MAC CE) to a wireless device. Each differential Koffset MAC CE may indicate a differential Koffset (e.g., the first differential Koffset MAC CE indicate/configure/provide a first differential Koffset and the second differential Koffset MAC CE indicate/provide/configure a second differential Koffset). The differential Koffset MAC CE may indicate/provide/configure a differential Koffset in a number of slots using SCS of 15 kHz. When the differential Koffset is indicated (e.g., the wireless device receives the differential Koffset MAC CE), the wireless device may (e.g., during a second time window) determine a UE-specific scheduling offset K_{UE, offset} based on the differential Koffset (e.g., the UE-specific scheduling offset is equal to the differential Koffset). If the differential Koffset is not indicated (the wireless device has not received any differential Koffset MAC CE from the base station, e.g., during a first time window or before a start of the second time window), the wireless device may set K_{UE,offset}=0.

The second time window is started (or the first time offset is expired/stopped) in response to receiving/applying the first differential Koffset. The second time window is stopped/expired in response to receiving/applying a second differential Koffset. For example, in response to receiving/applying the second differential Koffset, the wireless device may start a third time window.

If the wireless device is provided/indicated a differential Koffset (e.g., a K_{UE,offset} value, e.g., by the first/second differential Koffset MAC CE) by a differential Koffset MAC CE (e.g., the first/second differential Koffset MAC CE), the wireless device may apply/implement the differential Koffset MAC CE (e.g., a differential Koffset command) in a first/earliest/starting/initial slot/subframe that is after a slot

$${k}_{1} + 3 {N}_{slot}^{subframe , μ}$$

where k₁ is a slot/occasion where the wireless device may transmit a PUCCH with HARQ-ACK information for a PDSCH (or MAC PDU) providing the differential Koffset MAC CE, μ is the SCS configuration for the PUCCH transmission that is determined in the slot when the differential K_{offset} MAC CE is applied.

If the wireless device is provided/indicated a differential Koffset (e.g., a K_{UE,offset} value) by a differential Koffset MAC CE (e.g., the first/second differential Koffset MAC CE) and a HARQ feedback of a HARQ process corresponding to the differential Koffset MAC CE is enabled, the wireless device may apply/implement the differential Koffset MAC CE (e.g., a differential Koffset command) in the first/earliest/starting/initial slot/subframe that is after the slot

$${k}_{1} + 3 {N}_{slot}^{subframe , μ}$$

where k₁ is a slot/occasion where the wireless device may transmit the PUCCH with HARQ-ACK information for the PDSCH providing the differential Koffset MAC CE. In an example, the one or more configuration parameters may enable the HARQ feedback of the HARQ process (e.g., indicate/configure the HARQ process as a feedback-enabled HARQ process). For example, the base station may, via/according to the one or more RRC messages (e.g., a configured bitmap), or a MAC CE (e.g., the differential Koffset MAC CE), or a DCI (e.g., a DCI scheduling the differential Koffset MAC CE), indicate the HARQ process as a feedback-enabled HARQ process.

If the wireless device is provided/indicated a differential Koffset (e.g., a K_{UE, offset} value) by a differential Koffset MAC CE (e.g., the first/second differential Koffset MAC CE) and a HARQ feedback of the HARQ process corresponding to the differential Koffset MAC CE is disabled, the wireless device may apply the MAC CE command in a first/earliest/starting/initial slot/subframe that is after a slot l₁ from a slot that the differential MAC CE is received. In an example, the one or more configuration parameters may enable the HARQ feedback of the HARQ process (e.g., indicate/configure the HARQ process as a feedback-enabled HARQ process). For example, the base station may, via/according to the one or more RRC messages (e.g., a configured bitmap), or the MAC CE (e.g., the differential Koffset MAC CE), or a DCI (e.g., the DCI scheduling the differential Koffset MAC CE), indicate the HARQ process as a feedback-disabled HARQ process.

In some implementations, the wireless device may determine the slot 11 based on the one or more configuration parameters. For example, the one or more configuration parameters indicate/configure a first parameter. The first parameter may indicate a first number of slots/subframes/symbols (or a first time distance in milliseconds) for applying MAC CE commands (e.g., the differential Koffset MAC CE) corresponding to feedback-disabled HARQ processes. The wireless device may, based on the first parameter and in response to the differential Koffset MAC CE corresponding to feedback-disabled HARQ processes, determine the slot 11 after the first parameter from/after a slot (or a last symbol of the PDSCH with the differential Koffset MAC CE) that differential Koffset MAC CE is received. In other implementations, the first parameter may be a predefined value (e.g., 3 slots/subframes/symbols) or 3 ms.

As shown in FIG. 19C, applying/implementing the differential Koffset MAC CE may comprise calculating/determining the UE-specific Koffset based on the indicated differential Koffset. For example, in response to applying/implementing the differential Koffset MAC CE, the wireless device may determine Koffset (e.g., K_{offset}) based on the cell-specific scheduling offset (e.g., cellSpecifickoffset, e.g., K_{cell,offset}) of the serving cell and the UE-specific scheduling offset K_{UE, offset}, e.g., K_{offset}=K_{cell,offset}-K_{UE, offset}. An application time/occasion/slot of the differential Koffset (e.g., indicated by the differential Koffset MAC CE), e.g., an occasion/slot that the differential Koffset is applied/implemented, may be based on at least one of the following: whether the HARQ process corresponds to the differential Koffset MAC CE is feedback enabled or feedback disabled; and/or an slot/subframe that differential Koffset MAC CE is received; and/or an slot/subframe of a PUCCH resource for transmitting the HARQ-ACK of the differential Koffset MAC CE (or the PDSCH carrying/indicating the differential Koffset MAC CE); and/or a predefined/configured processing delay (of the MAC layer), e.g., 3 slots or the like; and/or the first parameter.

In response to/after/based on determining the configured/indicated differential Koffset being cleared/dropped/deleted (e.g., receiving an indication from the higher layers (e.g., the MAC layer) that the configured/indicated differential Koffset being cleared/dropped/deleted, the wireless device may set the UE-specific Koffset to zero (e.g., K_{UE,offset}=0). In response to/after/based on determining the configured/indicated differential Koffset being cleared/dropped/deleted, the wireless device may determine Koffset (e.g., K_{offset}) only based on the cell-specific scheduling offset (e.g., cellSpecifickoffset, e.g., K_{cell,offset}) of the serving cell e.g., K_{offset}=K_{cell,offset}. In response to/after/based on determining the configured/indicated differential Koffset being cleared/dropped/deleted, the wireless device may stop using the differential Koffset for UL transmissions. For example, due to the satellite switch with re-synchronization and/or a reconfiguration with synchronization (sync) procedure or a MAC reset, the wireless device may clear/drop/delete the configured/indicated differential Koffset, e.g., K_{UE,offset}=0. In another example, due to the satellite switch with re-synchronization and/or a reconfiguration with synchronization (sync) procedure or a MAC reset, the wireless device may stop using the differential Koffset determining transmission timing of UL signals and/or activation/deactivation time of one or more MAC CEs (e.g., the second/first TAC MAC CE) at the wireless device. The wireless device may start the first time window based on clearing/dropping/deleting the configured/indicated differential Koffset.

The base station may transmit, to the wireless device, a DCI indicating a dynamic UL grant or activating an UL grant (configured grant). The wireless device may receive the DCI during a reception occasion/time/interval (e.g., a slot/symbol). For example, the DCI may schedule/indicate/trigger a transmission of an uplink signal/channel (e.g., a PUSCH or a PUCCH or a PRACH or an SRS) to the base station via the NTN, e.g., a first/second/third UL signal/channel. The wireless device may transmit (pending) UL data and/or UCI and/or preamble and/or SRS resource via/based on the UL signal/channel to the base station via/during a transmission occasion/time/interval (e.g., slot/symbol).

For example, the DCI may trigger/schedule/indicate a transmission of the PUSCH/CG-PUSCH (e.g., the UL data) and/or the PUCCH (e.g., the UCI, e.g., HARQ-ACK information). The wireless device may use the cell-specific scheduling offset and/or the UE-specific scheduling offset to determine the transmission occasion of the PUSCH/PUCCH. For example, the transmission occasion of the PUSCH may be based on

$${K}_{offset} \cdot \frac{{2}^{{μ}_{PUSCH}}}{{2}^{{μ}_{{K}_{offset}}}} ,$$

wherein K_{offset}=K_{cell,offset}−K_{UE,offset} (corresponding to the serving cell). μ_{PUSCH} is the SCS configuration of the PUSCH transmission and μ_{K}_{_{offset}} is the SCS configuration of the Koffset (e.g., μ_{K}_{_{offset}}=0 for 15 kHz or FR1). For example, the transmission occasion of the PUCCH may be based on

$${K}_{offset} \cdot \frac{{2}^{{μ}_{PUCCH}}}{{2}^{{μ}_{{K}_{offset}}}}$$

(corresponding to the serving cell) where μ_{PUCCH} is the SCS configuration of the PUCCH transmission.

The wireless device may, after the receiving the first differential Koffset MAC CE and before the second differential Koffset MAC CE (e.g., during a second window), use the first differential Koffset (indicated by the first differential Koffset MAC CE) for determining transmission timing of first UL signals/channels (e.g., PUSCH/PUCCH/aperiodic SRS/aperiodic CSI report). The wireless device may start the second time window (or expire/stop the first time window) based on the receiving (or applying) the first differential Koffset MAC CE. For example, after applying the first differential Koffset MAC CE (e.g., after an initial/first/starting slot after a slot

$${k}_{2} + 3 {N}_{slot}^{subframe , μ}$$

where k₂ is a slot/occasion where the wireless device may transmit a first PUCCH with HARQ-ACK information for a first PDSCH providing the first differential Koffset MAC CE), the wireless device may determine K_{offset}=first K_{cell,offset}−K_{UE,offset} for transmission of an UL signal. The base station may indicate/trigger/schedule transmission of the first UL signals/channels based on first control channels (e.g., with a first DCI format). The first DCI format may not be scrambled by a TC-RNTI. The wireless device may transmit the UL signal/channel of the first UL signals/channels based on corresponding DCI (scheduling/triggering the UL signal); the first differential Koffset; and/or the current TA value (e.g., the first TA value or the second TA value).

The wireless device may, after the receiving the second differential Koffset MAC CE (e.g., during a third time window), use the second differential Koffset (indicated by the second differential Koffset MAC CE) for determining transmission timing of second UL signals/channels (e.g., PUSCH/PUCCH/aperiodic SRS/aperiodic CSI report). The wireless device may start the third time window (or expire/stop the second time window) based on the receiving (or applying) the second differential Koffset MAC CE. For example, after applying the second differential Koffset MAC CE (e.g., after an initial/first/starting slot after a slot

$${k}_{3} + 3 {N}_{slot}^{subframe , μ}$$

where k₃ is a slot/occasion where the wireless device may transmit a second PUCCH with HARQ-ACK information for a second PDSCH providing the second differential Koffset MAC CE), the wireless device may determine K_{offset}=second K_{cell,offset}−K_{UE,offset} for transmission of an UL signal. The base station may indicate/trigger/schedule transmission of the second UL signals/channels based on second control channels (e.g., second DCI formats). The wireless device may transmit the UL signal/channel of the second UL signals/channels based on corresponding DCI (scheduling/triggering the UL signal); the second differential Koffset; and/or the current TA value (e.g., the first TA value or the second TA value).

The cell-specific Koffset may be a value between 1 to 1023 slots (e.g., 1 to 1023 ms). The differential Koffset may be a value between 0 to 256 slots (e.g., 0 to 256 ms). The base station may determine the cell-specific Koffset based on a maximum RTD of the serving cell, e.g., the cell-specific Koffset is greater than or equal to the maximum RTD of the serving cell, e.g., in order to maintain causality of UL transmissions from all the wireless devices residing in the serving cell. To improve UL transmission efficiency and reduce UL latency, the base station may determine the differential Koffset based on the current TA value of the wireless device, e.g., the differential Koffset is determined such that K_{offset}=K_{cell,offset}−K_{UE, offset} being greater than or equal to the current TA value of the wireless device (e.g., the first TA value), e.g., in order to maintain causality of UL transmissions from the wireless device residing in the serving cell.

For example, the base station may configure (via the one or more configuration parameters) the wireless device with a TA report procedure in a non-terrestrial network (NTN). The one or more configuration parameters may comprise the NTN assistance information. The TA reporting procedure may be used in the NTN to provide the base station with an estimate of the current TA value of the wireless device. For example, the wireless device (when communicating with the base station via the serving cell of the NTN) may report the current (or the latest available estimate) TA value of the wireless device to the base station. The wireless device may receive the differential Koffset MAC CE in response to reporting/transmitting/sending the TA value (e.g., the TA report procedure).

The one or more configuration parameters (e.g., the NTN-config of the serving cell) may comprise/indicate a TA report (TAR) configuration. The TAR configuration may correspond to the serving cell. The TAR configuration may configure the wireless device for TA reporting in the NTN. The TAR configuration may comprise at least one of (or a combination of) the following: a TA threshold (e.g., offsetThresholdTA); and/or ta-Report (e.g., the first indication); and/or an SR indication (e.g., timingAdvanceSR). A higher layer (e.g., RRC) of the wireless device may control the TA reporting by configuring the TAR configuration.

When the first indication (e.g., ta-Report-r17) is indicated by (or present in/indicated in) SIB19 1800 (corresponding to the serving cell), it may indicate (or enable) reporting of TA is enabled during a Random Access (RA) procedure. For example, the RA procedure may be due to (or based on/in response to/during/correspond to) an RRC connection establishment (procedure) or an RRC connection resume (procedure), or an RRC connection reestablishment (procedure). In some implementations, the RA procedure may be due to (or based on/in response to/during/correspond to) the handover procedure (e.g., initiated or executed based on the RRC reconfiguration message). In an example, when the first indication (e.g., ta-Report-r17 field) is indicated by (or is present in/indicated in) the common configuration parameters of the serving cell (e.g., the ServingCellConfigCommon within a dedicated signaling, e.g., the RRC reconfiguration message), the first indication may indicate TA reporting is enabled during the Random Access due to reconfiguration with sync procedure (e.g., the handover procedure).

A wireless device may trigger a Timing Advance report (TAR) based on at least one TAR condition being satisfied. For example, the wireless device may determine the at least one TAR condition being satisfied based on at least one of the following (events being occurred): upon (or based on or in response to) at least one TAR indication from upper layers (e.g., the RRC layer) of the wireless device to trigger the TAR; and/or upon (or based on or in response to) configuration of the TA threshold (e.g., offsetThresholdTA) by upper layers (e.g., the RRC layer) of the wireless device (e.g., if the wireless device has not previously reported TA value to the serving cell); and/or based on (if) a variation between the current estimate of the TA value and the last reported TA value is equal to or larger than the TA threshold offsetThresholdTA (if configured). In response to the triggered TAR, the wireless device may transmit a TAR MAC CE to the base station. The TAR MAC CE may indicate/comprise a latest estimate of the current TA value of the wireless device (e.g., the first TA value or the second TA value).

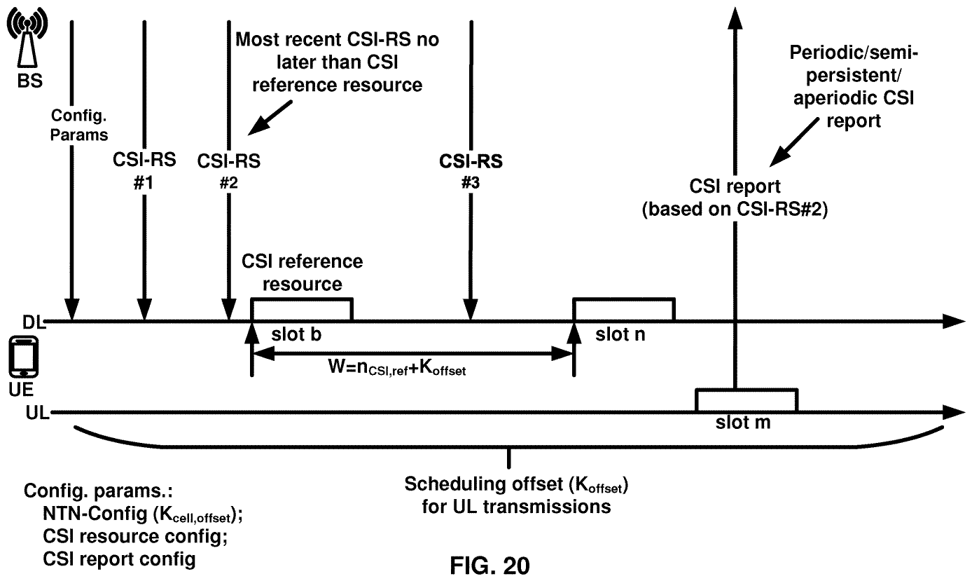

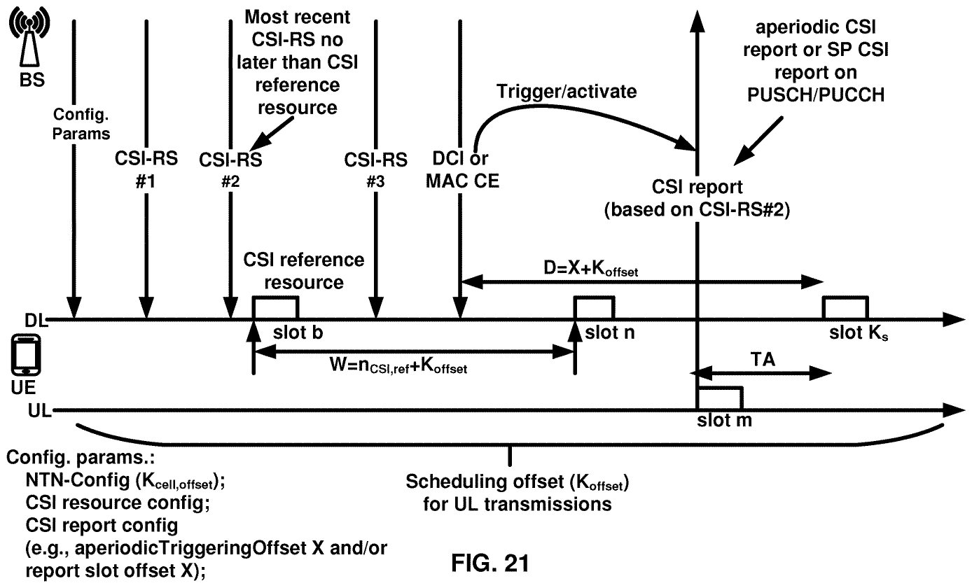

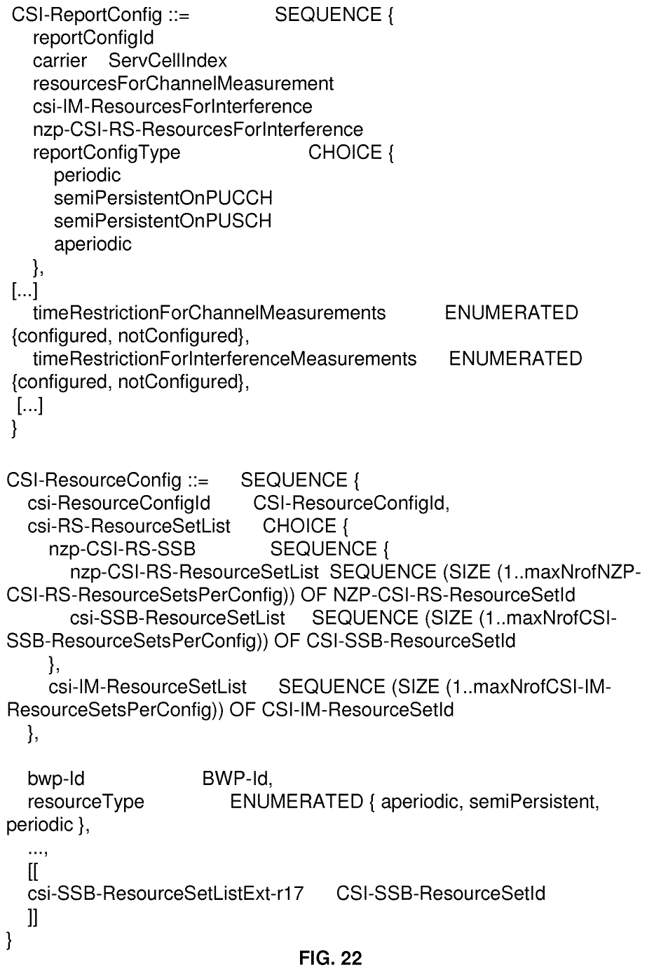

FIG. 20 and FIG. 21 show examples of channel state information (CSI) report in wireless communication systems. FIG. 22 shows an example of CSI configuration per an aspect of the present disclosure. As shown in FIG. 20 and FIG. 21, the wireless device may receive the one or more configuration parameters (e.g., via a cell of the NTN and/or from a base station). The one or more configuration parameters may comprise the NTN assistance information (e.g., the NTN-config). The one or more configuration parameters may comprise one or more CSI configuration parameters. FIG. 21 shows an example of the one or more CSI configuration parameters. The one or more CSI configuration parameters may comprise CSI resource configuration (CSI-ResourceConfig) and/or CSI report configuration (e.g., CSI-ReportConfig).

As FIG. 21 also shows, the one or more CSI configuration parameters may comprise at least one of the following: one or more CSI-RS resource settings/Resource Settings (e.g., configuration parameters for one or more CSI-RS resources, e.g., CSI-ResourceConfig); and/or one or more CSI reporting (or report) settings/Reporting Settings (e.g., configuration parameters for CSI reporting/report, e.g., CSI-ReportConfig), and/or one or more CSI measurement settings (e.g., configuration parameters for one or more CSI-RS measurement/receptions, e.g., for channel measurement or interference measurement). The one or more CSI measurement settings may comprise one or two list(s) of trigger states (configured/indicated by CSI-AperiodicTriggerStateList and CSI-SemiPersistentOnPUSCH-TriggerStateList). Each trigger state in the CSI-AperiodicTriggerStateList may contain/comprise (or indicate/configure) at least one associated CSI reporting setting (e.g., CSI-ReportConfig) indicating resource set ID/identity/identification/index (e.g., Resource Set IDs), e.g., of the one or more CSI reporting settings, for channel (measurement) and/or optionally for interference (measurement). Each trigger state in the CSI-SemiPersistentOnPUSCH-TriggerStateList may contain/comprise (or indicate/configure) at least one associated CSI reporting setting (e.g., CSI-ReportConfig). For a semi-persistent reporting on PUSCH (e.g., a semi-persistent CSI report on PUSCH), a CSI request field in a DCI scrambled with SP-CSI-RNTI may activate one of the trigger state of a set of trigger states configured by the CSI-SemiPersistentOnPUSCH-TriggerStateList.

A CSI-RS resource setting of the one or more CSI-RS resource settings may comprise one or more CSI-RS resource sets. The one or more CSI-RS resource sets may comprise/configure one or more CSI-RS resources, e.g., for receiving/measuring CSI-RS resources for channel/interference (e.g., for L1-RSRP and/or L1-SINR computation/measurement) and/or for mobility (e.g., configured by CSI-RS-Resource-Mobility of the one or more CSI configuration parameters) and/or tracking (e.g., when configured by higher layer parameters/configurations trs-Info of the one or more CSI configuration parameters). The one or more CSI-RS resource sets may comprise a list (or a plurality) of CSI resource sets/Resource Sets (e.g., indicated/provided by higher layer parameter csi-RS-ResourceSetList in FIG. 22). For example, the list of CSI Resource Sets may comprise of references to either or both of NZP CSI-RS resource set(s) and SS/PBCH block set(s) and/or CSI-IM Resource Set(s). In some examples, the list of CSI Resource Sets may comprise of reference(s)/linkage(s)/association(s) to CSI-IM resource set(s). Each CSI Resource Setting of the one or more CSI resource settings may be associated with/correspond to a DL BWP (e.g., identified by the higher layer parameter BWP-id in FIG. 22).

The wireless device may assume that NZP CSI-RS resource(s) (and/or CSI-IM resource(s)), of the one or more CSI-RS resource sets, for channel measurement and the CSI-IM resource(s) for interference measurement configured (by the one or more CSI configuration parameters) for one CSI reporting are resource-wise QCLed with respect to ‘typeD’. The NZP CSI-RS resource(s) (and/or CSI-IM resource(s)) may be configured/indicated by the NZP CSI-RS resource set(s) and/or the SS/PBCH block set(s) and/or CSI-IM Resource Set(s). When NZP CSI-RS resource(s) is used for interference measurement, the wireless device may assume that a NZP CSI-RS resource, of the one or more CSI-RS resource sets, for channel measurement and a CSI-IM resource (of the one or more CSI-RS resource sets) or NZP CSI-RS resource(s) (of the one or more CSI-RS resource sets) for interference measurement configured for one CSI reporting are QCLed with respect to ‘typeD’.

In an example, there may be one CSI-RS resource set for periodic CSI-RS, or semi-persistent (SP) CSI-RS or aperiodic CSI-RS. For example, the CSI-RS resource set may comprise at least one of the following: one CSI-RS type (e.g., periodic, aperiodic, or semi-persistent) and/or one or more CSI-RS resources. A time domain behavior of the CSI-RS resource(s) within the CSI-RS resource setting may be indicated/configured (e.g., by resourceType) as aperiodic (e.g., when receiving/measuring the CSI-RS resource(s) is triggered/scheduled by a DCI), periodic, or semi-persistent (e.g., when receiving/measuring the CSI-RS resource(s) is triggered/activated by a SP CSI-RS/CSI-IM Resource Set Activation/Deactivation MAC CE).

The wireless device may receive/measure a CSI-RS resource(s) based on associated CSI-RS resource setting. The CSI-RS resource setting (configured by the one or more CSI-RS resources) may comprise at least one of the following: CSI-RS resource configuration identity (or index); number of CSI-RS ports; CSI-RS configuration (symbol and RE locations in a subframe); CSI-RS subframe configuration (subframe location, offset, and/or periodicity in radio frame); CSI-RS power parameter; CSI-RS sequence parameter; CDM type parameter; frequency density; transmission comb; time domain behavior (e.g., periodic/semi-persistent/aperiodic); and/or QCL parameters.

The CSI resource setting may indicate a semi-persistent resource type (e.g., the resource Type being set with ‘semiPersistent’). In an example, the wireless device may receive a SP CSI-RS/CSI-IM Resource Set Activation MAC CE command indicating/activating at least one CSI-RS resource (or resource set) of the one or more CSI-RS resource sets (e.g., for channel/interference measurement(s). For example, the one or more CSI-RS resource sets may comprise one or more CSI-IM/NZP CSI-RS resource sets for interference measurement associated with the at least one CSI-RS resource. In response to receiving the activation command (e.g., SP CSI-RS/CSI-IM Resource Set Activation MAC CE command), e.g., for CSI-RS resource set(s) for channel measurement and CSI-IM/NZP CSI-RS resource set(s) for interference measurement associated with configured CSI resource setting(s), the wireless device may apply the activation (or selection) command from a first/initial/earliest slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for a PUCCH (for transmitting the HARQ-ACK acknowledgement bit of the activation command in/at slot n) and μ_{K}_{_{mac}} is the subcarrier spacing configuration for k_{mac} with a value of 0 for frequency range 1, and k_{mac} is provided (by the NTN-config) by K-Mac or k_{mac}=0 if K-Mac is not provided by (or absent from) the NTN-config. Applying the activation command may comprise QCL assumptions provided by a list of reference to TCI-State's, one per activated resource on CSI-RS/CSI-IM transmission corresponding to the configured CSI-RS/CSI-IM resource configuration(s). If a TCI-State referred to in the list is configured with a reference to an RS configured with qcl-Type set to ‘typeD’, that RS can be an SS/PBCH block, periodic or semi-persistent CSI-RS located in same or different CC/DL BWP.

In an example, the wireless device may receive a deactivate command (e.g., a SP CSI-RS/CSI-IM Resource Set Deactivation MAC CE command) for the (activated) at least one CSI-RS resource (or resource set), e.g., for activated CSI-RS/CSI-IM resource set(s) associated with configured CSI resource setting(s). In response to receiving the deactivate (or deactivation) command, the wireless device assumption on cessation (stopping/halting) of CSI-RS/CSI-IM transmission corresponding to the deactivated CSI-RS/CSI-IM resource set(s) may apply starting from a first/initial/earliest slot that is after slot

$$n + 3 {N}_{slot}^{subframe , μ} + \frac{{2}^{μ}}{{2}^{{μ}_{{K}_{mac}}}} \cdot {k}_{mac} .$$

As shown in FIG. 21 and FIG. 22, the base station may transmit to the wireless device the one or more CSI-RS (resources), e.g., CSI-RS #1 to CSI-RS #3. For example, the base station may transmit (via a cell of the NTN) and during/using one or more CSI-RS transmission/reception occasions (e.g., slots/subframes/symbols), the one or more CSI-RS resources (e.g., activated CSI-RS resources), e.g., based on CSI-RS resource setting of the one or more CSI-RS resources. The base station may, for example, transmit a CSI-RS resource of the one or more CSI-RS resources using/based on one of the following: CSI-RS resource configuration identity (or index) of the CSI-RS resource; number of CSI-RS ports of the CSI-RS resource; CSI-RS configuration (symbol and RE locations in a subframe) of the CSI-RS resource; CSI-RS subframe configuration (subframe location, offset, and/or periodicity in radio frame) of the CSI-RS resource; CSI-RS power parameter of the CSI-RS resource; CSI-RS sequence parameter of the CSI-RS resource; CDM type parameter of the CSI-RS resource; frequency density of the CSI-RS resource; transmission comb of the CSI-RS resource; time domain behavior (e.g., periodic/semi-persistent/aperiodic) of the CSI-RS resource; and/or QCL parameters of the CSI-RS resource. The transmission of the CSI-RS of one or more CSI resources may be periodically (e.g., when the resourceType is set to periodic) and/or aperiodic (e.g., when the resourceType is set to aperiodic), and/or semi-persistent (e.g., when the resourceType is set to semi-persistent). In the periodic transmission, the configured CSI-RS resource may be transmitted (by the base station) using a configured periodicity in time domain. In the aperiodic transmission, the configured CSI-RS resource may be transmitted (by the base station) in a dedicated time slot or subframe (by a DCI indicating the aperiodic CSI-RS resource). In the semi-persistent (or a multi-shot) transmission, the configured CSI-RS resource may be transmitted (by the base station) within a configured period (indicated by a MAC CE activation command). The base station may stop transmission of the one or more SP CSI-RSs if the CSI-RS is configured with a transmission duration. The base station may stop transmission of the one or SP CSI-RSs in response to transmitting a MAC CE or DCI for deactivating (or stopping the transmission of) the one or more SP CSI-RSs.

The wireless device may, during the one or more CSI-RS transmission/reception occasions and via the cell of the NTN, receive the one or more CSI-RS (resources), e.g., based on CSI-RS resource setting of the one or more CSI-RS resources. For example, the wireless device may receive/measure a CSI-RS resource of the one or more CSI-RS resources using/based on one of the following: CSI-RS resource configuration identity (or index) of the CSI-RS resource; number of CSI-RS ports of the CSI-RS resource; CSI-RS configuration (symbol and RE locations in a subframe) of the CSI-RS resource; CSI-RS subframe configuration (subframe location, offset, and/or periodicity in radio frame) of the CSI-RS resource; CSI-RS power parameter of the CSI-RS resource; CSI-RS sequence parameter of the CSI-RS resource; CDM type parameter of the CSI-RS resource; frequency density of the CSI-RS resource; transmission comb of the CSI-RS resource; time domain behavior (e.g., periodic/semi-persistent/aperiodic) of the CSI-RS resource; and/or QCL parameters of the CSI-RS resource.

The wireless device may, using/based on the received/measured on or more CSI-RS resources, prepare/determine (or obtain or derive or calculate or compute) at least one CSI report for transmitting the at least one CSI report, via the cell of the NTN, to the base station. Based on/using a CSI report/reporting setting (or Report Setting) of the one or more CSI reporting settings the wireless device may prepare/determine the at least one CSI report. For example, a CSI Resource Setting (of the one or more CSI Resource Settings) may be linked to the CSI report setting of the one or more CSI report setting. For determining the CSI report the wireless device may use measured/received one or more CSI-RS resources that are linked to the CSI report setting (or indicated by the CSI Resource Setting).

In an example, a CSI reporting setting of the one or more CSI reporting settings may comprise at least one of the following: a report configuration identifier; a report type; one or more reported CSI parameters; one or more CSI type (e.g., type I or type II); one or more codebook configuration parameters; one or more parameters indicating time-domain behavior (periodic CSI report/semi-persistent CSI report/aperiodic CSI report); frequency granularity for CQI and PMI; and/or measurement restriction configurations. The CSI reporting setting may further comprise at least one of: one periodicity parameter (e.g., indicating a periodicity of a CSI report); one duration parameter (e.g., indicating a duration of the CSI report transmission); and/or one slot offset (e.g., indicating a value of timing offset of the CSI report), if the report type is a periodic CSI report or a semi-persistent CSI report. For example, the one periodicity parameter and/or the one slot offset may apply in the numerology of an UL BWP in which the CSI report is configured to be transmitted on.

As shown in FIG. 20 and FIG. 21, the wireless device may, via the cell of the NTN, transmit the CSI report (during/on an uplink slot m) of the at least one CSI report, e.g., based on the received/measured one or more CSI-RS (resources) during/in the one or more CSI-RS transmission/reception occasions (e.g., the CSI-RS #2).

The report type of the CSI reporting setting may indicate a time domain behavior of the CSI report. For example, the time domain behavior may be indicated by a reportConfigType and may be set to ‘aperiodic’ (e.g., aperiodic CSI report using/on PUSCH), ‘semiPersistentOnPUCCH’ (e.g., semi-persistent CSI report using/on PUCCH), ‘semiPersistentOnPUSCH’ (e.g., semi-persistent CSI report using/on PUSCH that is activated by a DCI), or ‘periodic’ (e.g., periodic CSI report using/on PUCCH).

FIG. 21 may show an example of the aperiodic CSI report using/on PUSCH (or on PUCCH). For example, the base station may transmit a DCI to the wireless device triggering/scheduling the transmission of the CSI report (aperiodic CSI report), e.g., on PUSCH. The wireless device may transmit, during/withing on/in the UL slot m, the CSI report to the base station. For example, when aperiodic CSI-RS is not used with aperiodic reporting (e.g., when the CSI report is not based on the aperiodic CSI-RS), the wireless device may determine the UL slot m, for transmission of the CSI report, based on the (current) TA value of the wireless device, the scheduling offset (Koffset) and/or K2, e.g., D=Koffset+K2−TA. The DCI may indicate value of a slot offset (K2). For example, the DCI may comprise a ‘Time domain resource assignment’ field indicating the slot offset.

In other examples, when aperiodic CSI-RS is used with aperiodic reporting (e.g., when the CSI report is based on the aperiodic CSI-RS), the wireless device may determine the UL slot m, for transmission of the CSI report, based on the (current) TA value of the wireless device, the scheduling offset (Koffset) and/or an aperiodic triggering offset (X), e.g., D=Koffset+X−TA. As shown in FIG. 21, the one or more configuration parameters configure/indicate the aperiodic triggering offset (e.g., a CSI-RS offset per aperiodic CSI-RS resource of the one or more CSI-RS resources).

For example, the wireless device may determine (a first/earliest/initial symbol of) the UL slot m (or the PUSCH resource for transmitting the CSI report) being D (ms/slots/symbols) after/from a last/final/ending/latest symbol of the DCI (or a PDCCH monitoring occasion that the wireless device detects/receives the DCI) in the DL frame of the wireless device. Parameter D may further be based on one or more numerologies (e.g., PUSCH/PUCCH numerology and/or PDCCH numerology).

The higher layer parameter reportQuantity (of the one or more CSI configuration parameters) may indicate the CSI-related, L1-RSRP-related, or L1-SINR-related quantities to report via the CSI report. For example, for the periodic CSI report on PUCCH or the semi-persistent CSI report on PUCCH, a periodicity (measured in slots) and a slot offset may be configured (e.g., by reportSlotConfig). For example, for the semi-persistent CSI report on PUSCH, a periodicity measured in slots may be configured (e.g., by the reportSlotConfig). In an example, for the semi-persistent or the aperiodic CSI report on PUSCH, the allowed slot offsets may be configured based on at least whether the CSI report (semi-persistent or aperiodic) is activated/triggered by a DCI format 2_0 or a DCI format 1_0.

If the wireless device is configured (e.g., by the one or more CSI reporting settings) with the semi-persistent CSI reporting (on/using PUSCH or PUCCH), the wireless device may report CSI when both CSI-IM and NZP CSI-RS resources are configured as periodic or semi-persistent. If the wireless device is configured (e.g., by the one or more CSI reporting settings) with the aperiodic CSI reporting (on PUSCH), the wireless device may report CSI when both CSI-IM and NZP CSI-RS resources are configured as periodic, semi-persistent or aperiodic. For example, the CSI report may comprise Channel Quality Indicator (CQI), precoding matrix indicator (PMI), CSI-RS resource indicator (CRI), SS/PBCH Block Resource indicator (SSBRI), layer indicator (LI), rank indicator (RI), Layer 1 reference signal received power (L1-RSRP) or Layer 1 signal-to-interference-plus-noise ratio (L1-SINR).

In an example, for CQI, PMI, CRI, SSBRI, LI, RI, L1-RSRP, L1-SINR, the one or more CSI reporting settings may comprise one or more CSI-ReportConfig reporting settings, one or more CSI-ResourceConfig resource settings, and the one or two lists of trigger states (e.g., given by CSI-Aperiodic TriggerStateList and CSI-SemiPersistentOnPUSCH-TriggerStateList).

The at least one CSI measurement setting may comprise one or more links comprising one or more link parameters. The link parameter may comprise at least one of: one CSI reporting setting indication, CSI-RS resource setting indication, and one or more measurement parameters.

FIG. 20 and FIG. 21 also show a CSI reference resource in the time domain (or in the DL frame/configuration of the wireless device) corresponding to/associated with the CSI report in the UL slot m. The CSI reference resource may be (a first/earliest/starting symbol of) a DL slot b (a first DL slot) corresponding the CSI reporting (e.g., a periodic/semi-persistent/aperiodic CSI report) in the uplink slot m (e.g., a first uplink slot). The wireless device may, for transmitting the CSI report during/within/on/in/at the UL slot m, determine/identify the first DL slot (the slot b) as

$$b = n - {n}_{CSI , ref} - {K}_{offset} \cdot \frac{{2}^{{μ}_{DL}}}{{2}^{{μ}_{{K}_{offset}}}} .$$

As shown in FIG. 20, the first DL slot may be W ms/slots/symbols/subframes/prior to/before the UL slot n (a second DL slot). Downlink slot n (e.g., the second DL slot) may be determined (by the wireless device) based on/as

$$n = ⌊ m \frac{{μ}_{DL}}{{μ}_{UL}} ⌋ + Δ$$

where μ_{UL} is the SCS of the UL configuration, μ_{DL} is the SCS of the DL configuration, and Δ may depend on CA configuration (configured by the one or more configuration parameters). For example, determining the second DL slot may not be based on the NTN assistance information (e.g., the scheduling offset and/or the current TA value). The wireless device may determine the scheduling offset K_{offset} based on the one or more configuration parameters (e.g., one or more NTN configuration parameters), e.g., when the serving cell is part of the NTN, K_{cell,offset} and/or a differential offset indicated by a differential offset command (e.g., the differential K_{offset} MAC CE). When the cell is not part of the NTN, the first DL slot b is not based on the scheduling offset, e.g., as b=n−n_{CSI,ref}. In an example, n_{csi,ref} (e.g., a CSI reference gap/offset) may be based on at least one of: the type of the CSI reporting (e.g., periodic, aperiodic, or semi-persistent CSI reporting), whether a single CSI-RS/SSB resource or multiple CSI-RS/SSB resources are configured for channel measurement, and/or channel and interference measurements. For example, if a single CSI-RS/SSB resource is configured (by the one or more CSI configuration parameters) for channel measurement nCSI_ref is the smallest value greater than or equal to 4·2^{μ}^{_{DL}}. If multiple CSI-RS/SSB resources are configured (by the one or more CSI configuration parameters) for channel measurement nCSI_ref is the smallest value greater than or equal to 5·2^{μ}^{_{DL}}. The CSI reference gap/offset n_{CSI,ref} may not be based on the NTN assistance information (e.g., the scheduling offset and/or the current TA value).

When there is no valid downlink slot for the CSI reference resource corresponding to the CSI report setting in a serving cell (e.g., when the first DL slot is not a valid downlink slot), the wireless device may omit/avoid/skip transmitting the CSI reporting (e.g., a CSI report), e.g., drop or refrain from transmitting the CSI report, for the serving cell in/during/on the uplink slot m. For example, the wireless device may determine the first DL slot in the serving cell is a valid downlink slot based on the first DL slot comprises at least one downlink or flexible symbol (e.g., configured by the one or more configuration parameters, e.g., tdd-UL-DL-ConfigurationCommon and/or tdd-UL-DL-ConfigurationDedicated); and/or the first DL slot does not fall within a configured (or activated) measurement gap for that wireless device.

After CSI report (re) configuration (e.g., as a result of the handover procedure for handover from a first cell to a second cell or receiving an RRC reconfiguration messages indicating the CSI report reconfiguration), a serving cell activation, a BWP change/switch, or an activation of SP-CSI (e.g., based on receiving a command activating SP CSI resources), the wireless device may report/transmit the CSI report/reporting only after receiving at least one CSI-RS transmission occasion (e.g., corresponding to the activated SP CSI resources) for channel measurement and CSI-RS and/or CSI-IM occasion for interference measurement no later than the CSI reference resource and drops the report otherwise.

The wireless device may determine the CSI report based on a most recent, no later than the CSI reference resource, measurement/reception of a CSI-RS resource of the one or more CSI resources (e.g., CSI-RS #2 in FIG. 20 and/or FIG. 21). For example, based on the most recent measurement/reception of a CSI-RS resource of the one or more CSI resources (among/of the one or more CSI-RS transmission/reception occasions) being no later than (or being prior to/before) the CSI reference resource, the wireless device may determine (or obtain or calculate or derive or compute) the CSI report and/or transmit the CSI report. Based on the most recent measurement/reception of a CSI-RS resource of the one or more CSI resources (among/of the one or more CSI-RS transmission/reception occasions) being later than (or being after) the CSI reference resource, the wireless device may drop the CSI report (not transmit the CSI report). For example, the CSI reference resource may correspond to (or associated with the CSI report).

For example, if the higher layer parameter timeRestrictionForChannelMeasurements (e.g., to enable/configure/indicate a time domain restriction/behavior for channel measurements) in CSI-ReportConfig is set to “notConfigured”, the wireless device may derive/obtain/determine channel measurements for computing L1-RSRP value of the CSI report in the first UL slot based on only the SS/PBCH or NZP CSI-RS (among/of the one or more CSI-RS transmission/reception occasions), associated with the CSI resource setting, no later than the CSI reference resource. If the higher layer parameter timeRestrictionForChannelMeasurements in CSI-ReportConfig is set to “Configured”, the wireless device may derive/obtain/determine the channel measurements for computing L1-RSRP of the CSI report based on only a most recent, no later than the CSI reference resource, occasion of SS/PBCH or NZP CSI-RS (among/of the one or more CSI-RS transmission/reception occasions) associated with the CSI resource setting. If the higher layer parameter timeRestrictionForChannelMeasurements is set to “notConfigured”, the wireless device may derive/obtain/determine the channel measurements for computing CSI value of the CSI report based on only the NZP CSI-RS (among/of the one or more CSI-RS transmission/reception occasions), no later than the CSI reference resource, associated with the CSI resource setting. If the higher layer parameter timeRestrictionForChannelMeasurements in CSI-ReportConfig is set to “Configured”, the wireless device may derive/obtain/determine the channel measurements for computing/obtaining CSI reported in/of the CSI report in the uplink slot m based on only the most recent, no later than the CSI reference resource, reception/measurement occasion (among/of the one or more CSI-RS transmission/reception occasions) of NZP CSI-RS associated with the CSI resource setting. If the higher layer parameter timeRestrictionForInterferenceMeasurements (e.g., to enable/configure/indicate a time domain restriction/behavior for interference measurements) is set to “notConfigured”, the wireless device may derive/obtain/determine the interference measurements for computing CSI value reported in the CSI report in the uplink slot m based on only the CSI-IM and/or NZP CSI-RS for interference measurement (among/of the one or more CSI-RS transmission/reception occasions) no later than the CSI reference resource associated with the CSI resource setting. If the higher layer parameter timeRestrictionForInterferenceMeasurements in CSI-ReportConfig is set to “Configured”, the wireless device may derive/obtain/determine the interference measurements for computing the CSI value reported in the CSI report in the uplink slot m based on the most recent, no later than the CSI reference resource, occasion of CSI-IM and/or NZP CSI-RS for interference measurement (among/of the one or more CSI-RS transmission/reception occasions) associated with the CSI resource setting.

In an example, the base station may trigger/initiate (or request or activate) a CSI reporting by transmitting an RRC message of the one or more RRC messages, or a MAC CE, or a DCI (as shown in FIG. 21). The wireless device may perform periodic CSI reporting based on an RRC message (of the one or more RRC messages) and one or more periodic CSI-RSs (of the one or more CSI-RS resources). The wireless device may not be allowed (or required) to perform the periodic CSI reporting based on the one or more aperiodic CSI-RSs and/or one or more SP CSI-RSs (of the one or more CSI-RS resources). The wireless device may perform semi-persistent (SP) CSI reporting/report (on PUCCH or PUSCH) based on the SP CSI report (on PUSCH/PUCCH) being activated (e.g., a MAC CE or a DCI), and the one or more periodic/SP CSI-RSs. The wireless device may not be allowed (or required) to perform the SP CSI reporting based on the one or more aperiodic CSI-RSs. In an example, the wireless device may not be allowed (or required) to perform the semi-persistent CSI reporting based on one or more aperiodic CSI-RSs. In an example, the wireless device may perform aperiodic CSI reporting (e.g., report aperiodic CSI) based on a DCI and based on the one or more periodic CSI-RSs, the one or more SP CSI-RSs, or the one or more aperiodic CSI-RSs.

The CSI reporting (or report) may comprise transmitting/sending the CSI report via the serving cell (of the NTN). The wireless device may perform the CSI reporting by transmitting the CSI report at/during/in the uplink slot m. For example, a wireless device may perform the semi-persistent CSI reporting (e.g., report the semi-persistent CSI) based on a DCI (e.g., as shown in FIG. 21), and based on the one or more periodic CSI-RSs or the one or more SP CSI-RSs. For example, for a semi-persistent reporting on PUSCH, a set of trigger states may be configured (e.g., by CSI-SemiPersistentOnPUSCH-TriggerStateList), where the CSI request field in the DCI (e.g., activating DCI) scrambled with SP-CSI-RNTI activates one of the trigger states.

The wireless device may perform a semi-persistent CSI reporting on PUSCH in response to the semi-persistent CSI reporting being activated (or triggered) by the base station, e.g., based on the activating DCI. For example, the wireless device may perform the semi-persistent CSI reporting on (or using) PUSCH upon (or in response to) successful decoding of a DCI (e.g., activating DCI), e.g., a DCI format 0_1 or a DCI format 0_2, which activates a semi-persistent CSI trigger state. The DCI format 0_1 and the DCI format 0_2 may contain a CSI request field which may indicate the semi-persistent CSI trigger state to activate or deactivate. The CSI reporting on (or using) PUSCH (e.g., the semi-persistent CSI reporting on/using PUSCH) may be multiplexed with uplink data (from the wireless device) on PUSCH. For example, when the semi-persistent CSI reporting on PUSCH, activated by a DCI format (e.g., as shown in FIG. 20), is not expected to be multiplexed with the uplink data on the PUSCH, the wireless device may not multiplex the semi-persistent CSI reporting with the uplink data. In an example, the CSI reporting on PUSCH may be performed without any multiplexing with the uplink data on the PUSCH.

For example, the wireless device may receive a DCI (e.g., activating DCI) activating a SP CSI report/reporting on (or using) PUSCH. For a semi-persistent CSI report on (or using) PUSCH, a periodicity T_{CSI} (measured in slots) may be configured by a higher layer parameter reportSlotConfig of the one or more CSI configuration parameters (e.g., CSI-ReportConfig). A wireless device may transmit the semi-persistent CSI report on PUSCH in frames with SFN n_{f} and slot number within the frame

$${n}_{s , f}^{μ}$$

satisfying

$$( {N}_{slot}^{frame , μ} ( {n}_{f} - {n}_{f}^{start} ) + {n}_{s , f}^{μ} - {n}_{s , f}^{start} ) mod {T}_{CSI} = 0 ,$$

where

$${n}_{f}^{start} and {n}_{s , f}^{start}$$

are the SFN and slot number within the frame respectively of an initial/earliest/starting semi-persistent PUSCH transmission (occasion) according to the activating DCI. The wireless device may determine an initial/earliest/starting semi-persistent PUSCH transmission occasion/slot (for the initial/earliest/starting/first SP PUSCH transmission of the SP CSI report), e.g.,

$${n}_{f}^{start} ,$$

based on a report slot offset (e.g., a timing offset of the SP CSI report on/using PUSCH) value (of a list/plurality of report slot offsets or timing offsets for SP CSI report on/using PUSCH, e.g., reportSlotOffsetListDCI-0-2 or reportSlotOffsetListDCI-0-1 configured/indicated by the CSI-ReportConfig) indicated/selected by a CSI request field of the activating DCI. For example, the wireless device may determine the initial/earliest/starting semi-persistent PUSCH transmission occasion/slot (for the initial SP PUSCH transmission) being a first timing gap (e.g., D in FIG. 21) after the receiving the activating DCI. The first timing gap may be based on the scheduling offset (e.g., Koffset) and/or the selected/identified report slot offset (as indicated by the activating DCI).

For example, the first timing gap may be based on the cell-specific offset and/or the UE-specific offset. In some implementations, the first timing gap is based on r*Koffset, wherein r>=1. For example, r>=1 may allow the wireless device to compensate for the CSI reference resource of the first/initial SP CSI report. For example, when r=2 (e.g., D=X+2*Koffset), possibility of receiving at least one CSI-RS no later than the CSI reference resource of/for (or corresponding to) the initial semi-persistent PUSCH transmission increases, resulting in a lower possibility of dropping the initial semi-persistent PUSCH transmission.

By considering r<1 (e.g., D=X), the CSI reference resource of/for the initial semi-persistent PUSCH transmission may be before a reception occasion/slot of the activating DCI. When r<1, possibility of dropping the initial semi-persistent PUSCH transmission may grow.

In some other cases, to improve efficiency (e.g., not unnecessarily reserving PUSCH resources for SP CSI report), in response to receiving the activating DCI, the wireless device may activate the SP CSI report after the first timing gap after the receiving the DCI. For example, the wireless device may determine the initial/earliest/starting semi-persistent PUSCH transmission occasion/slot (for the initial SP PUSCH transmission), e.g.,

$${n}_{f}^{start} ,$$

based on a report slot offset value (of a list/plurality of report slot offsets, e.g., reportSlotOffsetListDCI-0-2 or reportSlotOffsetListDCI-0-1 or the like configured by the CSI-ReportConfig) indicated/selected by a CSI request field of the activating DCI.

Compared to a legacy scenario that the SP CSI report is activated when the activating DCI being validated (e.g., when the activating DCI being detected), by postponing the activation of the SP CSI report by the first timing gap after the detecting/validating the activating DCI, the wireless device may improve UL resource efficiency (as the PUSCH resources for the SP CSI report are not unnecessarily reserved when the wireless device is not able to transmit SP CSI reports on reserved PUSCHs).

The one or more CSI configuration parameters may semi-statistically configure the wireless device to perform periodic/SP CSI reporting on (or using) PUCCH. For example, the one or more CSI configuration parameters may configure multiple periodic CSI reports corresponding to one or more CSI reporting settings. For example, the PUCCH formats 2, 3, 4 may support Type I CSI with wideband granularity.

In an example, the wireless device may perform the semi-persistent CSI reporting on PUCCH in response to the semi-persistent CSI reporting being activated (or triggered), e.g., by a MAC CE (e.g., SP CSI reporting on PUCCH activation MAC CE). For semi-persistent reporting on (or using) PUCCH, the PUCCH resource used for transmitting a CSI report may be configured by reportConfigType. The wireless device may perform the semi-persistent CSI reporting on PUCCH applied starting from the first slot after transmitting a HARQ-ACK information corresponding to a PDSCH carrying the SP CSI reporting on (or using) PUCCH activation MAC CE command. For example, the semi-persistent CSI reporting on (or using) PUCCH may support Type I CSI. In an example, the semi-persistent CSI reporting on PUCCH format 2 may support Type I CSI with wideband frequency granularity. In an example, the semi-persistent CSI reporting on PUCCH formats 3 or 4 may support Type I CSI with wideband and sub-band frequency granularities and Type II CSI Part 1.

For example, for a semi-persistent CSI reporting/report on PUCCH, PUCCH resource used for transmitting the SP CSI report may be configured by reportConfigType of the CSI-ReportConfig. The base station may transmit the MAC CE (e.g., SP CSI reporting on PUCCH activation MAC CE) to the wireless device for activating the SP CSI report on (or using) PUCCH. The MAC CE may select/indicate/identify one of the semi-persistent Reporting Settings for use by the wireless device on the PUCCH. In response to receiving the MAC CE, the wireless device may apply/implement the MAC CE (e.g., activate the SP CSI report on PUCCH) in a first/earliest/starting/initial slot/subframe that is after a slot

$${k}_{1} + 3 {N}_{slot}^{subframe , μ}$$

(or slot

$${k}_{1} + 3 {N}_{slot}^{subframe , μ} + {K}_{mac}$$

when Kmac>0) where k₁ is a slot/occasion where the wireless device may transmit a PUCCH with HARQ-ACK information for a PDSCH (or MAC PDU) providing the MAC CE, μ is the SCS configuration for the PUCCH transmission that is determined in the slot when the MAC CE is applied.

If a HARQ feedback of a HARQ process corresponding to the MAC CE (e.g., SP CSI reporting on PUCCH activation MAC CE) is enabled, the wireless device may apply/implement the MAC CE in the first/earliest/starting/initial slot/subframe that is after the slot slot

$${k}_{1} + 3 {N}_{slot}^{subframe , μ}$$

(or slot

$${k}_{1} + 3 {N}_{slot}^{subframe , μ} + {K}_{mac}$$

when Kmac>0) where k₁ is a slot/occasion where the wireless device may transmit the PUCCH with HARQ-ACK information for the PDSCH providing the MAC CE, Kmac is indicated by the NTN-config. In an example, the one or more configuration parameters may enable the HARQ feedback of the HARQ process (e.g., indicate/configure the HARQ process as a feedback-enabled HARQ process). For example, the base station may, via/according to the one or more RRC messages (e.g., a configured bitmap), or a MAC CE (e.g., SP CSI reporting on PUCCH activation MAC CE), or a DCI (e.g., a DCI scheduling the MAC CE), indicate the HARQ process as a feedback-enabled HARQ process.

If a HARQ feedback of the HARQ process corresponding to the MAC CE (e.g., SP CSI reporting on PUCCH activation MAC CE) is disabled, the wireless device may apply the MAC CE command in a first/earliest/starting/initial slot/subframe that is after a slot l₁ (e.g., the first parameter) from a slot that the MAC CE is received. In an example, the one or more configuration parameters may enable the HARQ feedback of the HARQ process (e.g., indicate/configure the HARQ process as a feedback-enabled HARQ process). For example, the base station may, via/according to the one or more RRC messages (e.g., a configured bitmap), or the MAC CE (e.g., SP CSI reporting on PUCCH activation MAC CE), or a DCI (e.g., the DCI scheduling the MAC CE), indicate the HARQ process as a feedback-disabled HARQ process. The wireless device may, based on the first parameter and in response to the MAC CE corresponding to feedback-disabled HARQ processes, determine the slot 11 after the first parameter from/after a slot (or a last symbol of the PDSCH with the SP CSI reporting on PUCCH activation MAC CE) that MAC CE is received.

In some implementations, in order to reduce possibility of dropping a first/initial/earliest SP CSI report on (or using) PUCCH, the wireless device may, in response to receiving the MAC CE activating the SP CSI report on PUCCH, activate the SP CSI report on PUCCH (e.g., apply/implement the MAC CE) after the first timing gap after/after the slot

$${k}_{1} + 3 {N}_{slot}^{subframe , μ}$$

(or slot

$${k}_{1} + 3 {N}_{slot}^{subframe , μ} + {K}_{mac}$$

when Kmac>0). By activating the SP CSI report on PUCCH after the first timing gap after the slot k₁+

$$3 {N}_{slot}^{subframe , μ}$$

(or slot

$${k}_{1} + 3 {N}_{slot}^{subframe , μ} + {K}_{mac}$$

when Kmac>0), the CSI reference resource corresponding to the first/initial/earliest SP CSI report on (or using) PUCCH may be later than (or not before) the slot

$${k}_{1} + 3 {N}_{slot}^{subframe , μ}$$

(or slot

$${k}_{1} + 3 {N}_{slot}^{subframe , μ} + {K}_{mac}$$

when Kmac>0). This improves possibility of receiving at least one CSI-RS resource no later than the CSI reference resource corresponding to the first/initial/earliest SP CSI report on PUCCH, and consequently successful transmission of the initial/first SP CSI report on/suing PUCCH.

By activating the SP CSI report on (or using) PUCCH after the slot

$${k}_{1} + 3 {N}_{slot}^{subframe , µ}$$

(or slot

$${k}_{1} + 3 {N}_{slot}^{subframe , µ} + {K}_{mac}$$

when Kmac>0), the CSI reference resource corresponding to the first/initial/earliest SP CSI report on PUCCH may be before the slot

$${k}_{1} + 3 {N}_{slot}^{subframe , µ}$$

(or slot

$${k}_{1} + 3 {N}_{slot}^{subframe , µ} + {K}_{mac}$$

when Kmac>0), which increases a possibility of not receiving at least one CSI-RS resource before (no later than) the CSI reference resource corresponding to the first/initial/earliest SP CSI report on PUCCH. For example, the wireless device may drop the first/initial/earliest SP CSI report on PUCCH based on not receiving the at least one CSI-RS resource no later than the CSI reference resource corresponding to the first/initial/earliest SP CSI report on PUCCH.

In another implementations, the wireless device may determine a first/initial/earliest PUCCH resource/occasion (slot) for the first/initial/earliest SP CSI report on PUCCH based on the first timing gap and/or the slot

$${k}_{1} + 3 {N}_{slot}^{subframe , µ}$$

(or slot

$${k}_{1} + 3 {N}_{slot}^{subframe , µ} + {K}_{mac}$$

when Kmac>0). For example, the wireless device may determine the first/initial/earliest PUCCH resource/occasion (slot) for the first/initial/earliest SP CSI report on PUCCH based on the first timing gap after the slot

$${k}_{1} + 3 {N}_{slot}^{subframe , µ}$$

(or slot

$${k}_{1} + 3 {N}_{slot}^{subframe , µ} + {K}_{mac}$$

when Kmac>0). This reduces possibility of dropping the first/initial/earliest SP CSI report on PUCCH by improving possibility of receiving at least one CSI-RS resource no later than the CSI reference resource corresponding to the first/initial/earliest SP CSI report on PUCCH.

A base station may configure (via the one or more CSI configuration parameters) a wireless device to measure (or derive or compute or determine or obtain) a CSI value, associated/corresponding to a CSI resource setting (e.g., of the one or more CSI resource settings), for determining (or obtaining/computing/calculating/deriving) a CSI reporting/report. Similar to embodiment of FIG. 20 and/or FIG. 21 discussed above, the wireless device may send/transmit the CSI report, via a serving cell and to the base station, during/in/on the first uplink slot. The serving cell may be part of an NTN. The wireless device may transmit the CSI report via a PUSCH or PUCCH. The wireless device may derive (or calculate or obtain or determine) channel/interference measurements for computing (or calculating or obtaining or determining) the CSI reporting (or report) in/on/during the first uplink slot based on receiving/measuring, no later than the CSI reference resource, a CSI-RS/CSI-IM (e.g., CSI-RS resource associated with a CSI resource setting configured/indicated by the one or more CSI configuration parameters) among/of the one or more CSI-RS transmission/reception occasions. For example, the receiving/measuring the CSI-RS may comprise receiving/measuring a second occasion (of the CSI-RS transmission/reception occasion of the one or more CSI-RS transmission/reception occasions). The second occasion (of the CSI-RS transmission/reception occasion of the one or more CSI-RS transmission/reception occasions) may be a most recent occasion of the CSI-RS transmission/reception occasion. The second occasion may be a most recent occasion of the one or more CSI-RS transmission/reception occasion that is no later than a CSI reference resource (corresponding to the CSI report).

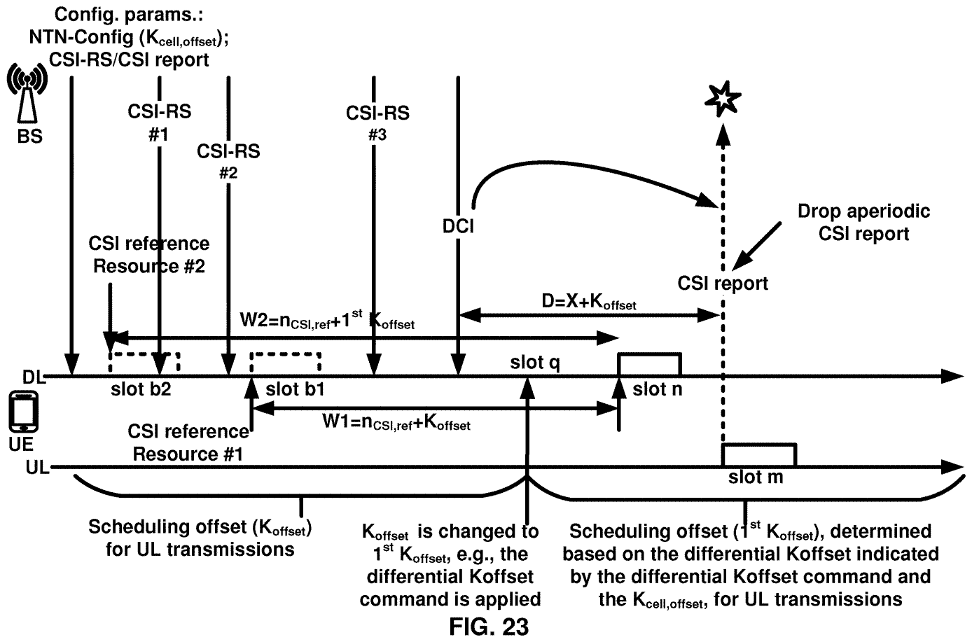

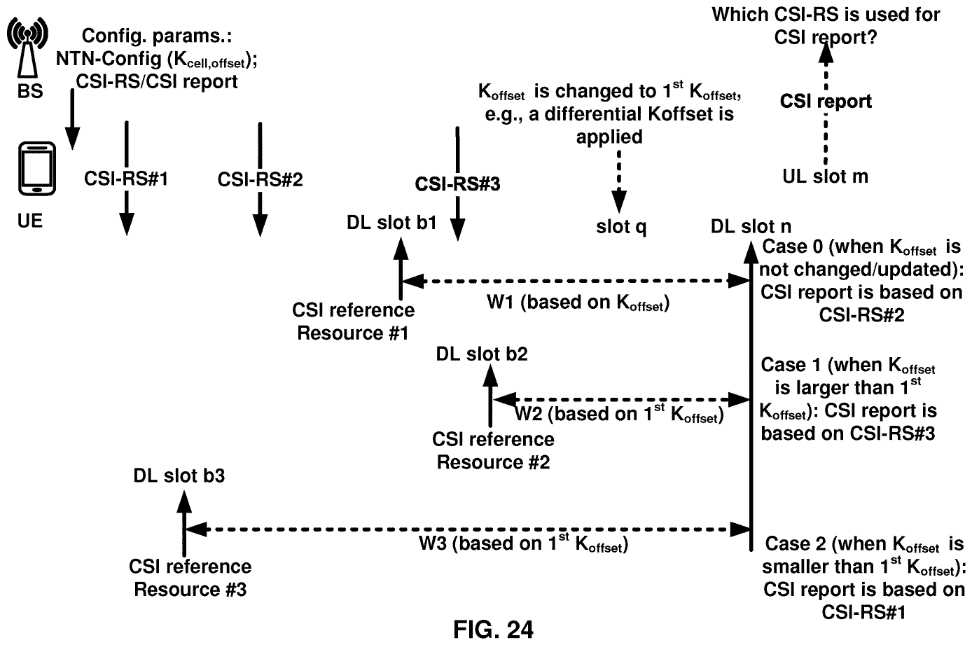

In existing technologies, when the serving cell is part of the NTN, in response to/after a change/update (or modification) of the scheduling offset (Koffset) prior to the first UL slot, the wireless device may mistakenly determine the CSI report (e.g., mistakenly derive the CSI value for the CSI report) or mistakenly drop the CSI report (see FIG. 23 and FIG. 24 for examples). In response to/after a change/update of the scheduling offset prior to the first UL slot, the wireless device may, prior to/before the first UL slot, update (or change or modify or recalculate or redetermine) the corresponding CSI reference resource of the CSI report. Updating the corresponding CSI reference resource of the CSI report prior to/before the first UL slot may result in mistakenly dropping the CSI report or mistakenly calculating/determining the CSI value of the CSI report.

For example, in response to/after a change/update of the scheduling offset prior to the first UL slot, the wireless device may mistakenly calculate the CSI value for obtaining the CSI report based on a using (wrong) CSI-RS/CSI-IM transmission occasion (for channel measurement and/or for interference measurement) of the one or more CSI-RS transmission/reception occasions (e.g., referring to FIG. 20/FIG. 21 using CSI-RS #1 or CSI-RS #3 instead of CSI-RS #2). For example, the base station by using the (wrong) CSI report may calculate/determine DL transmission parameters (e.g., Modulation and coding scheme, DL beam, or DL power) for transmission of PDCCHs/PDSCHs to the wireless device. The base station may assume the CSI report comprise a correct/relevant CSI value for determining DL transmission parameters (e.g., CSI-RS #2) while it comprises a wrong CSI value (CSI-RS #1 or CSI-RS #3). The implementation of existing technologies may result in a possibility of higher decoding error as the wireless device may fail to correctly receive/decode the PDCCHs/PDSCHs. A first occasion/resource/slot for receiving/measuring CSI-RS #2 may be at least 1 to 256 slots/ms after a second occasion/resource/slot for receiving/measuring CSI-RS #3 or before a third occasion/resource/slot for receiving/measuring CSI-RS #1.

In another example, in response to/after a change/update of the scheduling offset prior to the first UL slot, the wireless device may mistakenly drop (or refrain from transmitting) the CSI report based on a most recent occasion of the one or more CSI-RS transmission/reception occasion being later than an updated/recalculated CSI reference resource (e.g., the corresponding CSI reference resource of the CSI report). By not transmitting the CSI report, the base station may not be able to properly determine DL transmission parameters (e.g., Modulation and coding scheme, DL beam, or DL power) for transmission of PDCCHs/PDSCHs to the wireless device, e.g., use outdated DL transmission parameters (e.g., Modulation and coding scheme, DL beam, or DL power). The implementation of existing technologies may result in a possibility of higher decoding error as the wireless device may fail to correctly receive/decode the PDCCHs/PDSCHs.

In an NTN scenario and when the scheduling offset is changed/updated, enhancements in the CSI reporting may improve the DL data rate and/or DL communication reliability.

FIG. 23 and FIG. 24 show examples of CSI report in an NTN per an aspect of the present disclosure. In the example of FIG. 23, transmitting the CSI report may be triggered/scheduled by a DCI (transmitted by the base station), e.g., aperiodic CSI report or semi-persistent CSI report. Compared to embodiment of FIG. 21, in FIG. 23, after receiving the DCI triggering the CSI report and prior to the first UL slot, the wireless device may (during/within/on at a slot q) determine the scheduling offset being changed/updated (as discussed above corresponding to FIG. 19C).

As shown in FIG. 23 and FIG. 24, during/within/on at the slot q (prior to/before the UL slot m and/or after/later than a first CSI reference resource corresponding to the CSI report), the wireless device may determine the scheduling offset being changed/updated from Koffset (e.g., a current value of the scheduling offset/Koffset) to a first Koffset. For example, during/within occasion/slot/symbol/time q the wireless device may determine the (value) scheduling offset being changed/updated from Koffset (value) to a first Koffset (value). In an NTN scenario, the change/update of the scheduling offset from the Koffset to the first Koffset may comprise 1 to 256 slots/milliseconds, e.g., a (time domain) difference between an occasion/slot b2 (or b3) and an occasion/slot b1 (in FIG. 23 and/or FIG. 24) may be at least 1 slot/ms or at most 256 slots/ms. For example, a (time domain) difference between W1 and W2 (or W2) may be at least 1 slot/ms or at most 256 slots/ms. The slot/occasion b2 may be W2 (slots/subframes/symbols/ms) prior to a second DL slot (e.g., the slot n in FIG. 22 and/or FIG. 23). The slot/occasion b3 may be W3 (slots/subframes/symbols/ms) prior to the second DL slot. Note that in a terrestrial network, compared to an NTN scenario, as both the cell-specific Koffset and the UE-specific Koffset are zero (e.g., the first CSI reference resource corresponding to the CSI report is not changed to the second CSI reference report and/or the third CSI reference report prior to the CSI report in/during the first UL slot), the wireless device may not encounter issue/problem depicted in FIG. 23 and/or FIG. 24 (e.g., similar to Case 0 in FIG. 24).

For example, the slot q may correspond to a slot/occasion/time that the higher layers (MAC layer) of the wireless device notifies/informs/indicates to the PHY layer of the wireless device the (first or second) differential Koffset (e.g., information of the (first or second) differential Koffset MAC CE). In another example, the slot q may correspond to a slot/occasion/time that the wireless device apply/implement the indicated differential Koffset (e.g., as discussed above in FIG. 19C). The first Koffset may be determined based on the Koffset and the indicated differential Koffset. The first Koffset may be determined based on the cell-specific Koffset and the indicated differential Koffset.

In some scenarios, the first Koffset may be larger/greater (by a value from 1 to 256 slots/ms) than the Koffset (e.g., Case 2 in FIG. 20), e.g., depending on the indicated differential Koffset. As also shown in FIG. 24, corresponding to Case 2, W3 is larger/greater than W1 and/or W2.

In some other scenarios, the first Koffset may be smaller (by a value from 1 to 256 slots/ms) than the Koffset (e.g., Case 1 in FIG. 23), e.g., depending on the indicated differential Koffset. As also shown in FIG. 24, corresponding to Case 1, W2 is smaller (or not greater) than W1 and/or W3.

Case 0 in FIG. 24 may correspond to a scenario that there is no change/update of the scheduling offset prior to the first UL slot (e.g., transmission occasion/resource of the CSI report).

The slot q may correspond to a slot/occasion/time that the second time window or the third time window is started/initiated/begun. For example, the slot q may correspond to a slot/occasion/time that the first time window is stopped/expired. The slot q may correspond to a slot/occasion/time that the higher layers (MAC layer) of the wireless device may notify/inform/indicates to the PHY layer of the wireless device that the configured/indicated differential Koffset is cleared/dropped/deleted. For example, the slot q may correspond to a slot/occasion/time that the first time window is started (e.g., due to the configured/indicated differential Koffset is cleared/dropped/deleted), e.g., the first Koffset may be equal to the cell-specific Koffset. For example, as a result of the configured/indicated differential Koffset being cleared/dropped/deleted, the first Koffset may become larger than the Koffset (e.g., Case 2 in FIG. 24).

The wireless device may determine the scheduling offset being changed/updated at the slot q (from the Koffset to the first Koffset) in response to/based on/after receiving the differential Koffset MAC CE (e.g., the first/second differential Koffset MAC CE). In one example, a MAC PDU or a PDSCH may indicate/comprise (or be with) the differential Koffset MAC CE. The wireless device may apply the differential Koffset MAC CE (at the slot q) prior to the first UL slot and/or later than the first CSI reference resource.

FIG. 24 and FIG. 23 also shows examples of (re) determination/(re) calculation of the first CSI reference resource (corresponding to the CSI report in/during the UL slot m), e.g., a CSI resource reference #1, in response to the change/update of the scheduling offset prior to the UL slot m and/or after the first CSI reference resource). The first CSI reference resource may be (or correspond to) a slot b1. For example, in response to the change/update of the scheduling offset prior to the UL slot m (e.g., when the first Koffset is smaller than the Koffset), the wireless device may determine a second CSI reference resource (a CSI reference resource #2) corresponding to the CSI report in/during the UL slot m, e.g., update/change corresponding CSI reference resource for the CSI report from the slot b1 into a slot b2 (Case 1, e.g., advancing a CSI reference resource corresponding to the CSI report). In another example, in response to the change/update of the scheduling offset prior to the UL slot m (e.g., when the first Koffset is greater/larger than the Koffset), the wireless device may determine a third CSI reference resource (a CSI reference resource #3) corresponding to the CSI report in/during the UL slot m, e.g., update/change corresponding CSI reference resource for the CSI report from the slot b1 into a slot b3 (Case 2, e.g., delaying a CSI reference resource corresponding to the CSI report).

In existing technologies, in an NTN scenario, as a result of advancing/delaying a CSI reference resource corresponding to the CSI report due to a change/update of the scheduling offset prior to the first UL slot, the wireless device may mistakenly compute the CSI value of the CSI report. For example, instead of using the CSI-RS #2 in FIG. 24 for computing/determining the CSI report (as the base station expects), the wireless device may use the CSI-RS #3 (Case 1) or the CSI-RS #1 (Case 2). In another example, as also shown in FIG. 23, the wireless device may drop the CSI report as the most recent CSI reception/transmission occasion (e.g., the CSI-RS #1) being after the second CSI reference resource. In an NTN scenario, efficiency/accuracy of the CSI report may reduce, resulting in a possibility of higher decoding error as the wireless device may fail to correctly receive/decode the PDCCHs/PDSCHs.

Embodiments of the present disclosure are related to an approach for determining whether to use an indicated differential offset for determining a CSI reference resource of a CSI report. Some embodiments of the present disclosure may allow the wireless device to determine an applicable scheduling offset (Koffset) for determining the CSI reference resource of the CSI report. For example, the wireless device may, using the determined CSI reference resource of the CSI report, determine whether to transmit the CSI report or drop the CSI report. For example, the wireless device may, using the determined CSI reference resource of the CSI report, determine a CSI value of the CSI report. These and other features of the present disclosure are described further below.

In an example embodiment, for transmitting a CSI report in/during a first UL slot (e.g., for determining a CSI value of the CSI report), a wireless device may determine a CSI reference resource corresponding to the CSI report. In response to applying, in a second occasion, a differential Koffset MAC CE indicating a differential offset, the wireless device may determine whether to use the indicated differential offset for determining the CSI reference resource corresponding to the CSI report or not. In response to a first occasion being after the second occasion, the CSI reference resource may be based on the differential offset (e.g., the wireless device may use the indicated differential offset for determining the CSI reference resource of the CSI report). In response to the first occasion being no later than the second occasion, the CSI reference resource may be based on a cell-specific offset of the NTN (e.g., the wireless device may avoid using/no use the indicated differential offset for determining the CSI reference resource of the CSI report). In an example, the wireless device may determine a CSI reference signal (RS) being received in a third occasion that occurs before the CSI reference resource of the CSI report. For example, the wireless device may transmit the CSI report based on the CSI-RS received in the third occasion (e.g., the CSI value of the CSI report is based on the CSI-RS received in the third occasion).

The first occasion may be associated with the CSI report. For example, the first occasion may be (determined/identified) based on the first UL slot or the first UL slot may be (determined/identified) based on the first occasion. The first occasion may be a DL slot corresponding to the first UL slot. The first occasion may be a timing gap (e.g., CSI reference gap/offset) prior to the first UL slot. The first occasion may be (or correspond to) a PDCCH monitoring occasion. The wireless device may, via/during the PDCCH monitoring occasion, detect/receive a DCI indicating/triggering the transmission of the CSI report (e.g., aperiodic/semi-persistent CSI report).

In an example embodiment, to determine whether to transmit a CSI report (in/during a first UL slot) or drop the CSI report, a wireless device may determine the CSI reference resource corresponding to the CSI report. In an example, the wireless device may determine a CSI reference signal (RS) being received in a third occasion that occurs later than/after the CSI reference resource of the CSI report. For example, the wireless device may drop the CSI report based on the CSI-RS received after the CSI reference resource. In response to the first occasion being after the second occasion, the CSI reference resource may be based on the differential offset (e.g., the wireless device may use the indicated differential offset for determining the CSI reference resource of the CSI report). In response to the first occasion being no later than the second occasion, the CSI reference resource may be based on the cell-specific offset (e.g., the wireless device may avoid using/no use the indicated differential offset for determining the CSI reference resource of the CSI report).

In an example embodiment, a wireless device may receive a radio resource control (RRC) message indicating a cell-specific offset (of an NTN). The wireless device may, e.g., via the NTN, receive a downlink control information (DCI), in a first occasion, indicating a transmission of a channel state information (CSI) report. For example, in response to receiving a differential Koffset medium access control (MAC) control element (CE) indicating a differential offset, the wireless device may apply, in a second occasion, the differential offset indicated by the differential Koffset MAC CE. The wireless device may determine a CSI reference resource corresponding to the CSI report. In response to the first occasion being after the second occasion, the CSI reference resource may be based on the differential offset. In response to the first occasion being no later than the second occasion, the CSI reference resource may be based on the cell-specific offset. In an example, the wireless device may determine a CSI reference signal (RS) being received in a third occasion that occurs before the CSI reference resource of the CSI report. For example, the wireless device may transmit the CSI report based on the CSI-RS received in the third occasion.

For example, based on CSI-RS being received in a third occasion that occurs before the CSI reference resource of the CSI report, the wireless device may transmit the CSI report based on the CSI-RS received in the third occasion. Based on the CSI-RS being received in the third occasion that occurs later than/after the CSI reference resource of the CSI report, the wireless device may drop the CSI report.

In an example embodiment, a wireless device may, e.g., via an NTN, receive a DCI, in a first occasion, indicating a transmission of a channel state information (CSI) report. For example, in response to receiving a differential Koffset MAC CE indicating a differential offset, the wireless device may apply, in a second occasion, the differential offset indicated by the differential Koffset MAC CE. The wireless device may determine a CSI reference resource corresponding to the CSI report. In response to the first occasion being after the second occasion, the CSI reference resource may be based on the differential offset. In response to the first occasion being no later than the second occasion, the CSI reference resource may not be based on the differential offset. Based on CSI-RS being received in a third occasion that occurs before the CSI reference resource of the CSI report, the wireless device may transmit the CSI report based on the CSI-RS received in the third occasion. Based on the CSI-RS being received in the third occasion that occurs later than/after the CSI reference resource of the CSI report, the wireless device may drop the CSI report.

Embodiments of the present disclosure improve (accuracy) CSI reporting in an NTN scenario. Using accurate CSI report, a base station may determine UL/DL scheduling parameters.

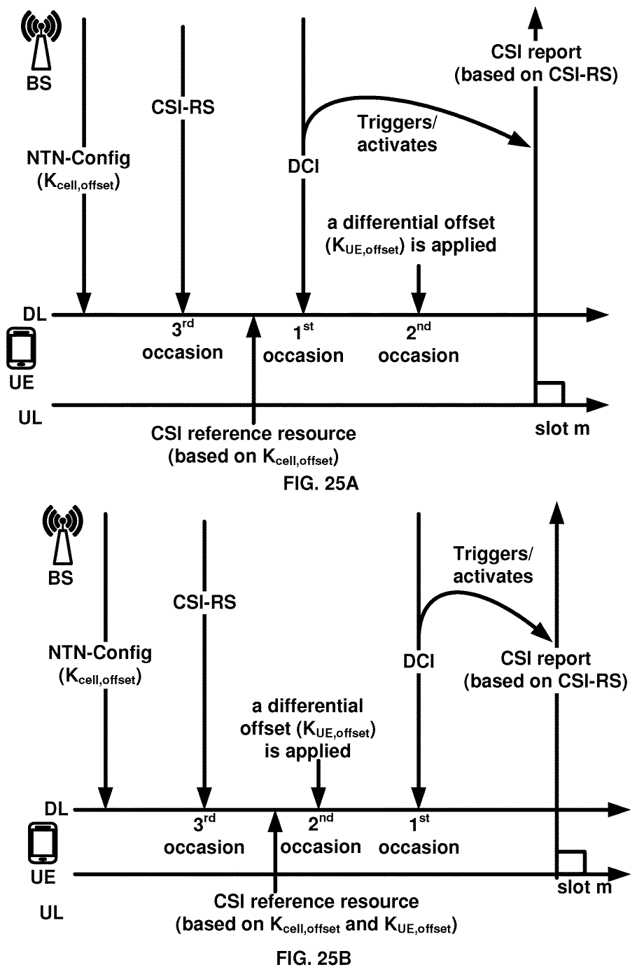

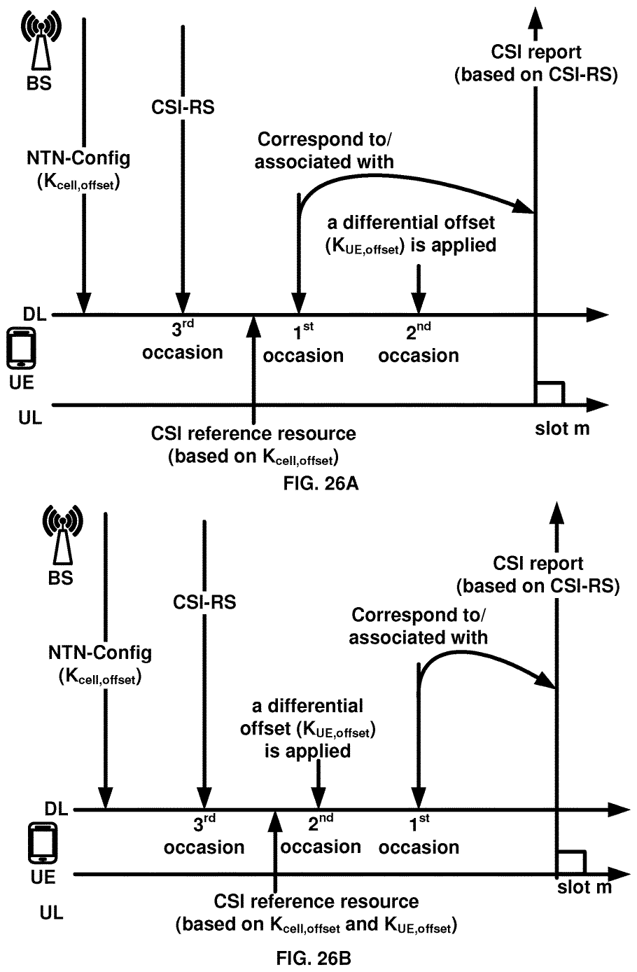

FIG. 25A, FIG. 25B, FIG. 26A, and FIG. 26B show examples of CSI reporting in an NTN scenario per an aspect of the present embodiment. Embodiments of FIG. 25A, FIG. 25B, FIG. 26A, and FIG. 26B may provide examples of a procedure at the wireless device for determining whether to transmit a CSI report or not and/or a CSI value of the CSI report. For example, in response to applying/receiving a differential offset, the wireless device may determine/identify the CSI reference resource (and therefore the CSI value of the CSI report) and/or whether to drop or transmit the CSI report. Embodiments of FIG. 25A, FIG. 25B, FIG. 26A, and FIG. 26B may provide examples of a procedure for determining applicable UE-specific offset (e.g., KUE, offset) for determining/obtaining a CSI reference resource corresponding to the CSI report, e.g., in response to applying/receiving a differential offset (from a base station).

In the examples of FIG. 25A and FIG. 25B, the CSI report may be an aperiodic CSI report triggered/scheduled by a DCI or a (first/earliest CSI report of a) semi-persistent CSI report activated by the DCI. In the examples of FIG. 26A and FIG. 26B, the CSI report may be a periodic/semi-persistent CSI report.

The wireless device may receive the one or more messages (the one or more RRC messages and/or the one or more MAC CEs and/or the one or more DCIs) from the base station, e.g., via the first NTN node of the cell (serving cell). The one or more messages may comprise/indicate the one or more configuration parameters. The one or more messages may comprise handover messages. The one or more messages may comprise RRC setup message(s) and/or RRC reconfiguration message(s) and/or RRC resume/release message(s). The wireless device may receive the one or more messages as part of a handover procedure and/or initial access procedure and/or connection resume procedure and/or connection re-establishment procedure and/or radio failure recovery procedure or the like. For example, a message of the one or more messages may be a broadcast/multicast/groupcast message (e.g., an NTN-specific SIB, e.g., SIB19, and/or SIB1 and/or positioning SIB). In some cases, a message of the one or more messages may be dedicated (unicast) message.

The one or more configuration parameters may, for example, comprise/indicate one or more serving cell (e.g., one or more Serving Cells or one or more cells) configuration parameters (e.g., ServingCellConfigCommon, ServingCellConfigCommonSIB, and/or ServingCellConfig) for configuring one or more cells (e.g., the one or more Serving Cells, e.g., the serving cell/cell). For example, the one or more cells may comprise a master (or primary) cell group (MSG) and/or a secondary cell group (SCG). In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). For example, the one or more configuration parameters may configure the wireless device for multi-cell communications and/or carrier aggregation. The cell (the serving cell) may belong to a SCG group or an MCG group. The cell may correspond to a pTAG (or a sTAG). The cell may, for example, be a PCell or a PSCell or a SpCell. The cell may be part of the NTN.

The one or more configuration parameters may comprise the NTN assistance information (e.g., comprising the first set of NTN configuration parameters, and/or comprising the at least one NTN-config, e.g., the NTN-config of the cell/serving cell), e.g., one or more NTN configuration parameters. The wireless device may receive (via the cell) the NTN-specific SIB (e.g., SIB19) comprising the one or more NTN configuration parameters. The one or more configuration parameters may comprise the NTN-config of the cell. The NTN assistance information may comprise a cell-specific offset (or cell-specific Koffset or cell-specific scheduling offset), e.g., Kcell,offset.

The one or more NTN configuration parameters may configure/indicate at least one of the following: t-Service (of each NTN node, e.g., a first NTN node and/or a second NTN node, of the cell) indicating a time that coverage provided by an NTN node (e.g., the first NTN node and/or the second NTN node) of the cell is stopped/finished/ended (e.g., the time information on when the cell provided via an NTN quasi-Earth fixed system, e.g., the first/second NTN node, is going to stop serving the area it is currently covering, e.g., the coverage area of the first/second NTN node); and/or a t-start indicating/configuring a time for starting a (soft/hard) satellite switching procedure, e.g., a time for starting searching SSBs corresponding to the second NTN node of the cell and/or a time for starting the coverage of the second NTN node; and/or a t-gap. The one or more configuration parameters may indicate whether the satellite switching procedure is hard or soft.

The one or more configuration parameters (e.g., the one or more NTN configuration parameters) may indicate whether the satellite switching procedure is based on the handover procedure (e.g., PCI changed scenario) or not (e.g., the PCI unchanged scenario). For example, the one or more configuration parameters may implicitly indicate the service link switching without changing the PCI of the cell (e.g., the PCI unchanged scenario or procedure) by configuring/indicating the first time and/or the first gap. In another example, the one or more configuration parameters may implicitly indicate the service link switching without changing the PCI of the cell (e.g., the PCI unchanged scenario or procedure) by configuring/indicating a flag/parameter. The parameter may enable (or disable) the service link switching without changing the PCI of the cell. For example, based on the parameter being enabled/configured/indicated, the wireless device may determine the service link switch procedure is without changing the PCI of the cell (e.g., the PCI unchanged procedure, e.g., the second satellite switch procedure). Based on the parameter not being enabled/configured/indicated (or being disabled or being absent from the one or more NTN configuration parameters), the wireless device may determine the service link switch procedure is with changing the PCI of the cell (e.g., the handover procedure).

The one or more configuration parameters may comprise the one or more CSI configuration parameters. The wireless device may identify/determine a first UL slot (e.g., the UL slot m) for transmitting the CSI report. For example, the wireless device may identify/determine a first occasion associated/corresponding to the CSI report. When the CSI report is the aperiodic CSI report (or a semi-persistent CSI report), the wireless device may, in/during/on/at the first occasion, receive a DCI triggering/indicating/scheduling the CSI report. As shown in FIG. 25A and FIG. 25B, the wireless device may, e.g., from the serving cell of the NTN and/or from the base station via the NTN, the DCI, in the first occasion (or slot or interval), e.g., a first PDCCH monitoring occasion, indicating a transmission of the channel state information (CSI) report. When the CSI report is the periodic CSI report (or the semi-persistent CSI report), the first occasion may be based on the first UL slot. For example, the first occasion may be the DL slot n (see FIG. 20). For example, the wireless device may determine the first occasion based on a CSI reference gap/offset of the CSI report. The first occasion may be the CSI reference gap/offset of the CSI report prior to/before the first UL slot.

The wireless device may apply, in/during/on/at a second occasion (e.g., a slot q), a differential offset indicated by a differential offset command (e.g., a differential Koffset MAC CE), e.g., in response to receiving the differential Koffset MAC CE indicating the differential offset. For example, the wireless device may apply/implement the differential Koffset MAC CE in/during/on the second occasion. The second occasion may be an application time/occasion of the differential Koffset MAC CE. By applying the differential offset, the wireless device may determine a UE-specific Koffset/offset (KUE,offset) based on the indicated differential offset.

The wireless device may determine a CSI reference resource corresponding to (or of) the CSI report (e.g., for determining whether to transmit the CSI report and/or CSI value of the CSI report). As shown the wireless device may determine a CSI-RS (resource) being received (from the base station, e.g., via the serving cell of the NTN0 in a third occasion (slot/symbol) before the (determined) CSI reference resource of the CSI report. The CSI-RS may be a most recent/latest CSI-RS transmission/reception, among the one or more CSI-RS resources, that is no later than the CSI-RS reference resource of the CSI report. For example, the third occasion may correspond to a most recent CSI-RS transmission/reception occasion, of the one or more CSI-RS transmission/reception occasion, that is no later than the CSI-RS reference resource of the CSI report. As shown in FIG. 25A, FIG. 25B, FIG. 26A, and FIG. 26B, the wireless device may transmit the CSI report based on the CSI-RS received in the third occasion.

In an example embodiment, as shown in FIG. 25A and/or FIG. 26A, in response to the first occasion being no later than (or being before/prior to) the second occasion (e.g., the application occasion of the differential offset being after or later than the receiving occasion of the DCI), the wireless device may determine the CSI reference resource only based on the cell-specific offset. For example, in response to the first occasion being no later than (or being before/prior to) the second occasion (e.g., the application occasion of the differential offset being after or later than the receiving occasion of the DCI), the wireless device may determine the CSI reference resource not based on the UE-specific offset (or not based on the differential offset).

In an example embodiment, as shown in FIG. 25B and/or FIG. 26B, in response to the first occasion being after or later than (or not being no later than/before/prior to) the second occasion (e.g., the application occasion of the differential offset being before/prior to/no later than the receiving occasion of the DCI), the wireless device may determine the CSI reference resource based on the differential offset. For example, in response to the first occasion being after or later than (or not being no later than/before/prior to) the second occasion (e.g., the application occasion of the differential offset being before/prior to/no later than the receiving occasion of the DCI), the wireless device may determine the CSI reference resource based on the UE-specific offset and the cell-specific offset (e.g., Kcell,offset-KUE,offset).

For example, based on a most recent/latest CSI-RS transmission/reception, among the one or more CSI-RS resources, being after/later than the CSI-RS reference resource of the CSI report (e.g., the third occasion being later than the CSI-RS reference resource of the CSI report), the wireless device may drop the CSI report (e.g., avoid/skip/omit transmitting the CSI report or not transmit the CSI report).

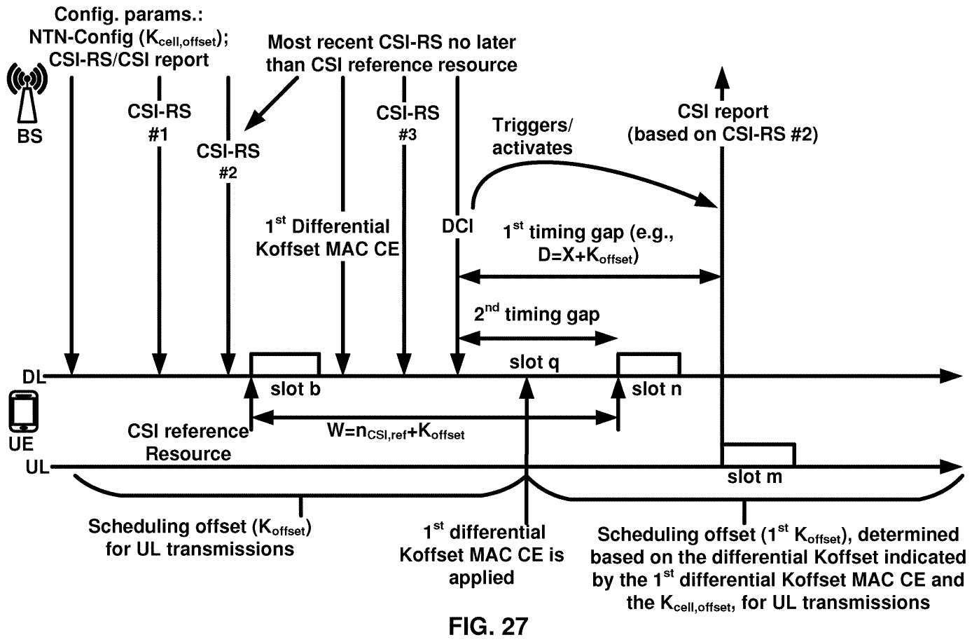

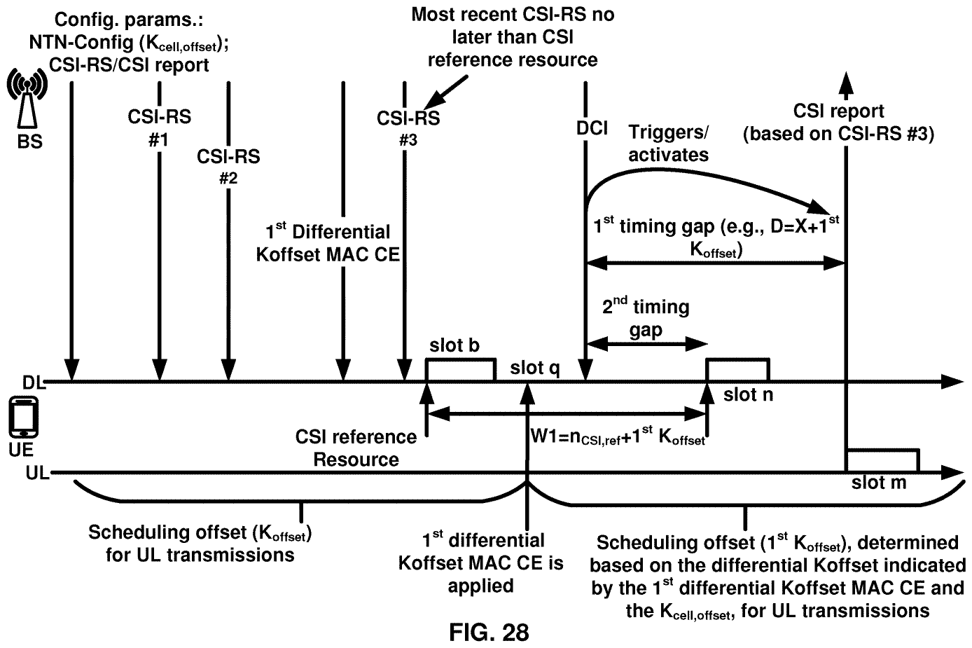

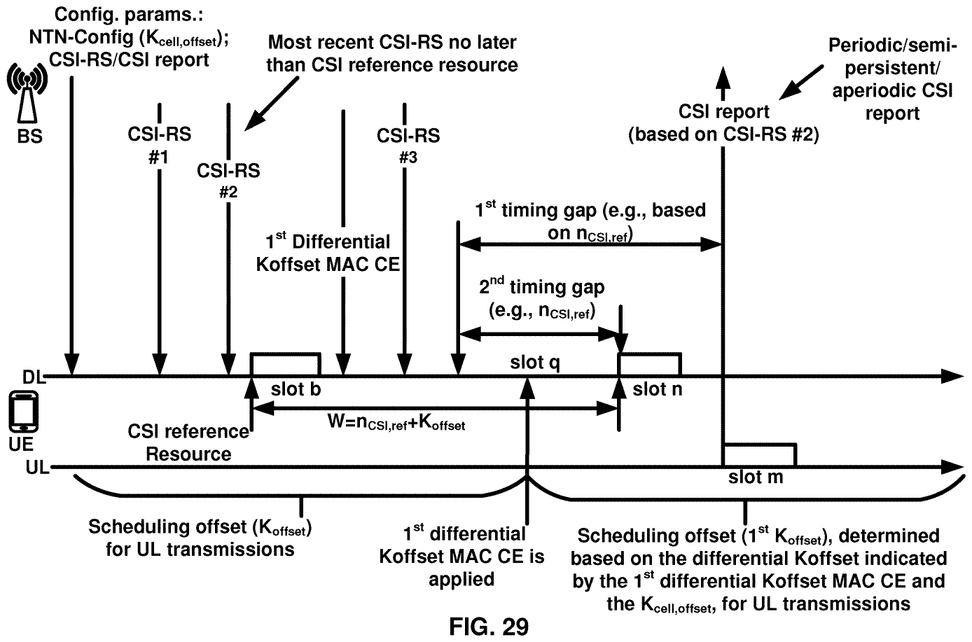

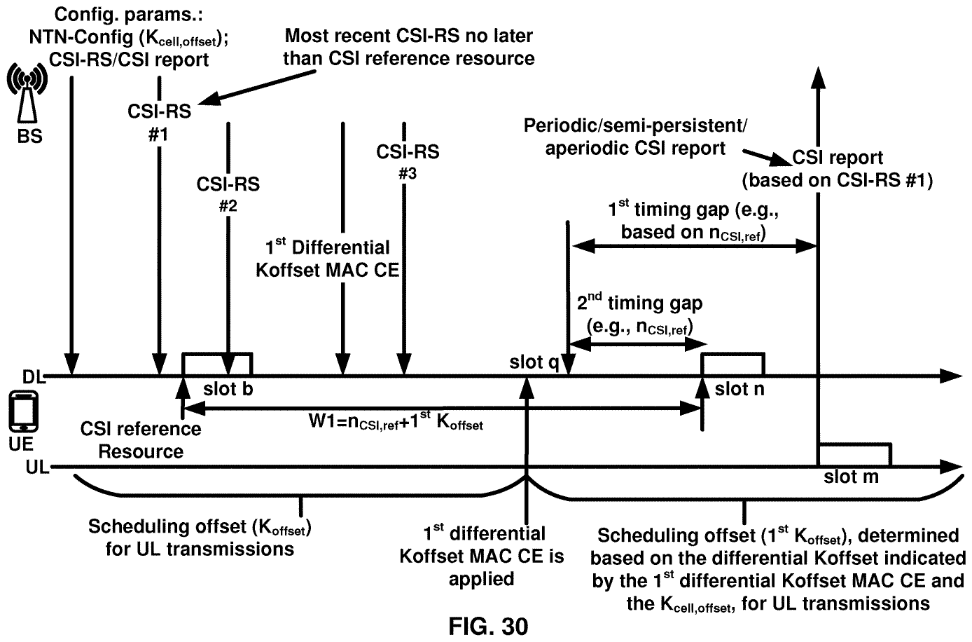

FIGS. 27-30 show examples of CSI reporting in an NTN scenario per an aspect of the present embodiment. Embodiments of FIGS. 27-30 may provide examples of a procedure at the wireless device for determining whether to transmit a CSI report or not and/or a CSI value of the CSI report, e.g., in response to applying/receiving a differential offset (from a base station). Embodiments of FIGS. 27-30 may provide examples of a procedure for determining applicable UE-specific offset (e.g., KUE, offset) for determining/obtaining a CSI reference resource corresponding to the CSI report, e.g., in response to applying/receiving a differential offset (from a base station). Based on embodiments of FIGS. 27-30, in response to applying/receiving a differential offset, the wireless device may be able to properly determine/identify the CSI reference resource (and therefore the CSI value of the CSI report) and/or properly determine whether to drop or transmit the CSI report.

As shown in FIGS. 27-30, the wireless device may receive the one or more configuration parameters from the base station (e.g., via the serving cell of the NTN). The one or more configuration parameters comprise the NTN-config (of the serving cell), e.g., the cell-specific offset. The one or more configuration parameters may comprise the one or more CSI configuration parameters, e.g., for receiving the one or more CSI-RS resources (e.g., periodic or semi-persistent or aperiodic) at/during/on the one or more CSI-RS transmission/reception occasions (e.g., CSI-RS #1, CSI-RS #2, and/or CSI-RS #3). As shown in FIGS. 27-30, the base station may, during/on/at/in the one or more CSI-RS transmission/reception occasions, transmit to the wireless device the one or more CSI-RS (resources), e.g., CSI-RS #1 to CSI-RS #3. For example, the base station may transmit (via an NTN node of a serving cell or a serving cell of the NTN) and during/using the one or more CSI-RS transmission/reception occasions (e.g., slots/subframes/symbols), the one or more CSI-RS resources (e.g., activated CSI-RS resources), e.g., based on CSI-RS resource setting of the one or more CSI-RS resources. As shown in FIGS. 27-30, the wireless device may, during the one or more CSI-RS transmission/reception occasions and via the cell of the NTN, receive the one or more CSI-RS (resources), e.g., based on CSI-RS resource setting of the one or more CSI-RS resources. The wireless device may, using/based on the received/measured on or more CSI-RS resources and the one or more CSI configuration parameters (e.g., CSI-reportConfig), prepare/determine (or obtain or derive or calculate or compute) a CSI report (e.g., periodic/semi-persistent/aperiodic) for transmitting the CSI report, via the cell of the NTN and during/on/at/in an UL slot m, to the base station. The wireless device may, via the cell of the NTN, transmit the CSI report (during/on the uplink slot m), e.g., based on the received/measured one or more CSI-RS (resources) during/in the one or more CSI-RS transmission/reception occasions. For example, the one or more CSI-RS transmission/reception occasions may comprise a second occasion (or slot or symbol) for receiving a CSI-RS resource of the one or more CSI-RS resources. The second occasion may be a transmission/reception occasion of CSI-RS #1 or CSI-RS #2, or CSI-RS #3.

As shown in FIGS. 27-30, for UL transmissions (e.g., PUSCH/PUCCH), prior to a slot q (e.g., a third occasion/slot), the wireless device may use a scheduling offset Koffset. The wireless device may determine the scheduling offset based on the cell-specific offset (Kcell,offset) indicated/configured by the NTN assistance information and/or a UE-specific offset (e.g., KUE,offset), e.g., indicated/applied prior to/before/no later than the third occasion.

When there is no differential offset being indicated to the wireless device (e.g., when no differential Koffset MAC CE indicating the differential offset being received, e.g., KUE, offset=0), e.g., prior to/before/no later than the third occasion, the wireless device may determine the scheduling offset (only) based on the cell-specific offset (Kcell,offset), e.g., Koffset=Kcell,offset.

When at least one differential offset being indicated to the wireless device (e.g., when at least one differential Koffset MAC CE being received, e.g., KUE,offset>0), e.g., prior to/before/no later than the third occasion, the wireless device may determine the scheduling offset based on (both) the cell-specific offset (Kcell,offset) and the at least one differential offset indicated by the at least one differential Koffset MAC CE, e.g., Koffset=Kcell, offset−KUE,offset.

As shown in FIGS. 27-30, the third occasion (e.g., the slot q) corresponds to a slot/occasion/symbol for applying a first differential offset (a first differential Koffset). For example, the wireless device may receive, via the serving cell of the NTN, a first differential Koffset command (or a first differential offset command, e.g., a differential Koffset MAC CE indicating the first differential offset). The wireless device may apply the indicated first differential offset at/in/during the third occasion (as also discussed in FIG. 19C above). The wireless device may determine a first UE-specific offset (or a first UE-specific Koffset), e.g., first KUE, offset, based on (or equal to) the first differential offset. For example, in/on/during (or at) the third occasion the wireless device may determine the scheduling offset being changed/modified/updated (e.g., in response to applying the first differential offset) from the Koffset to a first Koffset. The wireless device may determine the first Koffset (a first scheduling offset) based on (both) the cell-specific offset (Kcell,offset) and the first differential offset, e.g., the first Koffset=Kcell,offset−(the first KUE, offset). After/in response to/based on applying the first differential offset during/in/on the third occasion, the wireless device may use the first Koffset for transmission of UL signals/channels (e.g., the CSI report in/on the UL slot m). The third occasion may be a first/earliest/initial symbol of the slot q. The third occasion may, for example, be a last/final/ending/latest symbol of the slot q.

In the examples of FIG. 27 and FIG. 28, the CSI report may be an aperiodic (or a semi-persistent) CSI report, e.g., triggered/indicated/scheduled (or activated) based on/by/in response to a DCI received in a first occasion (or/slot). The DCI may rigger/indicate/schedule (or activate) transmission of the CSI report. The base station may, via the serving cell of the NTN, transmit the DCI (to the wireless device) for triggering/indicating/scheduling (or activating) the CSI report. The wireless device may receive/detect the DCI in a PDCCH monitoring occasion. The DCI may have a field for triggering/indicating/scheduling (or activating) the CSI report. The DCI may further trigger/activate receiving CSI-RS resources of the one or more CSI-RS resources, within/during/in/at the second occasion of the one or more CSI-RS transmission/reception occasions. For example, the DCI may trigger/indicate CSI-RS #1 or CSI-RS #2 or CSI-RS #3. The first occasion may be a last/ending/final symbol of the PDCCH monitoring occasion comprising/carrying (or providing) the DCI. The first occasion may be a last/ending/final symbol of a PDCCH monitoring occasion that the wireless device detects the DCI. In the examples of FIG. 29 and FIG. 30, the CSI report may be a semi-persistent or periodic CSI report (although FIG. 29 and FIG. 30 shows only one CSI report).

For example, the UL slot m (e.g., the first UL/uplink slot) may be a first timing gap (or distance or window or duration) after the first occasion (or the first occasion may be the first timing gap before/prior to the first uplink slot). The wireless device may determine the UL slot m based on the DCI triggering/scheduling/activating the CSI report (e.g., the aperiodic/semi-persistent CSI report). The wireless device may determine the UL slot m based on the one or more CSI configuration parameters (e.g., the CSI-ReportConfig).

The wireless device may use (or consider) the first timing gap to determine whether the indicated first differential offset is applicable (or usable) for determining a CSI reference resource (corresponding to the CSI report) or not. For example, the wireless device may use (consider) the first timing gap to determine whether or not to use the indicated first differential offset for determining the CSI reference resource (corresponding to the CSI report). The first timing gap may provide a timing relationship between the third occasion (corresponding to the application time/occasion of the first differential offset) and the first occasion. The first timing gap may indicate whether the first differential offset being applied prior to/before/no later than the first occasion or not. For example, when the transmitting the CSI report is triggered/indicated/configured/scheduled by the DCI, the wireless device may use the first timing gap to determine the timing relationship between the third occasion (corresponding to the application time/occasion of the first differential offset) and the first occasion.

In examples of FIG. 27 and FIG. 29, the wireless device may determine that within/during the first timing gap prior to the first uplink slot (or the first timing gap after the third occasion) the scheduling offset is changed/modified/updated (Scenario 1), e.g., the timing distance/difference between the third occasion and the UL slot m (the first UL slot) is less than the first timing gap. Corresponding to Scenario 1, the wireless device may determine that within/during the first timing gap prior to the first uplink slot (or within/during the first timing gap after the third occasion) the first differential offset is indicated/applied.

In an example embodiment, in response to determining that within/during the first timing gap prior to the first uplink slot (or within/during the first timing gap after the third occasion) the first differential offset is indicated/applied (Scenario 1), the wireless device may determine that the CSI reference resource (corresponding to the CSI report) is not based on the first differential offset (or the first Koffset), e.g., the first differential offset is not applicable/usable for determining the CSI reference resource. For example, in response to determining that within/during the first timing gap prior to the first uplink slot (or within/during the first timing gap after the third occasion) the first differential offset is indicated/applied (Scenario 1), the wireless device may determine (or calculate or measure or derive) the CSI reference resource (corresponding to the CSI report) based on the scheduling offset (Koffset), e.g., the first differential offset is not applicable/usable for determining the CSI reference resource.

In examples of FIG. 28 and FIG. 30, the wireless device may determine before/prior to the first timing gap prior to the first uplink slot the scheduling offset being changed/modified/updated (Scenario 2), e.g., the timing distance/difference between the third occasion and the UL slot m (the first UL slot) is greater/larger than (or no smaller than) the first timing gap. Corresponding to Scenario 2, the wireless device may determine not within/during the first timing gap prior to the first uplink slot (or within/during the first timing gap after the third occasion) the first differential offset being indicated/applied, e.g., before or prior to the first timing gap prior to the first uplink slot (or within/during the first timing gap after the third occasion) the first differential offset being indicated/applied.

In an example embodiment, in response to determining that before (or no later than or prior to) the first timing gap prior to/before the first uplink slot (or not after the first timing gap after the third occasion) the first differential offset is indicated/applied (Scenario 2), the wireless device may determine the CSI reference resource (corresponding to the CSI report) based on the first differential offset (or the first Koffset), e.g., the first differential offset is applicable/usable for determining the CSI reference resource. For example, in response to determining that before (or no later than or prior to) the first timing gap prior to/before the first uplink slot (or not after the first timing gap after the third occasion) the first differential offset is indicated/applied (Scenario 2), the wireless device may determine that the CSI reference resource (corresponding to the CSI report) is not based on the scheduling offset (e.g., Koffset), e.g., the first differential offset is applicable/usable for determining the CSI reference resource.

A DL slot n (e.g., a fourth occasion/slot) may be a second timing gap (or distance or window or duration) after the first occasion. For example, the first occasion may be the second timing gap prior to/before the fourth occasion. The fourth occasion may be a first/earliest/initial/staring symbol of the DL slot n. The fourth occasion may, for example, be a last/final/ending/latest symbol of the DL slot n. In some implementations, the DL slot n (e.g., the fourth occasion) may be a virtual (or a pre-determined or auxiliary or assistant) DL slot corresponding to the CSI report. For example, the fourth occasion may be the second DL slot corresponding to the first UL slot, e.g., the downlink slot n (e.g., the second DL slot) may be determined (by the wireless device) based on the first uplink slot and/or one or more numerologies. The wireless device may determine the second DL slot n as

$$n = ⌊ m \frac{{μ}_{DL}}{{μ}_{UL}} ⌋ + Δ$$

where μ_{UL} is the SCS of the UL configuration, μ_{DL} is the SCS of the DL configuration, and Δ may depend on CA configuration (configured by the one or more configuration parameters).

The wireless device may use (or consider) the second timing gap (or the fourth occasion) to determine whether the indicated first differential offset is applicable (or usable) for determining the CSI reference resource (corresponding to the CSI report) or not. For example, the wireless device may use (consider) the second timing gap (or the fourth occasion) to determine whether or not to use the indicated first differential offset for determining the CSI reference resource (corresponding to the CSI report). The second timing gap (or the fourth occasion) may provide a timing relationship between the third occasion (corresponding to the application time/occasion of the first differential offset) and the first occasion. The second timing gap may indicate whether the first differential offset being applied prior to/before/no later than the first occasion or not. For example, when the transmitting the CSI report is triggered/indicated/configured/scheduled by the DCI, the wireless device may use the second timing gap (or the fourth occasion) to determine the timing relationship between the third occasion (corresponding to the application time/occasion of the first differential offset) and the first occasion.

In examples of FIG. 27 and FIG. 29, the wireless device may determine within/during the second timing gap prior to the fourth occasion (or the second timing gap after the third occasion) the scheduling offset being changed/modified/updated (Scenario 1), e.g., the timing distance/difference between the third occasion and the fourth occasion is less than the second timing gap. Corresponding to Scenario 1, the wireless device may determine within/during the second timing gap prior to the fourth occasion (or within/during the second timing gap after the third occasion) the first differential offset being indicated/applied.

In an example embodiment, in response to determining that within/during the second timing gap prior to the fourth occasion (or within/during the second timing gap after the third occasion) the first differential offset is indicated/applied (Scenario 1), the wireless device may determine that the CSI reference resource (corresponding to the CSI report) is not based on the first differential offset (or the first Koffset), e.g., the first differential offset is not applicable/usable for determining the CSI reference resource. For example, in response to determining that within/during the second timing gap prior to the fourth occasion (or within/during the first timing gap after the third occasion) the first differential offset is indicated/applied (Scenario 1), the wireless device may determine the CSI reference resource (corresponding to the CSI report) based on the scheduling offset (Koffset), e.g., the first differential offset is not applicable/usable for determining the CSI reference resource.

In examples of FIG. 28 and FIG. 30, the wireless device may determine that before/prior to the second timing gap prior to/before the first uplink slot the scheduling offset is changed/modified/updated (Scenario 2), e.g., the timing distance/difference between the third occasion and the fourth occasion is greater/larger than (or no smaller than) the second timing gap. Corresponding to Scenario 2, the wireless device may determine that not within/during the second timing gap prior to/before the fourth occasion (or within/during the second timing gap after the third occasion) the first differential offset being indicated/applied, e.g., before or prior to the second timing gap prior to the first uplink slot (or within/during the first timing gap after the third occasion) the first differential offset being indicated/applied.

In an example embodiment, in response to determining that before (or no later than or prior to) the second timing gap prior to/before the fourth occasion (or not after the second timing gap after the third occasion) the first differential offset being indicated/applied (Scenario 2), the wireless device may determine the CSI reference resource (corresponding to the CSI report) based on the first differential offset (or the first Koffset). For example, in response to determining that before (or no later than or prior to) the second timing gap prior to/before the fourth occasion (or not after the first timing gap after the third occasion) the first differential offset being indicated/applied (Scenario 2), the wireless device may determine that the CSI reference resource (corresponding to the CSI report) is not based on the scheduling offset (e.g., Koffset).

The first timing gap (and/or the second timing gap) may be predetermined. In some cases, the first timing gap (and/or the second timing gap) may be preconfigured. For example, the one or more configuration parameters may indicate/configure the first timing gap (and/or the second timing gap). The first timing gap (and/or the second timing gap) may be based on n_{CSI,ref} (e.g., the CSI reference gap/offset), e.g., corresponding to the CSI report. The wireless device may determine the first timing gap (and/or the second timing gap) may be based on n_{CSI,ref} (e.g., the CSI reference gap/offset) and

$$⌊ m \frac{{μ}_{DL}}{{μ}_{UL}} ⌋ + Δ .$$

For example, the first timing gap (and/or the second timing gap) may be

$${n}_{CSI , ref} + ⌊ m \frac{{μ}_{DL}}{{μ}_{UL}} ⌋ + Δ .$$

The first timing gap (and/or the second timing gap) may be based on the scheduling offset (K_{offset}). For example, the wireless device may determine the first timing gap (and/or the second timing gap) may be based on n_{CSI,ref}+K_{offset}.

In some implementations, the wireless device may determine the first timing gap (and/or the second timing gap) based on a time domain behavior of the CSI report (e.g., whether the CSI report is the periodic CSI report or the semi-persistent CSI report or the aperiodic CSI report. In one example, when the time domain behavior of the CSI report is either the semi-persistent CSI report or the periodic CSI report, the wireless device may determine the first timing gap (and/or the second timing gap) based on n_{CSI,ref} (e.g., the CSI reference gap/offset), e.g., corresponding to the CSI report. When the time domain behavior of the CSI report is neither the semi-persistent CSI report nor the periodic CSI report (e.g., when the CSI report is aperiodic CSI report, e.g., triggered/scheduled by the DCI), the wireless device may determine the first timing gap (and/or the second timing gap) based on parameter D (e.g., see FIG. 21), e.g., the aperiodic scheduling offset X. In an example, as shown in FIG. 27, in response to the first occasion being prior to/no later than/before the third occasion, the wireless device may determine the first timing gap (and/or the second timing gap) based on the scheduling offset (e.g., the first timing gap is not based on the first scheduling offset or the first differential offset). As shown in FIG. 27, in response to the first occasion being after the third occasion, the wireless device may determine the first timing gap (and/or the second timing gap) based on the scheduling offset (e.g., the first timing gap is not based on the first scheduling offset or the first differential offset).

In other implementations, the wireless device may determine the second timing gap based on the first timing gap. For example, the second timing gap may be a subtraction of

$$⌊ m \frac{{μ}_{DL}}{{μ}_{UL}} ⌋ + Δ$$

from the first timing gap. In other examples, as also shown in FIGS. 27-30, the wireless device may determine the second timing gap based on the first timing gap and the fourth occasion (e.g., the DL slot n).

In examples of FIG. 27 and FIG. 29, corresponding to Scenario 1, the wireless device determines the CSI reference resource (e.g., slot b) based on the scheduling offset (K_{offset}). As shown, the slot b (e.g., the CSI reference resource) may be W ms/slots/symbols prior to/before the fourth occasion (e.g., the DL slot n). For example, a first/earliest/starting/initial symbol of the slot b (e.g., the CSI reference resource) may be W ms/slots/symbols prior to/before (a first/earliest/starting/initial symbol of or a final/ending/latest symbol of) the fourth occasion. The wireless device may determine parameter W based on the scheduling offset and n_{CSI,ref} (e.g., the CSI reference gap/offset). In another example, a final/ending/latest symbol of the slot b (e.g., the CSI reference resource) may be W ms/slots/symbols prior to/before (a first/earliest/starting/initial symbol of or a final/ending/latest symbol of) the fourth occasion. The wireless device may determine (measure or calculate or derive or obtain) value of the CSI report based on the CSI-RS #2 of the one or more CSI-RS transmission/reception occasions, e.g., the second occasion the transmission/reception occasion of CSI-RS #2. For example, the wireless device may determine CSI-RS #2 of the one or more CSI-RS transmission/reception occasions is the latest (most recent) CSI-RS transmission/occasion that is no later than the (determined) CSI reference resource. Based on the most recent measurement/reception of a CSI-RS resource of the one or more CSI resources (among/of the one or more CSI-RS transmission/reception occasions), e.g., CSI-RS #2, being no later than (or being prior to/before) the CSI reference resource (corresponding to the CSI report), the wireless device may determine (or obtain or calculate or derive or compute) the CSI report and/or transmit the CSI report. The wireless device may, during/in/at/on the UL slot m, transmit/send/report the CSI report (via the serving cell of the NTN) to the base station. Based on the most recent measurement/reception of a CSI-RS resource of the one or more CSI resources (among/of the one or more CSI-RS transmission/reception occasions) being later than (or being after) the CSI reference resource (corresponding to the CSI report), the wireless device may drop the CSI report (not transmit the CSI report).

In examples of FIG. 28 and FIG. 30, corresponding to Scenario 2, the wireless device determines the CSI reference resource (e.g., slot b) based on the first scheduling offset (the first Koffset), e.g., the first differential offset. As shown, the slot b (e.g., the CSI reference resource) may be W1 ms/slots/symbols prior to/before the fourth occasion (e.g., the DL slot n). For example, a first/earliest/starting/initial symbol of the slot b (e.g., the CSI reference resource) may be W1 ms/slots/symbols prior to/before (a first/earliest/starting/initial symbol of or a final/ending/latest symbol of) the fourth occasion. The wireless device may determine parameter W1 based on the first scheduling offset, e.g., the first differential offset, and n_{CSI,ref} (e.g., the CSI reference gap/offset). In another example, a final/ending/latest symbol of the slot b (e.g., the CSI reference resource) may be W1 ms/slots/symbols prior to/before (a first/earliest/starting/initial symbol of or a final/ending/latest symbol of) the fourth occasion.

In the example of FIG. 28, the wireless device may determine (measure or calculate or derive or obtain) value of the CSI report based on the CSI-RS #3 of the one or more CSI-RS transmission/reception occasions, e.g., the second occasion the transmission/reception occasion of CSI-RS #3. For example, the wireless device may determine CSI-RS #3 of the one or more CSI-RS transmission/reception occasions is the latest (most recent) CSI-RS transmission/occasion that is no later than the (determined) CSI reference resource. Based on the most recent measurement/reception of a CSI-RS resource of the one or more CSI resources (among/of the one or more CSI-RS transmission/reception occasions), e.g., CSI-RS #3, being no later than (or being prior to/before) the CSI reference resource (corresponding to the CSI report), the wireless device may determine (or obtain or calculate or derive or compute) the CSI report and/or transmit the CSI report. The wireless device may, during/in/at/on the UL slot m, transmit/send/report the CSI report (via the serving cell of the NTN) to the base station. Based on the most recent measurement/reception of a CSI-RS resource of the one or more CSI resources (among/of the one or more CSI-RS transmission/reception occasions) being later than (or being after) the CSI reference resource (corresponding to the CSI report), the wireless device may drop the CSI report (not transmit the CSI report).

In the example of FIG. 30, the wireless device may determine (measure or calculate or derive or obtain) value of the CSI report based on the CSI-RS #1 of the one or more CSI-RS transmission/reception occasions, e.g., the second occasion the transmission/reception occasion of CSI-RS #1. For example, the wireless device may determine CSI-RS #1 of the one or more CSI-RS transmission/reception occasions is the latest (most recent) CSI-RS transmission/occasion that is no later than the (determined) CSI reference resource. Based on the most recent measurement/reception of a CSI-RS resource of the one or more CSI resources (among/of the one or more CSI-RS transmission/reception occasions), e.g., CSI-RS #1, being no later than (or being prior to/before) the CSI reference resource (corresponding to the CSI report), the wireless device may determine (or obtain or calculate or derive or compute) the CSI report and/or transmit the CSI report. The wireless device may, during/in/at/on the UL slot m, transmit/send/report the CSI report (via the serving cell of the NTN) to the base station. Based on the most recent measurement/reception of a CSI-RS resource of the one or more CSI resources (among/of the one or more CSI-RS transmission/reception occasions) being later than (or being after) the CSI reference resource (corresponding to the CSI report), the wireless device may drop the CSI report (not transmit the CSI report).

Although not shown in FIGS. 27-30, when there is no valid downlink slot for the CSI reference resource corresponding to the CSI report setting in the serving cell (e.g., when the first DL slot is not a valid downlink slot), the wireless device may omit/avoid/skip transmitting the CSI report, e.g., drop or refrain from transmitting the CSI report, for the serving cell in/during/on the first UL slot.

For example, if the higher layer parameter timeRestrictionForChannelMeasurements (e.g., to enable/configure/indicate a time domain restriction/behavior for channel measurements) in CSI-ReportConfig is set to “notConfigured”, the wireless device may derive/obtain/determine channel measurements for computing L1-RSRP value of the CSI report in the first UL slot based on only the SS/PBCH or NZP CSI-RS (among/of the one or more CSI-RS transmission/reception occasions), associated with the CSI resource setting, no later than the CSI reference resource of the CSI report. If the higher layer parameter timeRestrictionForChannelMeasurements in CSI-ReportConfig is set to “Configured”, the wireless device may derive/obtain/determine the channel measurements for computing L1-RSRP of the CSI report based on only a most recent, no later than the CSI reference resource of the CSI report, occasion of SS/PBCH or NZP CSI-RS (among/of the one or more CSI-RS transmission/reception occasions) associated with the CSI resource setting. If the higher layer parameter timeRestrictionForChannelMeasurements is set to “notConfigured”, the wireless device may derive/obtain/determine the channel measurements for computing CSI value of the CSI report based on only the NZP CSI-RS (among/of the one or more CSI-RS transmission/reception occasions), no later than the CSI reference resource of the CSI report, associated with the CSI resource setting. If the higher layer parameter timeRestrictionForChannelMeasurements in CSI-ReportConfig is set to “Configured”, the wireless device may derive/obtain/determine the channel measurements for computing/obtaining CSI reported in/of the CSI report in the uplink slot m based on only the most recent, no later than the CSI reference resource of the CSI report, reception/measurement occasion (among/of the one or more CSI-RS transmission/reception occasions) of NZP CSI-RS associated with the CSI resource setting. If the higher layer parameter timeRestrictionForInterferenceMeasurements (e.g., to enable/configure/indicate a time domain restriction/behavior for interference measurements) is set to “notConfigured”, the wireless device may derive/obtain/determine the interference measurements for computing CSI value reported in the CSI report in the uplink slot m based on only the CSI-IM and/or NZP CSI-RS for interference measurement (among/of the one or more CSI-RS transmission/reception occasions) no later than the CSI reference resource associated with the CSI resource setting. If the higher layer parameter timeRestrictionForInterferenceMeasurements in CSI-ReportConfig is set to “Configured”, the wireless device may derive/obtain/determine the interference measurements for computing the CSI value reported in the CSI report in the uplink slot m based on the most recent, no later than the CSI reference resource of the CSI report, occasion of CSI-IM and/or NZP CSI-RS for interference measurement (among/of the one or more CSI-RS transmission/reception occasions) associated with the CSI resource setting.

In an NTN scenario, when the scheduling offset is changed/updated (e.g., due to receiving/applying a differential offset), some embodiments of the present disclosure allow the wireless device to correctly determine value of the CSI report, e.g., reduce misalignment between the wireless device and/or the base station or improve UL/DL spectral efficiency. For example, the wireless device may identify/determine the CSI reference resource of the CSI report based on whether the indicated first differential offset is applicable or not.

In an NTN scenario, when the scheduling offset is changed/updated (e.g., due to receiving/applying a differential offset), some embodiments of the present disclosure allow the wireless device to correctly determine whether to transmit or drop the CSI report.

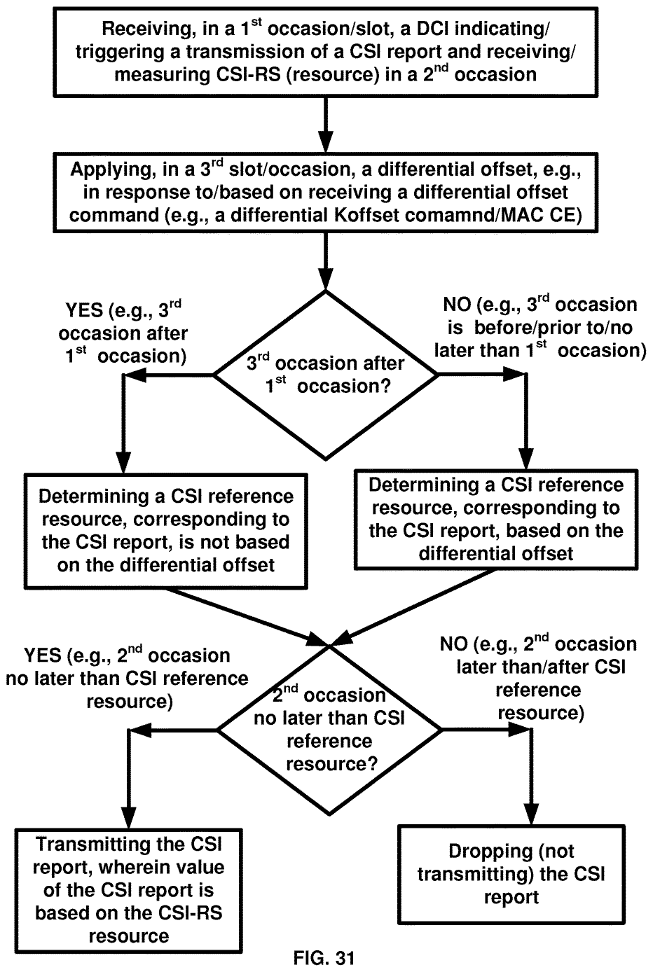

FIG. 31 illustrates an example flowchart of a procedure for CSI report in an NTN as per an aspect of an embodiment of the present disclosure. The wireless device may receive, via a serving cell of the NTN and during/in/on/at a first occasion (or a first slot), a DCI indicating/triggering/scheduling/activating a transmission of a CSI report (in/during/on/at a first UL slot, e.g., UL slot m). The wireless device may receive, via the serving cell of the NTN and during the one or more CSI-RS transmission/reception occasions (e.g., comprising a second occasion), the one or more CSI-RS resources. For example, the wireless device may measure/receive, during/in/on/at the second occasion a CSI-RS (resource) of the one or more CSI-RS resources.

As shown in FIG. 31, the wireless device may, e.g., in response to receiving a differential offset (e.g., a differential Koffset MAC CE indicating the differential offset/Koffset), apply (or implement) the differential offset during/in/at a third occasion (e.g., slot q). For example, during/in/at the third occasion (e.g., slot q), the wireless device may determine a scheduling offset (of the NTN) being changed/updated/modified from Koffset to a first Koffset (determined based on the indicated/applied differential offset). Koffset is not based on the indicated differential offset. In an example embodiment, for determining whether to transmit or drop a CSI report (or for determining a CSI value of the CSI report) and/or for determining a CSI reference report corresponding to the CSI report and/or for determining whether the indicated differential offset is usable/applicable for determining the CSI reference report corresponding to the CSI report, the wireless device may determine whether the third occasion is before/prior to (or no later than) the first occasion or not.

In response to the third occasion being before/prior to (or no later than) the first occasion, the wireless device may determine the indicated differential offset being usable/applicable for determining the CSI reference report corresponding to the CSI report (e.g., the wireless device determines the CSI reference report corresponding to the CSI report based on the indicated differential offset). In response to the third occasion not being before/prior to (or no later than) the first occasion (e.g., the third occasion being after the first occasion), the wireless device may determine the indicated differential offset not being usable/applicable (or being inapplicable/unusable) for determining the CSI reference report corresponding to the CSI report (e.g., the wireless device determines the CSI reference report corresponding to the CSI report not based on the indicated differential offset or based on the Koffset).

As shown in FIG. 31, for the determined CSI reference resource, the wireless device may determine whether the second occasion being no later than (or before or prior to) the CSI reference resource or not. In response to the second occasion being no later than (or before or prior to) the CSI reference resource, the wireless device may, via the serving cell of the NTN and during/in/on/at the UL slot m, transmit the CSI report based on the measured/received CSI-RS (resource) of the one or more CSI-RS resources during/in/on/at the second occasion. The measured/received CSI-RS (resource) of the one or more CSI-RS resources during/in/on/at the second occasion may be latest/most recent CSI-RS (resource) of the one or more CSI-RS resources no later than the determined CSI reference resource. In response to the second occasion not being no later than (or not being before or prior to), e.g., being later than or after, the CSI reference resource, the wireless device may drop/omit/skip/avoid/ignore (transmitting) the CSI report, e.g., not transmit or refrain from transmitting the CSI report in/on/at the UL slot m.

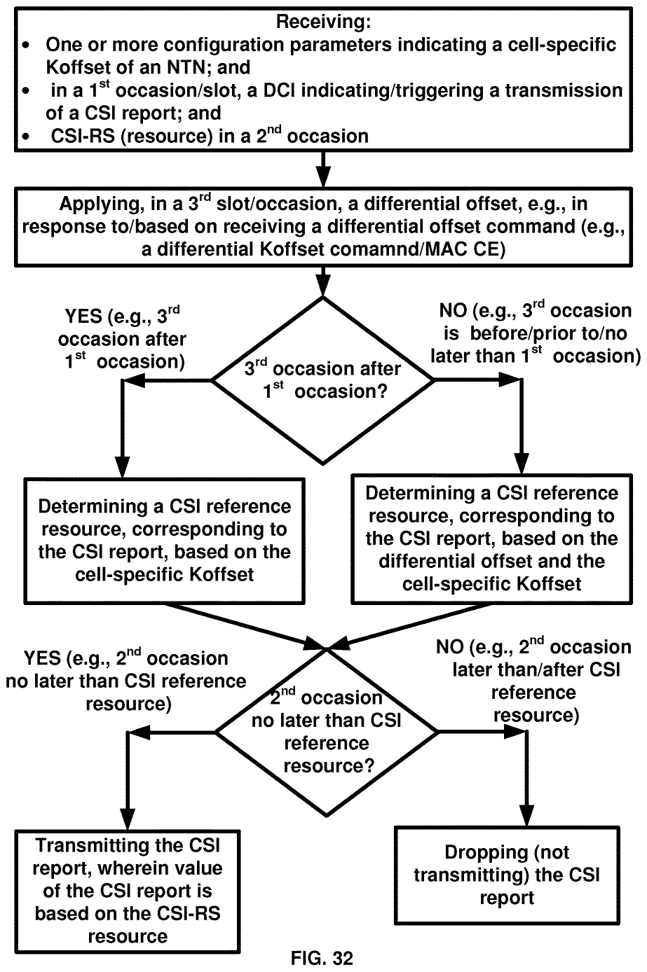

FIG. 32 illustrates an example flowchart of a procedure for CSI report in an NTN as per an aspect of an embodiment of the present disclosure. The wireless device may receive, via a serving cell, the one or more configuration parameters comprising the NTN assistance information. For example, the one or more configuration parameters may indicate/configure the cell-specific Koffset/offset of the NTN. The wireless device may receive, via the serving cell of the NTN and during/in/on/at a first occasion (or a first slot), a DCI indicating/triggering/scheduling/activating a transmission of a CSI report (in/during/on/at a first UL slot, e.g., UL slot m). The wireless device may receive, via the serving cell of the NTN and during the one or more CSI-RS transmission/reception occasions (e.g., comprising a second occasion), the one or more CSI-RS resources. For example, the wireless device may measure/receive, during/in/on/at the second occasion a CSI-RS (resource) of the one or more CSI-RS resources.

As shown in FIG. 32, the wireless device may, e.g., in response to receiving a differential offset (e.g., a differential Koffset MAC CE indicating the differential offset/Koffset), apply (or implement) the differential offset during/in/at a third occasion (e.g., slot q). For example, during/in/at the third occasion (e.g., slot q), the wireless device may determine a scheduling offset (of the NTN) being changed/updated/modified from Koffset (e.g., the cell-specific offset) to a first Koffset (determined based on the indicated/applied differential offset and the cell-specific offset). Koffset is not based on the indicated differential offset. In an example embodiment, for determining whether to transmit or drop a CSI report (or for determining a CSI value of the CSI report) and/or for determining a CSI reference report corresponding to the CSI report and/or for determining whether the indicated differential offset is usable/applicable for determining the CSI reference report corresponding to the CSI report, the wireless device may determine whether the third occasion is before/prior to (or no later than) the first occasion or not.

In response to the third occasion being before/prior to (or no later than) the first occasion, the wireless device may determine the indicated differential offset being usable/applicable for determining the CSI reference report corresponding to the CSI report (e.g., the wireless device determines the CSI reference report corresponding to the CSI report based on the indicated differential offset and the cell-specific offset). In response to the third occasion not being before/prior to (or no later than) the first occasion (e.g., the third occasion being after the first occasion), the wireless device may determine the indicated differential offset not being usable/applicable (or being inapplicable/unusable) for determining the CSI reference report corresponding to the CSI report (e.g., the wireless device determines the CSI reference report corresponding to the CSI report not based on the indicated differential offset or based on the cell-specific offset).

As shown in FIG. 32, for the determined CSI reference resource, the wireless device may determine whether the second occasion being no later than (or before or prior to) the CSI reference resource or not. In response to the second occasion being no later than (or before or prior to) the CSI reference resource, the wireless device may, via the serving cell of the NTN and during/in/on/at the UL slot m, transmit the CSI report based on the measured/received CSI-RS (resource) of the one or more CSI-RS resources during/in/on/at the second occasion. The measured/received CSI-RS (resource) of the one or more CSI-RS resources during/in/on/at the second occasion may be latest/most recent CSI-RS (resource) of the one or more CSI-RS resources no later than the determined CSI reference resource. In response to the second occasion not being no later than (or not being before or prior to), e.g., being later than or after, the CSI reference resource, the wireless device may drop/omit/skip/avoid/ignore (transmitting) the CSI report, e.g., not transmit or refrain from transmitting the CSI report in/on/at the UL slot m.

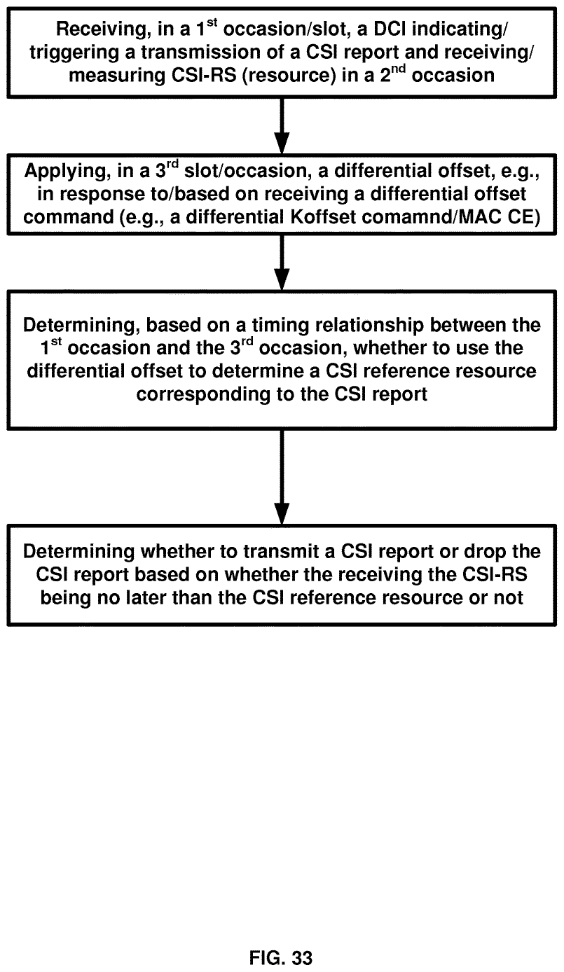

FIG. 33 illustrates an example flowchart of a procedure for CSI report in an NTN as per an aspect of an embodiment of the present disclosure. The wireless device may receive, via a serving cell of the NTN and during/in/on/at a first occasion (or a first slot), a DCI indicating/triggering/scheduling/activating a transmission of a CSI report (in/during/on/at a first UL slot, e.g., UL slot m). The wireless device may receive, via the serving cell of the NTN and during the one or more CSI-RS transmission/reception occasions (e.g., comprising a second occasion), the one or more CSI-RS resources. For example, the wireless device may measure/receive, during/in/on/at the second occasion a CSI-RS (resource) of the one or more CSI-RS resources.

As shown in FIG. 33, the wireless device may, e.g., in response to receiving a differential offset (e.g., a differential Koffset MAC CE indicating the differential offset/Koffset), apply (or implement) the differential offset during/in/at a third occasion (e.g., slot q). For example, during/in/at the third occasion (e.g., slot q), the wireless device may determine a scheduling offset (of the NTN) being changed/updated/modified from Koffset to a first Koffset (determined based on the indicated/applied differential offset). Koffset is not based on the indicated differential offset. In an example embodiment, for determining whether to transmit or drop a CSI report (or for determining a CSI value of the CSI report) and/or for determining a CSI reference report corresponding to the CSI report and/or for determining whether the indicated differential offset is usable/applicable for determining the CSI reference report corresponding to the CSI report, the wireless device may determine a timing relationship between the first occasion and the third occasion. The timing relationship may indicate whether the third occasion is before/prior to (or no later than) the first occasion or not. For example, based on the timing relationship between the first occasion and the third occasion, the wireless device may determine whether to transmit or drop a CSI report (or for determining a CSI value of the CSI report). Based on the timing relationship between the first occasion and the third occasion (e.g., for determining whether to transmit or drop the CSI report), the wireless device may determine whether the CSI reference report corresponding to the CSI report is based on the indicated differential offset or not. For example, to determine whether to transmit or drop the CSI report, the wireless device may determine whether the measured/received CSI-RS (resource), e.g., a latest/most recent CSI-RS resource, of the one or more CSI-RS resources during/in/on/at the second occasion being no later than (or before/prior to) the (determined) CSI reference resource or not. Based on the measured/received CSI-RS (resource), e.g., the latest/most recent CSI-RS resource, of the one or more CSI-RS resources during/in/on/at the second occasion being no later than (or before/prior to) the (determined) CSI reference resource, the wireless device may transmit the CSI report (using the measured/received CSI-RS (resource). Based on the measured/received CSI-RS (resource), e.g., the latest/most recent CSI-RS resource, of the one or more CSI-RS resources during/in/on/at the second occasion being later than (or after) the (determined) CSI reference resource, the wireless device drop (the transmission of) the CSI report.

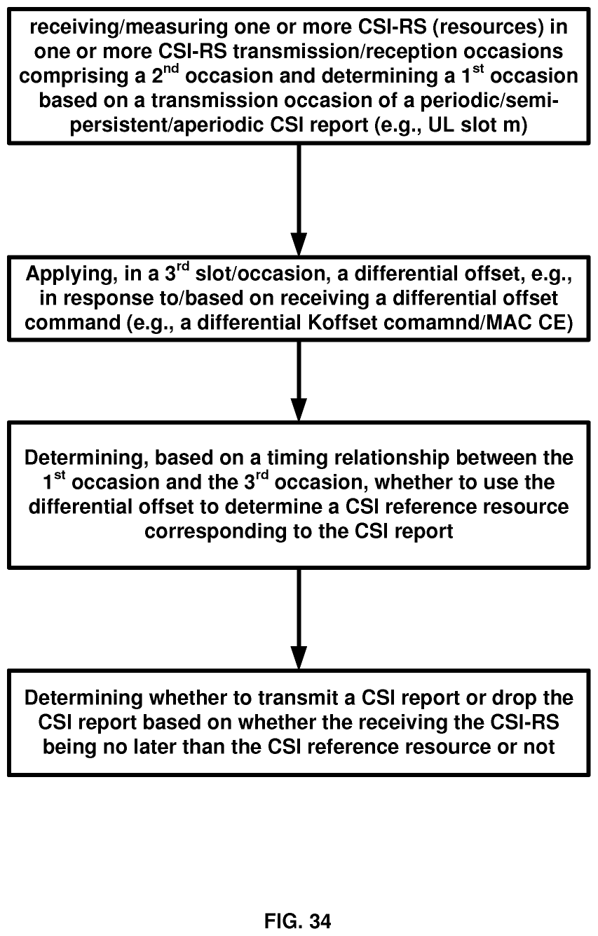

FIG. 34 illustrates an example flowchart of a procedure for CSI report in an NTN as per an aspect of an embodiment of the present disclosure. The wireless device may receive/measure, via a serving cell of the NTN, the one or more CSI-RS resources during/in/on/at the one or more CSI-RS transmission/reception occasions (e.g., comprising a second occasion). For example, the wireless device may measure/receive, during/in/on/at the second occasion a CSI-RS (resource) of the one or more CSI-RS resources. The wireless device may determine a first occasion (or a first slot), based on a transmission of a CSI report (in/during/on/at a first UL slot, e.g., UL slot m). The CSI report may be a periodic CSI report or a semi-persistent CSI report. The first occasion may be based on the CSI reference gap/offset. The first occasion may be the fourth occasion. The first occasion may be based on the DL slot n. The first occasion may be based on the first timing gap and/or the second timing gap.

As shown in FIG. 34, the wireless device may, e.g., in response to receiving a differential offset (e.g., a differential Koffset MAC CE indicating the differential offset/Koffset), apply (or implement) the differential offset during/in/at a third occasion (e.g., slot q). For example, during/in/at the third occasion (e.g., slot q), the wireless device may determine a scheduling offset (of the NTN) being changed/updated/modified from Koffset to a first Koffset (determined based on the indicated/applied differential offset). Koffset is not based on the indicated differential offset. In an example embodiment, for determining whether to transmit or drop a CSI report (or for determining a CSI value of the CSI report) and/or for determining a CSI reference report corresponding to the CSI report and/or for determining whether the indicated differential offset is usable/applicable for determining the CSI reference report corresponding to the CSI report, the wireless device may determine a timing relationship between the first occasion and the third occasion. The timing relationship may indicate whether the third occasion is before/prior to (or no later than) the first occasion or not. For example, based on the timing relationship between the first occasion and the third occasion, the wireless device may determine whether to transmit or drop a CSI report (or for determining a CSI value of the CSI report). Based on the timing relationship between the first occasion and the third occasion (e.g., for determining whether to transmit or drop the CSI report), the wireless device may determine whether the CSI reference report corresponding to the CSI report is based on the indicated differential offset or not. For example, to determine whether to transmit or drop the CSI report, the wireless device may determine whether the measured/received CSI-RS (resource), e.g., a latest/most recent CSI-RS resource, of the one or more CSI-RS resources during/in/on/at the second occasion being no later than (or before/prior to) the (determined) CSI reference resource or not. Based on the measured/received CSI-RS (resource), e.g., the latest/most recent CSI-RS resource, of the one or more CSI-RS resources during/in/on/at the second occasion being no later than (or before/prior to) the (determined) CSI reference resource, the wireless device may transmit the CSI report (using the measured/received CSI-RS (resource)). Based on the measured/received CSI-RS (resource), e.g., the latest/most recent CSI-RS resource, of the one or more CSI-RS resources during/in/on/at the second occasion being later than (or after) the (determined) CSI reference resource, the wireless device drop (the transmission of) the CSI report

In a time domain, a CSI reference resource for a CSI reporting/report in an uplink slot m (the first UL slot) is defined by a single downlink slot

$$b = n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer (e.g., the cell-specific Koffset and/or the UE-specific Koffset), and where μ_{K}_{_{offset}} is the subcarrier spacing configuration for K_{offset} with a value of 0 for frequency range 1, where

$$n = ⌊ m \frac{{μ}_{DL}}{{μ}_{UL}} ⌋ + Δ and Δ = ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋$$

and μ_{DL} and μ_{UL} are the subcarrier spacing configurations for DL and UL, respectively, and

$${N}_{slot , offset}^{CA}$$

higher-layer configured ca-SlotOffset for the cells transmitting the uplink and downlink.

The applicable/usable (or valid) value of K_{UE,offset} for determining the CSI reference resource (of/corresponding to the CSI report) is the one that is applicable/usable (or valid) at the slot n.

The applicable/usable (or valid) value of K_{UE,offset} for determining the CSI reference resource (of/corresponding to the CSI report) is the one that is applicable/usable (or valid) at the slot n−n_{CSI}_{_{ref}}.

For periodic and semi-persistent CSI reporting/report, the applicable value of K_{UE, offset} for determining the CSI reference resource (of/corresponding to the CSI report) is the one that is applicable/usable (or valid) at the slot n.

For periodic and semi-persistent CSI reporting/report, the applicable value of K_{UE, offset} for determining the CSI reference resource (of/corresponding to the CSI report) is the one that is applicable/usable (or valid) at the slot n−n_{CSI}_{_{ref}}.

For aperiodic CSI reporting/report, the applicable value of K_{UE, offset} for determining the CSI reference resource (of/corresponding to the CSI report) is the one that is applicable/usable (or valid) at the last symbol of the DCI indicating (triggering/activating/scheduling) the CSI report, e.g., indicating to the wireless device to report the CSI.

For aperiodic CSI reporting/report, the applicable value of K_{UE, offset} for determining the CSI reference resource (of/corresponding to the CSI report) is the one that is applicable/usable (or valid) at the slot n.

For aperiodic CSI reporting/report, the applicable value of K_{UE, offset} for determining the CSI reference resource (of/corresponding to the CSI report) is the one that is applicable/usable (or valid) at the slot n−n_{CSI}_{_{ref}}.

In an example embodiment, a wireless device may receive a radio resource control (RRC) message indicating a cell-specific offset. The wireless device may receive a downlink control information (DCI), in a first occasion, indicating a transmission of a channel state information (CSI) report. The wireless device may apply, in a second occasion, a differential offset indicated by a differential offset medium access control (MAC) control element (CE). For example, the wireless device may determine a CSI reference resource corresponding to the CSI report, wherein the CSI reference resource is based on: the differential offset in response to the first occasion being after the second occasion; and the cell-specific offset in response to the first occasion being no later than the second occasion. The wireless device may determine a CSI reference signal (RS) being received in a third occasion that occurs before the CSI reference resource. The wireless device may transmit the CSI report based on the CSI-RS received in the third occasion. The received CSI-RS in the third occasion may be (or correspond to) a most recent CSI-RS (resource) of the one or more CSI-RS resources no later than the CSI reference resource.

In an example embodiment, a wireless device may receive a downlink control information (DCI), in a first occasion, indicating a transmission of a channel state information (CSI) report. The wireless device may apply, in a second occasion, a differential offset indicated by a differential offset medium access control (MAC) control element (CE). For example, the wireless device may determine a CSI reference resource corresponding to the CSI report, wherein the CSI reference resource is based on: the differential offset in response to the first occasion being after the second occasion; and the cell-specific offset in response to the first occasion being no later than the second occasion. The wireless device may determine a CSI reference signal (RS) being received in a third occasion that occurs later than the CSI reference resource. The wireless device may drop (the transmission of) the CSI report based on the third occasion being later than the CSI reference resource.

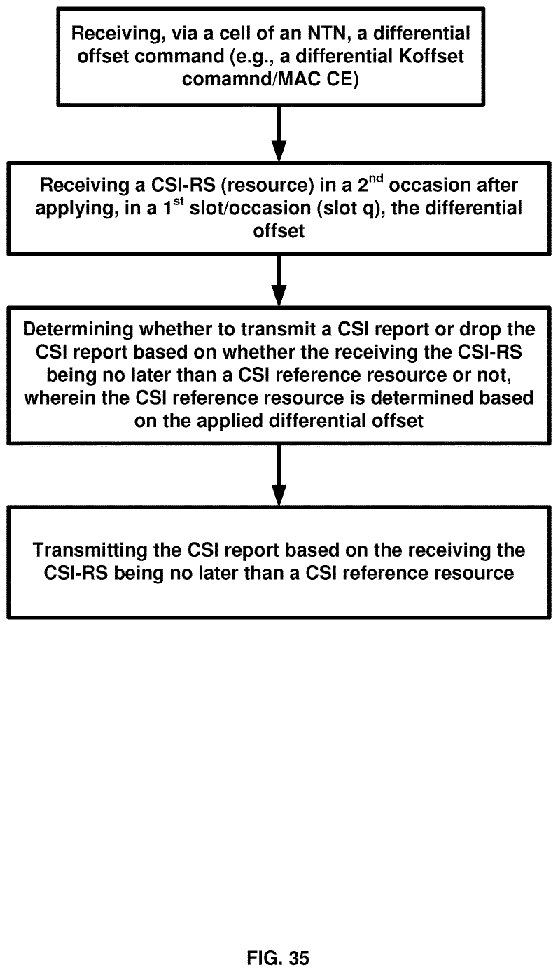

FIG. 35 illustrates an example flowchart of a procedure for CSI report in an NTN as per an aspect of an embodiment of the present disclosure. The wireless device may, e.g., in response to receiving a differential offset (e.g., a differential Koffset MAC CE indicating the differential offset/Koffset), apply (or implement) the differential offset during/in/at a third occasion (e.g., slot q). For example, during/in/at the third occasion (e.g., slot q), the wireless device may determine a scheduling offset (of the NTN) being changed/updated/modified from Koffset to a first Koffset (determined based on the indicated/applied differential offset). Koffset is not based on the indicated differential offset.

In an example embodiment, after applying/implementing the differential offset (or applying the differential Koffset MAC CE), e.g., in/during the third occasion (e.g., the slot q), the wireless device may, only after receiving at least one CSI-RS transmission occasion (e.g., for channel measurement and CSI-RS and/or CSI-IM occasion for interference measurement), of the one or more CSI-RS transmission/reception occasions, report/transmit the CSI report/reporting based on the at least one CSI-RS transmission occasion being no later than a CSI reference resource of the CSI report. In an example embodiment, after applying/implementing the differential offset (or applying the differential Koffset MAC CE), e.g., in/during the third occasion (e.g., the slot q), the wireless device may, only after receiving at least one CSI-RS transmission occasion (e.g., for channel measurement and CSI-RS and/or CSI-IM occasion for interference measurement), drop (the transmission of) the CSI report/reporting based on the at least one CSI-RS transmission occasion being later than/after the CSI reference resource of the CSI report. The wireless device may determine the CSI reference resource based on indicated/applied differential offset.

After CSI report (re) configuration (e.g., as a result of the handover procedure for handover from a first cell to a second cell or receiving an RRC reconfiguration messages indicating the CSI report reconfiguration), a serving cell activation, a BWP change/switch, an activation of SP-CSI (e.g., based on receiving a command activating SP CSI resources), or after applying a differential Koffset indicated by a differential Koffset MAC CE (or after receiving a differential offset from higher layers of the wireless device), the wireless device may report/transmit the CSI report/reporting only after receiving at least one CSI-RS transmission occasion (e.g., corresponding to the activated SP CSI resources) for channel measurement and CSI-RS and/or CSI-IM occasion for interference measurement no later than the CSI reference resource and drops the report otherwise.

After CSI report (re) configuration (e.g., as a result of the handover procedure for handover from a first cell to a second cell or receiving an RRC reconfiguration messages indicating the CSI report reconfiguration), a serving cell activation, a BWP change/switch, an activation of SP-CSI (e.g., based on receiving a command activating SP CSI resources), or after receiving a differential Koffset MAC CE providing a UE-specific Koffset, the wireless device may report/transmit the CSI report/reporting only after receiving at least one CSI-RS transmission occasion (e.g., corresponding to the activated SP CSI resources) for channel measurement and CSI-RS and/or CSI-IM occasion for interference measurement no later than the CSI reference resource and drops the report otherwise.

The wireless device may not expect to receive the differential offset (or apply the differential offset) within/during the first timing gap prior to/before the first UL slot (e.g., the UL slot m). For example, the wireless device may not expect to receive the differential offset (or apply the differential offset) within/during the second timing gap prior to/before the fourth occasion (e.g., DL slot n).

In the present disclosure, “determine” may (interchangeably) refer to “estimate” or “measure” or “calculate” or “derive” or “obtain” or “identify” or “evaluate” or “verify” or “decide” or “select”.

In the present disclosure, a TA command may be a TAC MAC CE.

In the present disclosure, a TA command may comprise a TA value or a TA adjustment value. For example, a cell switch command (or message) may comprise/indicate the TA command. In other example, a handover message/command may comprise/indicate the TA command. In some implementations, the TAC MAC CE may comprise/indicate (or be) the TA command.

In the present disclosure, a differential offset command may be an activation command or an update command or a MAC CE command.

In the present disclosure, a differential offset refers to a differential Koffset or a UE-specific offset or a UE-specific scheduling offset, or a UE-specific Koffset.

In the present disclosure, a differential offset command refers to a differential Koffset MAC CE or a differential Koffset command.

In the present disclosure, a TA command refers to an RRC message indicating a target TA value or DCI indicating a TA value.

In the present disclosure, “before” refers to “prior to” or “no later than” or “not after”.

In the present disclosure, “later than” refers to “after” or “not before” or “not prior to”.

In the present disclosure, an occasion refers to “a slot” or “a symbol” or “a subframe” or “a frame” or “a transmission resource in time domain” or “a reception resource in time domain”.

In the present disclosure, “in an occasion” refers to “at the occasion” or “during the occasion” or “on the occasion” or “within the occasion”.

In the present disclosure, “monitoring PDCCH” refers to “monitoring PDCCH candidates” or “receiving PDCCH via monitoring PDCCH candidates” or “receiving PDCCHs in/during a CORESET” or “monitoring the PDCCH candidates using one or more search space sets”.

In the present disclosure, “MAC CE” refers to “MAC CE command” or “MAC CE activation command” or “activation command”.

In the present disclosure, “receiving a signal (e.g., PDSCH/PDCCH/CSI-RS) in time T” refers to “receiving the signal during occasion T”.

In the present disclosure, “a dynamic UL grant” refers to “an UL grant scheduled/indicated/activated by a DCI or PDCCH”.

In the present disclosure, “stop” refers to “terminate” or “end” or “finish” or “cease” or “conclude” or “halt” or “expire” the like.

In the present disclosure, “start” refers to “begin” or “initiate”.

In the present disclosure, “RACH-less HO procedure” refers to “an HO procedure without performing an RA procedure” or “an HO procedure using rach-skip configuration” or “an HO procedure without RACH”.

In the present disclosure, “an HO command” refers to an “an RRC message” or “a MAC CE” or “a DCI”.

In the present disclosure, “an HO command” refers to an “an RRC reconfiguration message”.

In the present disclosure, “a first cell” refers to “a source cell” or “a serving cell prior to performing an HO procedure”.

In the present disclosure, “a second cell” refers to “a target cell” or “a candidate target cell” or “non-serving cell” or “a neighbor cell” or “a serving cell after performing an HO procedure”.

In the present disclosure, “performing the handover procedure” refers to “executing the handover procedure” and/or “initiating or starting the handover procedure” and/or “triggering the handover procedure”.

In the present disclosure, “a handover procedure” refers to “a handover from a first/source cell with a first PCI to a second/target cell with a second PCI” or “an RRC reconfiguration procedure” or “an MAC resetting procedure” or a “a layer 3 mobility”.

In the present disclosure, “switch” refers to “switching” or “switch over” or “switchover”.

In the present disclosure, “a handover procedure” refers to or comprises “a service link switch from a first cell with a first PCI to a second cell with a second PCI” or “a satellite switch from a first cell with a first PCI to a second cell with a second PCI” or “a feeder link switch from a first cell with a first PCI to a second cell with a second PCI”.

In the present disclosure, “a service link switch without changing PCI of a cell” refers to or comprises “a service link switch from a first NTN node of the cell to a second NTN node of the cell” or “a service link switch without handover” or “a service link switch without RRC reconfiguration” or “a service link switch without resetting MAC entity” or “a PCI unchanged procedure/scenario”.

In the present disclosure, “a service link switch without changing PCI of a cell” does not comprise “a layer 3 mobility” or “handover” or “reconfiguration procedure”.

In the present disclosure, “a service link switch” refers to “a satellite switch” or “feeder link switch” or “a soft satellite switch” or “a hard satellite switch” or “a soft feeder link switch” or “a hard feeder link switch”.

In the present disclosure, “a second satellite switch method” refers to “a service link switch without changing PCI of serving cell” or “a service link switch while maintaining PCI of the serving cell”.

In the present disclosure, “method” refers to “procedure” or “protocol” or “technique” or “system”.

In the present disclosure, “release” refers to “delete” or “remove” or “discard”. For example, “releasing PUCCH/SRS” refers to “deleting/removing/discarding PUCCH/SRS configurations in an RRC layer”.

In the present disclosure, “clear” refers to “delete” or “remove” or “discard”. For example, “clearing SPS assignments” refers to “deleting/discarding/removing SPS assignments in the MAC layer (without releasing SPS configuration in the RRC layer”.

In the present disclosure, “suspend” refers to “halt” or “postpone” or “delay”. For example, “suspending a procedure during a window/duration” refers to “avoiding performing the procedure during the duration” or “halting performing the procedure during the duration” or “delaying/postponing performing the procedure until after the duration”.

In the present disclosure, “performing a handover” refers to “triggering the handover” or “initiating/starting the handover” or “executing the handover”.

In the present disclosure, “performing a satellite switch” refers to “triggering the satellite switch” or “initiating/starting the satellite switch” or “executing the satellite switch”.

In the present disclosure, “performing DL/UL synchronization toward an NTN node or a cell” refers to “performing DL/UL synchronization for an NTN node or a cell” or “performing DL/UL synchronization with an NTN node or a cell”.

In the present disclosure, “synchronization” refers to “resynchronization” or “UL synchronization” or “DL synchronization”.

In the present disclosure, “corresponding to a CSI report” refers to “of the CSI report” or “associated with the CSI report”.
Clause 1. A method comprising: receiving, by a wireless device, a radio resource control (RRC) message comprising one or more non-terrestrial network (NTN) configurations, wherein the one or more NTN configurations indicate a cell-specific offset; determining, in a third occasion prior to a first occasion, a second differential offset; receiving, in the first occasion, a medium access control control element (MAC CE) indicating a first differential offset; receiving a downlink control information (DCI) indicating a transmission of channel state information (CSI) report; determining a channel state information (CSI) reference resource, corresponding to the CSI report, using a differential offset, among the first differential offset and the second differential offset, based on a relationship between the first occasion and a second occasion, wherein: the first occasion is no later than the second occasion; and the second occasion is based on an uplink slot of the CSI report; receiving a CSI reference signal (CSI-RS); and in response to receiving the CSI-RS no later than the CSI reference resource, transmitting, in the uplink slot, the CSI report based on the CSI-RS.
Clause 2. A method comprising: receiving, by a wireless device and in a first occasion, a first message indicating a first differential offset; determining a channel state information (CSI) reference resource, corresponding to a CSI report, using a differential offset, among the first differential offset and a second differential offset, based on a relationship between the first occasion and an uplink slot of the CSI report; and transmitting, in the uplink slot, the CSI report based on a CSI reference signal (CSI-RS) received no later than the CSI reference resource.
Clause 3. The method of clause 2, wherein the first message is a first medium access control control element (MAC CE).
Clause 4. The method of any one of clauses 2 to 3, further comprising receiving a second message indicating the second differential offset.
Clause 5. The method of clause 4, wherein the second message is a second MAC CE received prior to the first MAC CE.
Clause 6. The method of any one of clauses 2 to 3, further comprising determining the second differential offset.
Clause 7. The method of any one of clauses 3 to 6, wherein the second differential offset is received or determined in a third occasion.
Clause 8. The method of clause 7, wherein the third occasion is prior to the first occasion.
Clause 9. The method of any one of clauses 2 to 8, further comprising determining a second occasion based on the uplink slot of the CSI report.
Clause 10. The method of clause 9, wherein determining the CSI reference resource is based on the relationship between the first occasion and the second occasion.
Clause 11. The method of any one of clauses 9 to 10, wherein the relationship between the first occasion and the second occasion comprises the first occasion being later than the second occasion.
Clause 12. The method of any one of clauses 2 to 11, wherein the CSI reference resource is based on the second differential offset.
Clause 13. The method of any one of clauses 2 to 12, wherein the relationship between the first occasion and the second occasion comprises the first occasion being no later than the second occasion.
Clause 14. The method of any one of clauses 2 to 13, wherein the CSI reference resource is based on the first differential offset.
Clause 15. The method of any one of clauses 2 to 14, further comprising determining the differential offset for determining the CSI reference resource.
Clause 16. The method of clause 15, wherein the differential offset is the first differential offset.
Clause 17. The method of clause 15, wherein the differential offset is the second differential offset.
Clause 18. The method of any one of clauses 2 to 17, wherein the determining the CSI reference resource uses the first differential offset.
Clause 19. The method of any one of clauses 2 to 18, wherein the determining the CSI reference resource uses the second differential offset.
Clause 20. The method of any one of clauses 2 to 19, further comprising determining a third occasion.
Clause 21. The method of clause 20, wherein the uplink slot is in a third occasion.
Clause 22. The method of any one of clauses 20 to 21, wherein the third occasion is a downlink slot corresponding to the uplink slot.
Clause 23. The method of any one of clauses 2 to 22, further comprising determining a downlink slot, corresponding to the uplink slot, based on: a first subcarrier spacing configuration for downlink transmissions; and a second subcarrier spacing configuration for uplink transmissions.
Clause 24. The method of any one of clauses 20 to 23, wherein the third occasion is a first timing gap prior to a downlink slot corresponding to the uplink slot.
Clause 25. The method of clause 24, wherein the first timing gap is determined based on the first subcarrier spacing configuration and a predefined number.
Clause 26. The method of clause 24, further comprising receiving one or more configuration parameters indicating the first timing gap.
Clause 27. The method of clause 24, wherein the first timing gap is predefined.
Clause 28. The method of any one of clauses 2 to 27, wherein the CSI report is a periodic CSI report or a semi-persistent CSI report.
Clause 29. The method of any one of clauses 2 to 28, wherein the CSI report is an aperiodic CSI report.
Clause 30. The method of any one of clauses 2 to 29, further comprising receiving a downlink control information (DCI) indicating the CSI report and the uplink slot.
Clause 31. The method of clause 30, wherein the second occasion is a reception occasion of receiving the DCI.
Clause 32. The method of any one of clauses 2 to 31, further comprising determining the uplink slot based on the first differential offset.
Clause 33. The method of any one of clauses 2 to 31, further comprising determining the uplink slot based on the second differential offset.
Clause 34. The method of any one of clauses 2 to 33, wherein the second differential offset is 0.
Clause 35. The method of any one of clauses 2 to 34, further comprising receiving a radio resource control (RRC) message indicating a cell-specific offset.
Clause 36. The method of clause 35, wherein the CSI reference resource is further determined based on the cell-specific offset.
Clause 37. The method of any one of clauses 35 to 36, wherein the CSI reference resource is determined based on a subtraction of the first differential offset from the cell-specific offset.
Clause 38. The method of any one of clauses 35 to 36, wherein the CSI reference resource is determined based on a subtraction of the second differential offset from the cell-specific offset.
Clause 39. The method of any one of clauses 35 to 38, wherein the uplink slot is determined based on a subtraction of the second differential offset from the cell-specific offset.
Clause 40. The method of any one of clauses 35 to 39, wherein the uplink slot is determined based on a subtraction of the first differential offset from the cell-specific offset.
Clause 41. The method of any one of clauses 35 to 40, wherein the RRC message is a system information block (SIB) 19 message comprising one or more non-terrestrial network (NTN) configurations.
Clause 42. The method of clause 41, wherein the RRC message further comprises ephemeris data for an NTN node, wherein the uplink slot is determined based on the ephemeris data.
Clause 43. The method of any one of clauses 2 to 42, further comprising receiving the CSI-RS no later than the CSI reference resource.
Clause 44. The method of clause 43, wherein the CSI-RS is received in a fourth occasion.
Clause 45. The method of any one of clauses 2 to 44, wherein a value of the CSI report is determined based on the CSI-RS.
Clause 46. A method comprising: transmitting, by a base station to a wireless device and in a first occasion, a message indicating a first differential offset; and receiving, in an uplink slot, a channel state information (CSI) report based on a CSI reference signal (CSI-RS) received no later a CSI reference resource, wherein the CSI reference resource uses a differential offset, among the first differential offset and a second differential offset, based on a relationship between the first occasion and the uplink slot of the CSI report.
Clause 47. The method of clause 46, wherein the first message is a first medium access control control element (MAC CE).
Clause 48. The method of any one of clauses 46 to 47, further comprising transmitting a second message indicating the second differential offset.
Clause 49. The method of clause 48, wherein the second message is a second MAC CE received prior to the first MAC CE.
Clause 50. The method of any one of clauses 46 to 47, further comprising determining the second differential offset.
Clause 51. The method of any one of clauses 47 to 50, wherein the second differential offset is transmitted or determined in a third occasion.
Clause 52. The method of clause 51, wherein the third occasion is prior to the first occasion.
Clause 53. The method of any one of clauses 46 to 52, further comprising determining a second occasion based on the uplink slot of the CSI report.
Clause 54. The method of clause 53, wherein determining the CSI reference resource is based on the relationship between the first occasion and the second occasion.
Clause 55. The method of any one of clauses 53 to 54, wherein the relationship between the first occasion and the second occasion comprises the first occasion being later than the second occasion.
Clause 56. The method of any one of clauses 46 to 55, wherein the CSI reference resource is based on the second differential offset.
Clause 57. The method of any one of clauses 46 to 56, wherein the relationship between the first occasion and the second occasion comprises the first occasion being no later than the second occasion.
Clause 58. The method of any one of clauses 46 to 57, wherein the CSI reference resource is based on the first differential offset.
Clause 59. The method of any one of clauses 46 to 58, further comprising determining the differential offset for determining the CSI reference resource.
Clause 60. The method of clause 59, wherein the differential offset is the first differential offset.
Clause 61. The method of clause 59, wherein the differential offset is the second differential offset.
Clause 62. The method of any one of clauses 46 to 61, wherein the CSI reference resource uses the first differential offset.
Clause 63. The method of any one of clauses 46 to 61, wherein the CSI reference resource uses the second differential offset.
Clause 64. The method of any one of clauses 46 to 63, further comprising determining a third occasion.
Clause 65. The method of clause 64, wherein the uplink slot is in a third occasion.
Clause 66. The method of any one of clauses 64 to 65, wherein the third occasion is a downlink slot corresponding to the uplink slot.
Clause 67. The method of any one of clauses 46 to 66, further comprising determining a downlink slot, corresponding to the uplink slot, based on: a first subcarrier spacing configuration for downlink transmissions; and a second subcarrier spacing configuration for uplink transmissions.
Clause 68. The method of any one of clauses 64 to 67, wherein the third occasion is a first timing gap prior to a downlink slot corresponding to the uplink slot.
Clause 69. The method of clause 68, wherein the first timing gap is determined based on the first subcarrier spacing configuration and a predefined number.
Clause 70. The method of clause 68, further comprising transmitting one or more configuration parameters indicating the first timing gap.
Clause 71. The method of clause 68, wherein the first timing gap is predefined.
Clause 72. The method of any one of clauses 46 to 71, wherein the CSI report is a periodic CSI report or a semi-persistent CSI report.
Clause 73. The method of any one of clauses 46 to 71, wherein the CSI report is an aperiodic CSI report.
Clause 74. The method of any one of clauses 46 to 73, further comprising transmitting a downlink control information (DCI) indicating the CSI report and the uplink slot.
Clause 75. The method of clause 74, wherein the second occasion is a reception occasion of receiving the DCI.
Clause 76. The method of any one of clauses 46 to 75, further comprising determining the uplink slot based on the first differential offset.
Clause 77. The method of any one of clauses 46 to 76, further comprising determining the uplink slot based on the second differential offset.
Clause 78. The method of any one of clauses 46 to 77, wherein the second differential offset is 0.
Clause 79. The method of any one of clauses 46 to 78, further comprising transmitting a radio resource control (RRC) message indicating a cell-specific offset.
Clause 80. The method of clause 79, wherein the CSI reference resource is further determined based on the cell-specific offset.
Clause 81. The method of any one of clauses 79 to 80, wherein the CSI reference resource is determined based on a subtraction of the first differential offset from the cell-specific offset.
Clause 82. The method of any one of clauses 79 to 80, wherein the CSI reference resource is determined based on a subtraction of the second differential offset from the cell-specific offset.
Clause 83. The method of any one of clauses 79 to 82, wherein the uplink slot is determined based on a subtraction of the second differential offset from the cell-specific offset.
Clause 84. The method of any one of clauses 79 to 83, wherein the uplink slot is determined based on a subtraction of the first differential offset from the cell-specific offset.
Clause 85. The method of any one of clauses 79 to 84, wherein the RRC message is a system information block (SIB) 19 message comprising one or more non-terrestrial network (NTN) configurations.
Clause 86. The method of clause 85, wherein the RRC message further comprises ephemeris data for an NTN node, wherein the uplink slot is determined based on the ephemeris data.
Clause 87. The method of any one of clauses 46 to 86, further comprising transmitting the CSI-RS no later than the CSI reference resource.
Clause 88. The method of clause 87, wherein the CSI-RS is transmitted in a fourth occasion.
Clause 89. The method of any one of clauses 46 to 88, wherein a value of the CSI report is determined based on the CSI-RS.
Clause 90. A method comprising: receiving, by a wireless device and in a first occasion, a first message indicating a first differential offset; receiving one or more channel state information (CSI) references signals (CSI-RSs); determining a channel state information (CSI) reference resource, corresponding to a CSI report, using a differential offset, among the first differential offset and a second differential offset, based on a relationship between the first occasion and an uplink slot of the CSI report; and dropping the CSI report based on each CSI-RS of the one or more CSI-RSs being received later than the CSI reference resource.
Clause 91. The method of clause 90, wherein the first message is a first medium access control control element (MAC CE).
Clause 92. The method of any one of clauses 90 to 91, further comprising receiving a second message indicating the second differential offset.
Clause 93. The method of clause 92, wherein the second message is a second MAC CE received prior to the first MAC CE.
Clause 94. The method of any one of clauses 90 to 91, further comprising determining the second differential offset.
Clause 95. The method of any one of clauses 91 to 94, wherein the second differential offset is received or determined in a third occasion.
Clause 96. The method of clause 95, wherein the third occasion is prior to the first occasion.
Clause 97. The method of any one of clauses 90 to 96, further comprising determining a second occasion based on the uplink slot of the CSI report.
Clause 98. The method of clause 97, wherein determining the CSI reference resource is based on the relationship between the first occasion and the second occasion.
Clause 99. The method of any one of clauses 97 to 98, wherein the relationship between the first occasion and the second occasion comprises the first occasion being later than the second occasion.
Clause 100. The method of any one of clauses 90 to 99, wherein the CSI reference resource is based on the second differential offset.
Clause 101. The method of any one of clauses 90 to 100, wherein the relationship between the first occasion and the second occasion comprises the first occasion being no later than the second occasion.
Clause 102. The method of any one of clauses 90 to 101, wherein the CSI reference resource is based on the first differential offset.
Clause 103. The method of any one of clauses 90 to 102, further comprising determining the differential offset for determining the CSI reference resource.
Clause 104. The method of clause 103, wherein the differential offset is the first differential offset.
Clause 105. The method of clause 103, wherein the differential offset is the second differential offset.
Clause 106. The method of any one of clauses 90 to 105, wherein the determining the CSI reference resource uses the first differential offset.
Clause 107. The method of any one of clauses 90 to 106, wherein the determining the CSI reference resource uses the second differential offset.
Clause 108. The method of any one of clauses 90 to 107, further comprising determining a third occasion.
Clause 109. The method of clause 108, wherein the uplink slot is in the third occasion.
Clause 110. The method of any one of clauses 108 to 109, wherein the third occasion is a downlink slot corresponding to the uplink slot.
Clause 111. The method of any one of clauses 90 to 110, further comprising determining a downlink slot, corresponding to the uplink slot, based on: a first subcarrier spacing configuration for downlink transmissions; and a second subcarrier spacing configuration for uplink transmissions.
Clause 112. The method of any one of clauses 108 to 111, wherein the third occasion is a first timing gap prior to a downlink slot corresponding to the uplink slot.
Clause 113. The method of clause 112, wherein the first timing gap is determined based on the first subcarrier spacing configuration and a predefined number.
Clause 114. The method of clause 112, further comprising receiving one or more configuration parameters indicating the first timing gap.
Clause 115. The method of clause 112, wherein the first timing gap is predefined.
Clause 116. The method of any one of clauses 90 to 115, wherein the CSI report is a periodic CSI report or a semi-persistent CSI report.
Clause 117. The method of any one of clauses 90 to 116, wherein the CSI report is an aperiodic CSI report.
Clause 118. The method of any one of clauses 90 to 117, further comprising receiving a downlink control information (DCI) indicating the CSI report and the uplink slot.
Clause 119. The method of clause 118, wherein the second occasion is a reception occasion of receiving the DCI.
Clause 120. The method of any one of clauses 90 to 119, further comprising determining the uplink slot based on the first differential offset.
Clause 121. The method of any one of clauses 90 to 119, further comprising determining the uplink slot based on the second differential offset.
Clause 122. The method of any one of clauses 90 to 121, wherein the second differential offset is 0.
Clause 123. The method of any one of clauses 90 to 122, further comprising receiving a radio resource control (RRC) message indicating a cell-specific offset.
Clause 124. The method of clause 123, wherein the CSI reference resource is further determined based on the cell-specific offset.
Clause 125. The method of any one of clauses 123 to 124, wherein the CSI reference resource is determined based on a subtraction of the first differential offset from the cell-specific offset.
Clause 126. The method of any one of clauses 123 to 125, wherein the CSI reference resource is determined based on a subtraction of the second differential offset from the cell-specific offset.
Clause 127. The method of any one of clauses 123 to 126, wherein the uplink slot is determined based on a subtraction of the second differential offset from the cell-specific offset.
Clause 128. The method of any one of clauses 123 to 127, wherein the uplink slot is determined based on a subtraction of the first differential offset from the cell-specific offset.
Clause 129. The method of any one of clauses 123 to 128, wherein the RRC message is a system information block (SIB) 19 message comprising one or more non-terrestrial network (NTN) configurations.
Clause 130. The method of clause 129, wherein the RRC message further comprises ephemeris data for an NTN node, wherein the uplink slot is determined based on the ephemeris data.
Clause 131. The method of any one of clauses 90 to 130, further comprising receiving the CSI-RS no later than the CSI reference resource
Clause 132. A method comprising: receiving, by a wireless device, one or more configuration parameters indicating a cell-specific offset; receiving a downlink control information (DCI) activating a semi-persistent channel state information (CSI) report; in response to the DCI activating the semi-persistent CSI report, determining a transmission occasion of an initial semi-persistent CSI report based on the cell-specific offset; and transmitting, based on the determining, the semi-persistent CSI report on the transmission occasion.
Clause 133. An apparatus comprising: one or more processors; and memory storing instructions that, when executed by the one or more processors, cause the apparatus to perform the method of any one of clauses 1 to 132.
Clause 134. A non-transitory computer-readable medium comprising instructions that, when executed by one or more processors of an apparatus, cause the apparatus to perform the method of any one of clauses 1 to 132.

What is claimed is:

1. A method comprising:
receiving, by a wireless device and in a first occasion, a first message indicating a first differential offset;
receiving a second message indicating a second differential offset;
determining a channel state information (CSI) reference resource, corresponding to a CSI report, using a differential offset, among the first differential offset and the second differential offset, based on a relationship between the first occasion and a second occasion for an uplink slot of the CSI report; and
transmitting, in the uplink slot, the CSI report based on a CSI reference signal (CSI-RS) received no later than the CSI reference resource.

2. The method of claim 1, wherein the first message is a first medium access control control element (MAC CE).

3. The method of claim 1, wherein:
the relationship between the first occasion and the second occasion comprises the first occasion being later than the second occasion; and
the CSI reference resource is determined using the second differential offset, based on the relationship.

4. The method of claim 1, wherein:
the relationship between the first occasion and the second occasion comprises the first occasion being no later than the second occasion; and
the CSI reference resource is determined using the first differential offset, based on the relationship.

5. The method of claim 1, wherein:
the uplink slot is in a third occasion; and
the third occasion is:
a downlink slot corresponding to the uplink slot; or
a timing gap prior to the downlink slot corresponding to the uplink slot.

6. The method of claim 5, further comprising determining the downlink slot, corresponding to the uplink slot, based on:
a first subcarrier spacing configuration for downlink transmissions; and
a second subcarrier spacing configuration for uplink transmissions.

7. The method of claim 1, further comprising receiving a downlink control information (DCI) indicating the CSI report and the uplink slot, wherein the second occasion is a reception occasion of receiving the DCI.

8. The method of claim 4, further comprising receiving a radio resource control (RRC) message indicating a cell-specific offset, wherein the CSI reference resource is determined based on a subtraction of the first differential offset from the cell-specific offset.

9. The method of claim 3, further comprising receiving a radio resource control (RRC) message indicating a cell-specific offset, wherein the CSI reference resource is determined based on a subtraction of the second differential offset from the cell-specific offset.

10. A wireless device comprising:
one or more processors; and
memory storing instructions that, when executed by the one or more processors, cause the wireless device to:
receive, in a first occasion, a first message indicating a first differential offset;
receive a second message indicating a second differential offset;
determine a channel state information (CSI) reference resource, corresponding to a CSI report, using a differential offset, among the first differential offset and the second differential offset, based on a relationship between the first occasion and a second occasion for an uplink slot of the CSI report; and
transmit, in the uplink slot, the CSI report based on a CSI reference signal (CSI-RS) received no later than the CSI reference resource.

11. The wireless device of claim 10, wherein the first message is a first medium access control control element (MAC CE).

12. The wireless device of claim 10, wherein:
the relationship between the first occasion and the second occasion comprises the first occasion being later than the second occasion; and
the CSI reference resource is determined using the second differential offset, based on the relationship.

13. The wireless device of claim 10, wherein:
the relationship between the first occasion and the second occasion comprises the first occasion being no later than the second occasion; and
the CSI reference resource is determined using the first differential offset, based on the relationship.

14. The wireless device of claim 10, wherein:
the uplink slot is in a third occasion; and
the third occasion is:
a downlink slot corresponding to the uplink slot; or
a timing gap prior to the downlink slot corresponding to the uplink slot.

15. The wireless device of claim 14, wherein the instructions further cause the wireless device to determine the downlink slot, corresponding to the uplink slot, based on:
a first subcarrier spacing configuration for downlink transmissions; and
a second subcarrier spacing configuration for uplink transmissions.

16. The wireless device of claim 10, wherein the instructions further cause the wireless device to receive a downlink control information (DCI) indicating the CSI report and the uplink slot, wherein the second occasion is a reception occasion of receiving the DCI.

17. The wireless device of claim 13, wherein the instructions further cause the wireless device to receive a radio resource control (RRC) message indicating a cell-specific offset, wherein the CSI reference resource is determined based on a subtraction of the first differential offset from the cell-specific offset.

18. The wireless device of claim 12, wherein the instructions further cause the wireless device to receive a radio resource control (RRC) message indicating a cell-specific offset, wherein the CSI reference resource is determined based on a subtraction of the second differential offset from the cell-specific offset.

19. A non-transitory computer-readable medium comprising instructions that, when executed by one or more processors of a wireless device, cause the wireless device to:
receive, in a first occasion, a first message indicating a first differential offset;
receive a second message indicating a second differential offset;
determine a channel state information (CSI) reference resource, corresponding to a CSI report, using a differential offset, among the first differential offset and the second differential offset, based on a relationship between the first occasion and a second occasion for an uplink slot of the CSI report; and
transmit, in the uplink slot, the CSI report based on a CSI reference signal (CSI-RS) received no later than the CSI reference resource.
